(19) United States
(12) Patent Application Publication
(10) Pub. No.: US 2015/0022764 A1
(43) Pub. Date: Jan. 22, 2015

(54) PHASE DIFFERENCE FILM, POLARIZING PLATE, AND LIQUID CRYSTAL DISPLAY DEVICE

(71) Applicant: FUJIFILM Corporation, Tokyo (JP)

(72) Inventors: Jun TAKEDA, Kanagawa (JP); Yuki MATSUDA, Kanagawa (JP); Nobuhiko ICHIHARA, Kanagawa (JP)

(73) Assignee: FUJIFILM Corporation, Tokyo (JP)

(21) Appl. No.: 14/509,771

(22) Filed: Oct. 8, 2014

Related U.S. Application Data
(63) Continuation of application No. PCT/JP2013/059322, filed on Mar. 28, 2013.

(30) Foreign Application Priority Data
Apr. 13, 2012 (JP) 2012-092497
Nov. 15, 2012 (JP) 2012-251648

(51) Int. Cl. G02F 1/13363; G02B 5/30; B29D 11/00; G02F 1/1335

(52) U.S. Cl. CPC G02F 1/13363; G02F 1/133528; G02B 5/3083; B29D 11/0074; B29D 11/00865; G02F 2001/133531; B29K 2029/04
USPC 349/96; 428/1.2; 349/117; 359/489.07; 427/162

(57) ABSTRACT

There is provided a phase difference film which includes a, an intermediate layer, and a phase difference layer to which an alignment state of a liquid crystal material is fixed in this order, in which the substrate contains cellulose acylate in which an average substitution degree DS of an acyl group satisfies 2.0<DS<2.6, specific polycondensation ester, or specific sugar ester, the intermediate layer contains a polyvinyl alcohol resin or an acrylic resin having a polar group, and the phase difference layer contains a liquid crystal compound which is homeotropically aligned and has specific optical characteristics.

### CROSS REFERENCE TO RELATED APPLICATION

This is a continuation of International Application No. PCT/JP2013/059322 filed on Mar. 28, 2013, and claims priority from Japanese Patent Application No. 2012-092497 filed on Apr. 13, 2012, and Japanese Patent Application No. 2012-251648 filed on Nov. 15, 2012 the entire disclosures of which are incorporated therein by reference.

### TECHNICAL FIELD

The present invention relates to a phase difference film which performs display by horizontally applying an electric field to a liquid crystal compound aligned in a horizontal direction and is suitable for optical compensation of a liquid crystal display device having a horizontal electric field mode such as an In-Plane Switching (IPS) mode, in a polarizing plate using the same, and in a liquid crystal display device having a horizontal electric field mode.

### BACKGROUND ART

An In-Plane Switching (IPS) mode or a Fringe Field Switching (FFS) mode of a liquid crystal display device is not a mode in which a liquid crystal display device is driven by the rising of liquid crystal molecules but a system (mode) in which an electric field is applied to a space between an upper substrate and a lower substrate such as a Twisted Nematic (TN) mode or a Vertical Alignment (VA) mode and which is referred to as a horizontal electric field system allowing liquid crystal molecules to respond in a substrate in-plane direction due to the electric field containing a component which is substantially parallel to the surface of a substrate.

Since the horizontal electric field system is a system in which restrictions on the viewing angle are decreased in principle, this system is known as a driving system having characteristics of small chromaticity shift and a small hue change in addition to a wide viewing angle. In recent years, this system has begun to spread from a display device for a mobile terminal other than a TV to a display device with high definition and high image quality for business.

In the liquid crystal display device having a horizontal electric field system, a configuration in which a liquid crystal cell is used without hindering the advantages thereof by setting protective films of a polarizing plate, which interpose the liquid crystal cell therebetween as an isotropic film, is known (for example, Patent Document 1).

However, since compensation caused by the polarizer has not been examined with this configuration, optical compensation is needed with respect to a decrease in contrast or color shift due to light leakage in visual recognition particularly from an oblique direction. Accordingly, a liquid crystal display device having a horizontal electric field system in which compensation has been examined in the entire display device by allowing the optically anisotropic layer to be arranged is proposed.

For example, in Patent Document 2, a lamination type phase difference film provided with an alignment film (intermediate layer) containing a polyvinyl alcohol resin and a layer allowing a rod-shaped liquid crystal compound to be vertically aligned, on a cellulose acylate film (substrate) is disclosed.

### RELATED ART

### Patent Document

[Patent Document 1] JP-A-2010-107953
[Patent Document 2] JP-A-2007-279083

### SUMMARY OF THE INVENTION

### Problems that the Invention is to Solve

However, according to examination by the present inventors, in a phase difference film disclosed in Patent Document 2, it is understood that (1) there is room for improvement in an adhesion property between a cellulose acylate film (substrate) and an alignment film (intermediate layer) containing a polyvinyl alcohol resin (PVA) and (2) there is room for improvement in polarizing plate durability in a moist heat environment when attached to a polarizer to be used as a polarizing plate.

Accordingly, the present invention has been made in consideration of the above-described problems and an object thereof is to provide a phase difference film having an excellent adhesion property between a substrate and an intermediate layer and excellent polarizing plate durability in a moist heat environment when attached to a polarizer to be used as a polarizing plate. Further, an object of the present invention is to provide a polarizing plate and a liquid crystal display device, having such a phase difference film.

### Means for Solving the Problems

As a result of intensive examination repeatedly conducted by the present inventors for solving the above-described problem, since a cellulose acetate film that is used as a substrate in Patent Document 2 and has a substitution degree of an acetyl group of 2.8, which is high, has hydrophobicity, it is considered that an interaction with respect to a hydrophilic group having PVA is weak and an adhesion property between a substrate and a PVA layer is decreased. Therefore, as a result of a test carried out in consideration of the necessity for decreasing the average substitution degree of the acyl group of cellulose acylate further than that of Patent Document 2, a lamination-type phase difference film with an excellent adhesion property can be obtained. Further, by adjusting the average substitution degree thereof to be higher than 2.0 and to be lower than 2.6 (low substitution degree), it is understood that exhibition of the optical characteristics is improved and thinning of the film which has been required recently can be achieved.

In addition, since hydrophilicity is increased and exhibition of the optical characteristics becomes high only by decreasing the substitution degree of the acyl group of cellulose acylate, it is understood that moisture permeability is increased and the polarizing plate durability is conversely deteriorated by the film being thinned. Here, as a result of intensive examination of various techniques, it is understood that the polarizing plate durability can be improved by containing an additive of i) and ii) described below with respect to cellulose acylate having a low substitution degree, thereby completing the present invention.

i) Polycondensation ester containing a dicarboxylic acid residue that contains at least one kind of aromatic dicarboxylic acid residue and has an average carbon number of 5.5 to 10.0, or

ii) Sugar ester having 1 to 12 pyranose structures or furanose structures in which at least one hydroxyl group is aromatically esterified

In addition, the same effect can be obtained by using an acrylic layer having a polar group instead of the PVA layer.

In other words, the present invention provides a thin phase difference film having an excellent adhesion property between the three layers and having excellent polarizing plate durability by providing cellulose acylate with a low substitution degree, an intermediate layer on a substrate using the above-described additive, and a liquid crystal layer thereon.

The present invention has the following configurations.

[1] A phase difference film comprising at least a substrate, an intermediate layer, and a phase difference layer in this order,

wherein the substrate is a cellulose acylate film which contains:
i) polycondensation ester containing a dicarboxylic acid residue that contains at least one kind of aromatic dicarboxylic acid residue and has an average carbon number of 5.5 to 10.0, or
ii) sugar ester having 1 to 12 pyranose structures or furanose structures in which at least one hydroxyl group is aromatically esterified,

and in which an average substitution degree DS of an acyl group of the cellulose acylate is 2.0<DS<2.6,

the intermediate layer contains a polyvinyl alcohol resin or an acrylic resin having a polar group,

the phase difference layer is a layer to which a state of homeotropic alignment of a liquid crystal compound is fixed, and

optical characteristics of the phase difference film satisfy the following expressions (1), (2), and (3):

80 nm≦Re≦150 nm Expression (1)

−100 nm≦Rth≦10 nm Expression (2)

0.05≦|Rth/Re|≦1.0 Expression (3)

in the expressions, Re represents a value of in-plane retardation (unit: nm) measured using light having a wavelength of 550 nm at 25° C. and at 60% RH, and Rth represents a value of a retardation (unit: nm) in a thickness direction measured using light having a wavelength of 550 nm at 25° C. and at 60% RH.

[2] The phase difference film as described in [1], containing i) the polycondensation ester or ii) the sugar ester in the content of 1% by mass to 30% by mass with respect to the cellulose acylate which is a main component of the substrate.
[3] The phase difference film as described in [1] or [2], comprising a mixed layer which contains a main component of the substrate and a main component of the intermediate layer between the substrate and the intermediate layer,

wherein the film thickness of the mixed layer is in the range of 0.3 μm to 5.0 μm.

[4] The phase difference film as described in any one of [1] to [3],

wherein the phase difference layer contains at least one kind of onium compound represented by the following general formula (I):

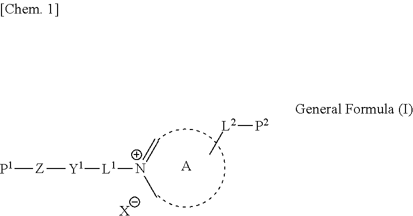

in the general formula (I),

a ring A represents a quaternary ammonium ion formed of a nitrogen-containing heterocyclic ring;

X represents an anion;

L¹ represents a divalent linking group;

L² represents a single bond or a divalent linking group;

Y¹ represents a divalent linking group having 5- or 6-membered ring as a partial structure;

Z represents a divalent linking group having an alkylene group having a carbon number of 2 to 20 as a partial structure; and

each of P¹ and P² independently represents a monovalent substituent having a polymerizable ethylenically unsaturated group.

[5] The phase difference film as described in any one of [1] to [4], containing at least one kind of element selected from bromine, boron, and silicon in the phase difference layer.
[6] The phase difference film as described in [5],

wherein at least one kind of element selected from bromine, boron, and silicon is largely and unevenly distributed on a side close to the intermediate layer in the phase difference layer.

[7] The phase difference film as described in any one of [1] to [6],

wherein a liquid crystal compound forming the phase difference layer is at least one kind of compound which has a polymerizable group and is selected from a group consisting of a compound represented by the following general formula (IIA) and a compound represented by the following general formula (IIB):

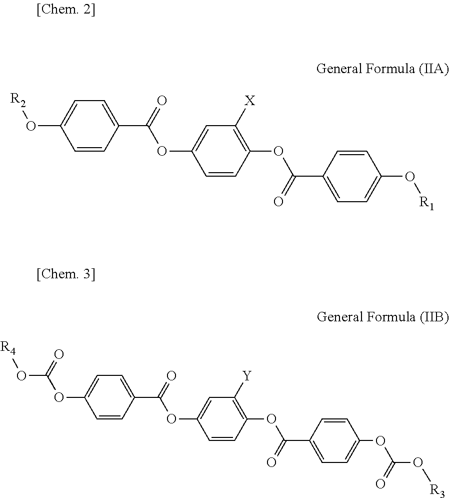

wherein, each of R₁ to R₄ independently represents —(CH₂)ₙ—OOC—CH═CH₂,

n represents an integer of 2 to 5, and

each of X and Y independently represents a hydrogen atom or a methyl group.

[8] The phase difference film as described in [7],

wherein X and Y each represent a methyl group in the general formula (IIA) or (IIB).

[9] The phase difference film as described in [7] or [8],

wherein the phase difference layer contains the compound represented by the general formula (IIA) and the compound represented by the general formula (IIB) in the content of 3% by mass or more with respect to the total solid content of the respective phase difference layers.

[10] The phase difference film as described in any one of [1] to [9],

wherein the cellulose acylate is cellulose acetate.

[11] The phase difference film as described in any one of [1] to [10],

wherein the average substitution degree DS of an acyl group of the cellulose acylate is satisfies 2.00<DS<2.5 in the substrate.

[12] The phase difference film as described in any one of [1] to [11],

wherein a tear strength of the phase difference film is in the range of 1.5 g·cm/cm to 6.0 g·cm/cm.

[13] The phase difference film as described in any one of [1] to [12],

wherein a thickness thereof is in the range of 20 μm to 50 μm.

[14] The phase difference film as described in any one of [1] to [13],

wherein a film thickness of the phase difference layer is in the range of 0.5 μm to 2.0 μm.

[15] The phase difference film as described in any one of [1] to [14],

wherein the intermediate layer is a layer containing an acrylic resin having a polar group,

the acrylic resin is a layer crosslinked with an acrylic monomer, and

the polar group is a hydroxyl group.

[16] The phase difference film as described in any one of [1] to [15],

wherein the substrate is a substrate obtained by laminating a layer of cellulose acylate having an average substitution degree of acyl of 2.6 to 3.0 as a surface layer.

[17] The phase difference film as described in any one of [1] to [16],

wherein Rth of the substrate is greater than Re,

Re satisfies 80 nm≦Re<150 nm, and

Rth satisfies 80 nm<Rth≦150 nm,

wherein, Re represents a value of an in-plane retardation measured using light having a wavelength of 550 nm at 25° C. and at 60% RH, and Rth represents a value of retardation in a thickness direction measured using light having a wavelength of 550 nm at 25° C. and at 60% RH.

[18] The phase difference film as described in any one of [1] to [17],

wherein Re is in the range of 0 nm to 10 nm and Rth is in the range of −250 nm to −100 nm in the phase difference layer,

wherein, Re represents a value of in-plane retardation measured using light having a wavelength of 550 nm at 25° C. and at 60% RH, and Rth represents a value of retardation in a thickness direction measured using light having a wavelength of 550 nm at 25° C. and at 60% RH.

[19] A polarizing plate comprising:

a polarizing film, and

two sheets of protective films protecting both surfaces of the polarizing film,

wherein at least one protective film is the phase difference film according to any one of claims 1 to 18.

[20] A polarizing plate,

wherein, among two sheets of protective films, one is the phase difference film as described in any one of [1] to [18] and the other is a film made of an acrylic resin.

[21] The polarizing plate as described in [19] or [20],

wherein a film thickness thereof is in the range of 80 μm to 120 μm.

[22] A liquid crystal display device, comprising:

the phase difference film as described in any one of [1] to [18]; and

the polarizing plate as described in any one of [19] to [21].

[23] A liquid crystal display device having a horizontal electric field mode using the phase difference film as described in any one of [1] to [18].
[24] A liquid crystal display device having a horizontal electric field mode using the polarizing plate as described in any one of [19] to [21].
[25] A method of producing a phase difference film which includes at least a substrate, an intermediate layer, and a phase difference layer in this order, the method comprising:

a process of dissolving cellulose acylate whose average substitution degree DS of an acyl group satisfies 2.0<DS<2.6, and i) polycondensation ester containing a dicarboxylic acid residue that contains at least one kind of aromatic dicarboxylic acid residue and has an average carbon number of 5.5 to 10.0, or ii) sugar ester having 1 to 12 pyranose structures or furanose structures in which at least one hydroxyl group is aromatically esterified in a solvent, casting the obtained solution on a metal substrate, and forming a substrate by peeling and removing the solvent;

a process of coating a substrate with a solution obtained by dissolving or dispersing at least one kind of a polyvinyl alcohol resin and an acrylic resin having a polar group in a solvent having swelling ability or lytic potential with respect to cellulose acylate, and forming an intermediate layer by drying and curing the resultant; and

a process of coating the intermediate layer with a solution containing a polymerizable liquid crystal compound, drying the resultant, allowing the polymerizable liquid crystal compound to be homeotropically aligned, allowing the alignment state to be fixed by polymerization, and forming a phase difference layer, in this order.

### Advantage of the Invention

According to the present invention, it is possible to provide a phase difference film having an excellent adhesion property between a substrate and an intermediate layer and having excellent polarizing plate durability in a moist heat environment when attached to a polarizer to be used as a polarizing plate.

In addition, the phase difference film of the present invention provides optical characteristics suitable for optical compensation of a liquid crystal display device having a horizontal electric field mode, maintains appropriate tear strength, and can satisfy the requirement for thinning a film which has been required recently, at the same time.

In addition, it is possible to provide a polarizing plate having such a phase difference film and a liquid crystal display device.

### BRIEF DESCRIPTION OF DRAWINGS

FIG. 1 is a schematic view illustrating an example of a phase difference film according to an embodiment of the present invention.

FIG. 2 is a schematic view illustrating an example of a polarizing plate according to an embodiment of the present invention.

### MODE FOR CARRYING OUT THE INVENTION

Hereinafter, the present invention will be described in detail. Further, in the present specification, when numerical values represent values of physical properties and characteristics, descriptions of “(numerical value 1) to (numerical value 2)” and “between (numerical value 1) and (numerical value 2)” mean “from (numerical value 1) to (numerical value 2).”

A phase difference film of the present invention is a phase difference film which includes at least a substrate, an intermediate layer, and a phase difference layer to which an aligned liquid crystal material is fixed in this order, in which the substrate contains cellulose acylate, as a main component, whose average substitution degree DS of an acyl group satisfies 2.0<DS<2.6, and i) polycondensation ester containing a dicarboxylic acid residue that contains at least one kind of aromatic dicarboxylic acid residue and has an average carbon number 5.5 to 10.0, or ii) sugar ester having 1 to 12 pyranose structures or furanose structures in which at least one hydroxyl group is aromatically esterified, the intermediate layer contains a polyvinyl alcohol resin or an acrylic resin having a polar group, the phase difference layer contains a homeotropically aligned liquid crystal compound, and optical characteristics of the phase difference film satisfy the following formulae (1), (2), and (3).

80 nm≦Re≦150nm Formula (1)

−100 nm≦Rth≦10 nm Formula (2)

0.05≦|Rth/Re|≦1.0 Formula (3)

In the formulae, Re represents a value of in-plane retardation (unit: nm) measured using light having a wavelength of 550 nm at 25° C. and at 60% RH (relative humidity of 60%) and Rth represents a value of retardation (unit: nm) in a thickness direction measured using light having a wavelength of 550 nm at 25° C. and at 60% RH (relative humidity of 60%).

### <Substrate>

A substrate (cellulose acylate film) obtained by including cellulose acylate as a main component, which is included in the phase difference film of the present invention will be described.

### [Cellulose Acylate]

Examples of the cellulose acylate include a cellulose acylate compound and a compound having an acyl-substituted cellulose skeleton obtained by biologically or chemically introducing a functional group using cellulose as a raw material.

The cellulose acylate is an ester of cellulose and an acid. As an acid constituting the ester, an organic acid is preferable, carboxylic acid is more preferable, a fatty acid having 2 to 22 carbon atoms is still more preferable, and a lower fatty acid having 2 to 4 carbon atoms is most preferable.

### [Raw Material Cotton of Cellulose Acylate]

As the cellulose of the cellulose acylate raw material used for the present invention, cotton linters or wood pulp (hardwood pulp or softwood pulp) is exemplified. In addition, cellulose acylate obtained from any cellulose raw material can be used and may be used in combination in some cases. These cellulose raw materials are specifically described in “Cellulose-based Resin of Plastic Material Course (17)” (written by Marusawa and Uda, Nikkan Kogyo Shimbun, Ltd., published in 1970) and Journal of Technical Disclosure 2001-1745 (pp. 7 and 8). The cellulose described therein can be used and the cellulose acylate used in the present invention is not particularly limited.

### [Substitution Degree of Acyl of Cellulose Acylate]

The cellulose acylate in the present invention is an acylated hydroxyl group of cellulose.

The substrate in the present invention contains cellulose acylate whose average substitution degree DS of an acyl group satisfies 2.0<DS<2.6 as a main component.

Here, the term “as a main component” indicates a polymer in a case where the substrate is made of a single polymer and indicates a polymer having the highest mass fraction among polymers constituting the substrate in a case where the substrate is made of a plurality of polymers.

Measurement of the substitution degree in the hydroxyl group of cellulose in the cellulose acylate is not particularly limited, but the degree of bonding of acetate substituted with the hydroxyl group of cellulose and/or a fatty acid having 3 or more carbon atoms is measured to obtain the substitution degree through calculation. The measurement can be carried out in conformity with ASTMD-817-91.

When the substitution degree of acyl of cellulose acylate is set as DS, DS of the present invention is 2.00<DS<2.60, preferably 2.00<DS<2.55, more preferably 2.10<DS<2.50, and still more preferably 2.20<DS<2.45.

By the substitution degree acyl of cellulose acylate being greater than 2.00, the acyl substitution degree thereof is sufficient in terms of humidity stability and polarizing plate durability. In addition, by the substitution degree of acyl thereof being smaller than 2.6, the cellulose acylate is made into cellulose acylate which exhibits excellent optical characteristics, and has excellent solubility in an organic solvent and excellent compatibility with a polycondensate that can be used as an additive, which is preferable.

The acyl group included in the cellulose acylate may be an aliphatic acyl group or an aromatic acyl group, which is not particularly limited, and may be used alone or as a combination of two or more kinds thereof.

The carbon number of the acyl group is preferably in the range of 2 to 22, and particularly preferably 2 or 3. Examples of the acyl group include alkyl carbonyl ester of cellulose, alkenyl carbonyl ester, aromatic carbonyl ester, and aromatic alkyl carbonyl ester, and each of the examples may include a further substituted group. Preferable examples of the acyl group include an acteyl group, a propionyl group, a butanoyl group, a heptanoyl group, a hexanoyl group, an octanoyl group, a decanoyl group, a dodecanoyl group, a tridecanoyl group, tetradecanoyl group, a hexadecanoyl group, an octadecanoyl group, an i-butanoyl group, t-butanoyl group, a cyclohexane carbonyl group, an oleoyl group, a benzoyl group, a naphthyl carbonyl group, and a cinnamoyl group. Among these, an acetyl group, a propionyl group, a butanoyl group, a dodecanoyl group, an octadecanoyl group, a t-butanoyl group, an oleoyl group, a benzoyl group, a naphthyl carbonyl group, and a cinnamoyl group are preferable, and an acetyl group, a propionyl group, and a butanoyl group are more preferable. An acetyl group and a propionyl group are still more preferable and an acetyl group is most preferable.

### [Polymerization Degree of Cellulose Acylate]

The polymerization degree of the cellulose acylate preferably used in the present invention is in the range of 180 to 700 in terms of a viscosity average polymerization degree, in cellulose acetate, more preferably in the range of 180 to 550, still more preferably in the range of 180 to 400, and particularly preferably in the range of 180 to 350. When the polymerization degree is less than or equal to the upper limit, the viscosity of a dope solution of cellulose acylate does not become extremely high and preparation of a film by casting can be easily done, which is preferable. When the polymerization degree is more than or equal to the lower limit, inconvenience such as a decrease in strength of the prepared film does not occur, which is preferable. The viscosity average polymerization degree can be measured using an intrinsic viscosity method created by Uda and colleague {Kazuo Uda and Hideo Saito, “Textile Academic Journal,” Vol. 18, No. 1, pp. 105 to 120 (in 1962)}. The method is described in JP-A-9-95538 in detail.

The molecular weight distribution of the cellulose acylate preferably used in the present invention is evaluated using gel permeation chromatography, and a polydispersity index Mw/Mn (Mw represents a mass average molecular weight and Mn represents a number average molecular weight) thereof is preferably small and the molecular weight distribution is preferably small. Specific values of Mw/Mn are preferably in the range of 0 to 4.0, more preferably in the range of 2.0 to 4.0, and most preferably in the range of 2.3 to 3.4.

### [Method of Producing Cellulose Acylate Film]

It is preferable that the method of producing a cellulose acylate film include a film forming process of casting a dope on a substrate for casting such as a metal substrate, and allowing a solvent to be evaporated to form a cellulose acylate film; a stretching process of stretching the film; a drying process of drying the obtained film; and a process of performing a heat treatment in a temperature range of 150° C. to 200° C. for 1 minute or longer after the drying process is completed.

### (Film Forming Process)

In the present invention, a method or the like of forming a known cellulose acylate film can be widely employed, and it is preferable that a film be produced using the solution casting film-forming method. In the solution casting film-forming method, a film can be produced using a solution (dope) which dissolves cellulose acylate in an organic solvent.

It is preferable that the organic solvent contain a solvent selected from ether having 3 to 12 carbon atoms, ketone having 3 to 12 carbon atoms, ester having 3 to 12 carbon atoms, and halogenated hydrocarbon having 1 to 6 carbon atoms. The ether, ketone, and ester may have a cyclic structure. A compound including any two or more functional groups of ether, ketone, and ester (that is, —O—, —CO—, and COO—) can be used as the organic solvent. The organic solvent may include another functional group such as an alcoholic hydroxyl group. In the case of an organic solvent including two or more kinds of functional groups, the number of carbon atoms may be within a specific range of the compound including any functional group.

Examples of the ethers having 3 to 12 carbon atoms include diisopropyl ether, dimethoxymethane, dimethoxyethane, 1,4-dioxane, 1,3-dioxolane, tetrahydrofuran, anisole, and phenetole.

Examples of the ketones having 3 to 12 carbon atoms include acetone, methyl ethyl ketone (MEK), diethyl ketone, diisobutyl ketone, cyclohexanone, and methyl cyclohexanone.

Examples of esters having 3 to 12 carbon atoms include ethyl formate, propyl formate, pentyl formate, methyl acetate, ethyl acetate, and pentyl acetate.

Examples of the organic solvent including two or more kinds of functional groups include 2-ethoxy ethyl acetate, 2-methoxy ethanol, and 2-buthoxy ethanol.

The number of carbon atoms of the halogenated hydrocarbon is preferably 1 or 2 with 1 being more preferable. Halogen of the halogenated hydrocarbon is preferably chlorine. The ratio of hydrogen atoms of the halogenated hydrocarbon substituted with halogen is preferably in the range of 25% by mole to 75% by mole, more preferably in the range of 30% by mole to 70% by mole, still more preferably in the range of 35% by mole to 65% by mole, and most preferably in the range of 40% by mole to 60% by mole. Methylene chloride is a typical example of halogenated hydrocarbon.

Two or more kinds of organic solvents may be used in combination.

A cellulose acylate solution can be prepared using a general method. The general method means performing a treatment at a temperature of 0° C. or higher. Preparation of the solution can be performed using a method and an apparatus of preparation of a dope in the general solution casting film-forming method. Further, in the case of the general method, it is preferable to use halogenated hydrocarbon (particularly, methylene chloride) as an organic solvent.

The amount of cellulose acylate is adjusted to be contained in the obtained solution in the range of 10% by mass to 40% by mass. The amount of the cellulose acylate is more preferably in the range of 10% by mass to 30% by mass. An arbitrary additive described below may be added to the organic solvent (main solvent).

The solution can be prepared by stirring the cellulose acylate and the organic solvent at room temperature (0° C. to 40° C.). The solution having high concentration may be stirred under a condition of pressurizing and heating. Specifically, cellulose acylate and an organic solvent are put into a pressurized container and tightly sealed, and stirred while being heated at a temperature of the boiling point or higher of the solvent at room temperature under pressure and the range in which the solvent is not boiled. The heating temperature is generally 40° C. or higher, preferably in the range of 60° C. to 200° C., and more preferably in the range of 80° C. to 110° C.

Respective components may be put into a container after the components are roughly mixed in advance. In addition, the components may be sequentially added to the container. The container must have a configuration capable of allowing stirring. Inert gas such as nitrogen gas can be injected to pressurize the container. Further, an increase in the steam pressure of the solvent caused by heating may be used. Alternatively, after the container is tightly sealed, respective components may be added under pressure.

In the case of heating, the heating source is preferably performed from the outside of the container. For example, a jacket-type heating device can be used. Further, the entire container can be heated by providing a plate heater and piping on the outside of the container of the plate heater to circulate a liquid.

It is preferable that a stirring blade be provided in the inside of the container and stirring be carried out using the stirring blade. A stirring blade having a length capable of reaching the vicinity of the container wall is preferable. Since a liquid film of the container wall is updated at the terminal of the stirring blade, it is preferable to provide a scraping blade.

Meters such as a pressure gauge and a thermometer may be installed in the container. Respective components are dissolved in the solvent in the container. The prepared dope is extracted from the container after cooling or cooled using a heat exchanger or the like after extraction.

A cellulose acylate film can be produced from the prepared cellulose acylate solution (dope) using the solution casting film-forming method.

The dope is cast on a drum or a band and allows a solvent to be evaporated to form a film. Preferably, the concentration of the dope before casting is adjusted such that the amount of the solid content is in the range of 18% by mass to 35% by mass. It is preferable to finish the surface of a drum or a band in a mirrored state. The casting and the drying methods in the solution casting film-forming method are described in the respective specifications of U.S. Pat. Nos. 2,336,310, 2,367,603, 2,492,078, 2,492,977, 2,492,978, 2,607,704, 2,739,069, 2,739,070, and UK Patent Nos. 640731 and 736892; and respective publications of JP-B-45-4554, JP-B-49-5614, JP-A-60-176834, JP-A-60-203430, and JP-A-62-115035.

Preferably, the dope is cast on a drum or a band having a surface temperature of 10° C. or lower. It is preferable to dry the dope by blowing air for 2 seconds or longer after the casting. The obtained film is peeled off from the drum or the band, and a residual solvent can be evaporated by being dried using hot air whose temperature is sequentially changed from 100° C. to 160° C. The above-described method is described in JP-B-5-17844. According to the method, the time from the casting to the peeling off can be shortened. In order to perform the method, gelation of the dope is needed at the surface temperature of the drum or the band at the time of casting.

### (Co-Casting)

A film produced by being stretched after formation using the solution casting film-forming method is preferable as the cellulose acylate film used in the present invention. In addition, the solution cast formed film is preferably a multilayer cast formed film simultaneously or sequentially formed by co-casting. This is because the film has a desired retardation value.

The obtained cellulose acylate solution in the present invention may be cast as a single-layer solution on a band or a drum which is flat as a metal substrate or two or more layers of cellulose acylate solutions may be cast. In the case where a plurality of cellulose acylate solutions are cast, a film may be prepared by respectively casting the solutions containing cellulose acylate from plural casting openings provided with intervals in the movement direction of the metal substrate while the solutions are laminated, and methods described in respective publications of JP-A-61-158414, JP-A-1-122419, and JP-A-11-198285 can be employed. In addition, a film may be formed by casting the cellulose acylate solutions from two casting openings, and the methods described in respective publications of JP-B-60-27562, JP-A-61-94724, JP-A-61-947245, JP-A-61-104813, JP-A-61-158413, and JP-A-6-134933 can be performed. Further, a cellulose acylate film-casting method of wrapping the flow of a cellulose acylate solution with high viscosity described in the publication of JP-A-56-162617 with a cellulose acylate solution with low viscosity, and pushing the cellulose acylate solutions with high and low viscosities out may be employed. Further, preferably, solutions on the surface side described in respective publications of JP-A-61-94724 and JP-A-61-94725 may contain significant alcohol components which are poorer solutions than the solutions in the inside thereof.

Alternatively, using two casting openings, a film may be prepared by peeling the film molded to the metal substrate using a first casting opening and performing a second casting on the side in contact with the surface of the metal substrate, and such a method is described in the publication JP-B-44-20235. Cellulose ester solutions to be cast may be the same as each other or cellulose acylate solutions which are different from each other, which are not particularly limited. In order for the plurality of cellulose acylate layers to have functionality, the cellulose acylate solutions according to the functions may be pushed out from the respective casting openings. In addition, in cellulose ester solutions used for the present invention, other functional layers (for example, an adhesive layer, a dye layer, an antistatic layer, an anti-halation layer, a UV absorption layer, a polarizing layer, and the like) may be cast at the same time.

In the single-layer liquid in the related art, it is preferable to push out the cellulose acylate solution with high concentration and high viscosity in order for the layer to have a necessary film thickness, but problems such as generation of solids due to the degraded stability of the cellulose acylate solutions, adhesion of the solids, and loss of flatness are generated. As the solutions therefor, a solution with high viscosity can be pushed out onto the metal substrate at the same time by casting the plurality of cellulose acylate solutions from the casting opening, an excellent planar film can be prepared by improving the flatness, reduction in the drying load can be achieved using a cellulose acylate solution with high concentration, and production speed of the film can be increased.

In the case of co-casting, the thickness on the inside or the surface side is not particularly limited, but the thickness on the surface side is preferably 1% to 50% of the entire film thickness and more preferably 2% to 30% thereof. Here, in the case of co-casting of three or more layers, the total film thickness of an outermost layer in contact with the metal substrate for casting and an outermost layer in contact with the air side is defined as the thickness of the surface side.

In the case of co-casting, a cellulose ester film having a lamination structure can be prepared by co-casting cellulose acylate solutions having substitution degrees different from each other.

Further, a cellulose acylate film having a lamination structure can be prepared by co-casting cellulose acylate solutions having additives described below such as a plasticizer, a UV absorber, and fine particles with concentrations different from one another. For example, fine particles are present in a large amount on the surface layer or can be added to the surface layer. A plasticizer and a UV absorber can be further added to the inner layer of the surface layer, or may be added only to the inner layer. Alternatively, the kinds of the plasticizer and the UV absorber added to the inner layer and the surface layer can be changed. For example, the surface layer may contain a plasticizer and/or a UV absorber with low volatility and a plasticizer with excellent plasticity, or a UV absorber with excellent UV absorbability can be added to the inner layer.

In addition, it is also preferable that a releasing agent be contained only in the surface layer on the metal substrate side. Further, for gelation of a solution by cooling the metal substrate using a cooling drum method, it is preferable that more alcohol which is a poor solution be added to the surface layer than to the inner layer. Tgs of the surface layer and the inner layer may be different from each other. Preferably, Tg of the inner layer is lower than Tg of the surface layer. Alternatively, the viscosities of solutions containing cellulose acylate at the time of casting may be different on the surface layer and the inner layer, and the viscosity of the surface layer is preferably lower than the viscosity of the inner layer, but the viscosity of the inner layer may be lower than the viscosity of the surface layer.

From the viewpoint of peeling from the metal substrate, it is preferable that the substrate be a substrate obtained by laminating cellulose acylate, which is the main component, whose average substitution degree DS of an acyl group satisfies 2.0<DS<2.6 and cellulose acylate (surface layer) whose average substitution degree of an acyl group satisfies the range of 2.6 to 3.0.

### (Drying Process and Stretching Process)

A drying method of a web which is formed on a drum or a belt which is a metal substrate for casting and then peeled therefrom will be described below. The web peeled from a peeling position immediately before the drum or the belt goes round once is conveyed by a conveying method of alternatively passing through a roller group arranged in a zigzag or by a non-contact conveying method allowing both ends of the peeled web to be pinched using clips or the like. The drying is performed using a method of blowing air at a predetermined temperature to both surfaces of the web (film) during conveyance or a method of using heating means such as a microwave. Since rapid drying may damage the flatness of a film to be formed, it is preferable to dry at a temperature at which a solvent does not foam in an initial stage of drying and then to dry at a high temperature when the drying advances. In the drying process after a film is peeled from the metal substrate, the film tends to contract in the longitudinal direction or the width direction due to evaporation of the solvent. The amount of contraction increases as the drying is performed at a higher temperature. In terms of excellent flatness of the completed film, it is preferable to perform drying while the contraction is suppressed as much as possible. Therefore, for example, as described in the publication JP-A-62-46625, a method (tenter system) of performing a total process or a part of the process of drying by holding both ends of the width of the web using clips or pins in the width direction is preferable. The drying temperature in the drying process is preferably in the range of 100° C. to 145° C. The drying temperature, the amount of air for drying, and the drying time are different from one another depending on a solvent to be used, but the solvent to be used may be appropriately selected according to the kind or the combination thereof. In production of the cellulose acylate film used in the present invention, preferably, the web (film) peeled from the metal substrate is stretched when the residual solvent amount in the web is less than 120% by mass.

In addition, the residual solvent amount can be expressed by the following formula.

Residual solvent amount (% by mass)={(M−N)/N}×100

Here, M represents the mass of the web at an arbitrary time point and N represents the mass of the web, whose M has been measured, allowing the web to be dried at 110° C. for 3 hours. An effect of stretching cannot be obtained when the residual solvent amount in the web is extremely large, and the stretching becomes very difficult when the amount thereof is extremely small such that breakage of the web occurs in some cases. The preferable range of the residual solvent amount in the web is 70% by mass or smaller, more preferably 10% by mass to 50% by mass, and particularly preferably 12% by mass to 35% by mass. Further, a phase difference cannot be sufficiently obtained when the stretching ratio is extremely small and the stretching becomes difficult such that breakage occurs when the stretching ratio is extremely large.

The stretching ratio is preferably in the range of 1.3 to 1.9 and more preferably in the range of 1.4 to 1.7.

Further, the stretching may be performed in the longitudinal direction, in the horizontal direction, or in both directions. In addition, since tensile strength is applied with respect to the conveying direction when the web is peeled from the metal substrate for casting, the same effect as the stretching may be generated under the peeling condition with strong tensile strength. The stretching condition is determined by applying such an effect. The cellulose ester film used in the present invention is preferably a film obtained by being stretched in the width direction and the stretching ratio thereof is preferably in the range of 5% to 100% in the vertical direction with respect to the conveying direction. By adjusting the stretching ratio to be 5% or more, Re can be exhibited more appropriately, and bowing becomes excellent. Moreover, by adjusting the stretching ratio to be 70% or less, a film with a tear strength of 1.5 [g·cm/cm] to 6.0 [g·cm/cm] can be obtained while the haze is maintained to be low.

In the present invention, the solution cast formed film can be stretched without heating at a high temperature when the residual solvent amount is in the specific range, but it is preferable that drying and stretching be carried out at the same time from a viewpoint of shortening the process. However, when the temperature of the web is extremely high, a plasticizer is volatilized, accordingly, the range is preferably room temperature (15° C.) to 145° C. Further, stretching in diaxial directions orthogonal to each other is an effective method for refractive indexes nx, ny, and nz of a film to be within the range of the present invention.

In this case, width contraction of a film can be improved by suppressing or stretching in the width direction. In the case of stretching in the width direction, distribution of the refractive indexes occurs in the width direction in some cases. This is a phenomenon, which can be seen when the tenter method is used, and is generated because of an end portion being fixed and the contraction force generated in the center portion of the film by being stretched in the width direction, and is referred to as a so-called bowing phenomenon. Even in this case, the bowing phenomenon can be suppressed by performing stretching in the casting direction and distribution of the phase difference in the width direction can be improved to decrease. Moreover, variation in film thickness of the film obtained by being stretched in the diaxial directions orthogonal to each other can be decreased. When the variation in the film thickness of an optical film becomes extremely large, unevenness in the phase difference is generated. The variation in the film thickness of the optical film is in the range of ±3% and preferably in the range of ±1%. For the above-described purpose, the method of stretching in the diaxial directions orthogonal to each other is effective and the stretching ratios of the diaxial directions orthogonal to each other are preferably in the range of 1.2 times to 2.0 times and in the range of 0.7 times to 1.0 times respectively. Here, adjusting the stretching to be in the range of 1.2 times to 2.0 times with respect to one direction and to be in the range of 0.7 times to 1.0 times with respect to the other orthogonal direction means that the interval of clips or pins supporting the film should be in the range of 0.7 times to 1.0 times with respect to the interval before stretching.

In general, in a case where stretching is adjusted such that the interval is in the range of 1.2 times to 2.0 times in the width direction using a biaxial stretching tenter, the contraction force is applied in the longitudinal direction which is the perpendicular direction.

Accordingly, when the force is applied only in one direction to be continuously stretched, the width in the perpendicular direction is contracted, but this means that the contraction amount is suppressed with respect to the contraction amount without restricting the width and also means that the interval of clips or pins restricting the width is restricted to be in the range of 0.7 times to 1.0 times with respect to the interval before stretching. At this time, in the longitudinal direction, the contraction force of the film is applied due to the stretching in the width direction. By using an interval between clips or pins in the longitudinal direction, tensile strength beyond that which is necessary is not applied in the longitudinal direction. The method of stretching a web is not particularly limited. Examples thereof include a method of allowing a plurality of rolls to be varied in circumferential speed and stretching a web in the longitudinal direction using the difference in the circumferential speed between the rolls; a method of fixing both ends of a web using clips or pins and widening the interval between clips or pins in the movement direction to be stretched in the longitudinal direction; a method of widening a web in the same manner in the horizontal direction to be stretched in the horizontal direction; and a method of longitudinally and horizontally widening a web at the same time as being stretched in both the longitudinal and horizontal directions. Of course, these methods may be used in combination. Further, in the case of a so-called tenter method, when a clip portion is driven using a linear drive system, smooth stretching can be performed and the risk of causing breakage or the like can be reduced, which is preferable.

### [Heat Treatment Process]

In the method of producing the cellulose acylate film used in the present invention, it is preferable that a process of a heat treatment be provided after a drying process is completed. The heat treatment in the process of the heat treatment may be carried out after the drying process is completed, may be carried out immediately after the drying process after a stretching process is performed, or only the process of the heat treatment may be separately done after a film is temporarily wound using a method described below after the drying process is completed. In the present invention, it is preferable to carry out the process of the heat treatment again after the film is temporarily cooled to the temperature range of room temperature to 100° C. when the drying process is completed. This method is advantageous in terms of obtaining a film with more excellent thermal dimensional stability. For the same reason, it is preferable that the residual solvent be dried such that the amount thereof is smaller than 2% by mass and preferably smaller than 0.4% by mass immediately before the process of the heat treatment.

The reason why the contraction ratio of the film can be reduced due to such a process is not clear, but the film which is subjected to a stretching treatment in the stretching process has high residual stress in the stretching direction, and accordingly, it is assumed that the contraction force in an area at a temperature lower than or equal to the temperature of a heat treatment is decreased by eliminating the residual stress through the heat treatment.

The heat treatment is performed by a method of blowing air at a predetermined temperature onto a film during conveyance or a method of using heating means such as a microwave.

The heat treatment is performed preferably in the temperature range of 150° C. to 200° C. and more preferably in the temperature range of 160° C. to 180° C. Further, the heat treatment is performed preferably for 1 minute to 20 minutes and more preferably for 5 minutes to 10 minutes.

When the heating is performed at a temperature of higher than 200° C. for a long period of time during the heat treatment, controlling a post-process or adjusting physical properties becomes difficult in some cases if the scattering amount of volatile components such as a plasticizer contained in the film becomes increased.

In addition, in the process of the heat treatment, the film tends to be contracted in the longitudinal direction or the width direction. It is preferable that the heat treatment be carried out while suppressing the contraction as much as possible in terms of excellent flatness of the formed film, and a method (tenter system) of holding both ends of the width of the web using clips or pins in the width direction is preferable. Moreover, it is preferable to stretch in the range of 0.9 times to 1.5 times more than normal in the width direction and the conveying direction of the film.

A generally used winding machine can be used for winding the obtained film, and the film can be wound using a winding method such as a constant tension method, a constant torque method, a taper tension method, or a program tension control method using constant internal stress. In the optical film roll obtained in the above manner, a slow axis direction of the film is preferably in the range of ±2 degrees with respect to the winding direction (the longitudinal direction of the film) and more preferably in the range of ±1 degree. Alternatively, the perpendicular direction (the width direction of the film) is preferably in the range of ±2 degrees with respect to the winding direction and more preferably in the range of ±1 degree. Particularly, the slow axis direction of the film is preferably within the range of ±0.1 degrees with respect to the winding direction (longitudinal direction of the film). Alternatively, the slow axis direction of the film is preferably within the range of ±0.1 degrees with respect to the width direction of the film.

### [Heating Water Vapor Treatment]

In addition, the film subjected to the stretching treatment may be subsequently subjected to a process of spraying water vapor heated at a temperature of 100° C. or higher. The residual stress of the cellulose acylate film to be produced is relaxed by being subjected to the process of spraying the water vapor, and the dimensional change thereof is small, which is preferable. The temperature of the water vapor is not particularly limited as long as the temperature is 100° C. or higher, but the temperature of the water vapor is preferably 200° C. or lower when heat resistance or the like of the film is considered.

The processes from the casting to the drying may be performed in an air atmosphere or in an inert gas atmosphere such as nitrogen gas. A winding machine used for production of the cellulose ester film used in the present invention may be a machine which is generally used, and a film can be wound using a winding method such as a constant tension method, a constant torque method, a taper tension method, or a program tension control method using constant internal stress.

### [Surface Treatment of Cellulose Acylate Film]

The cellulose ester film can be subjected to a surface treatment. Specific examples thereof include a corona discharge treatment, a glow discharge treatment, a flame treatment, an acid treatment, an alkali treatment, and a UV irradiation treatment. In addition, preferably, an undercoat layer is provided as described in the publication JP-A-7-333433.

From a viewpoint of maintaining the flatness of the film, the temperature of the cellulose acylate film in these treatments is set to Tg (glass transition temperature) or lower and, specifically, the preferable temperature thereof is 150° C. or lower.

In a case where the film is used as a transparent protective film of a polarizing plate, it is particularly preferable to perform an acid treatment or an alkali treatment, that is, a saponification treatment with respect to the cellulose acylate from a viewpoint of adhesion to a polarizer made of materials having a hydrophilic group such as polyvinyl alcohol.

The surface energy is preferably 55 mN/m or greater and more preferably in the range of 60 mN/m to 75 mN/m.

Hereinafter, an alkali saponification treatment will be described as an example.

Preferably, the alkali saponification treatment of the cellulose acylate film is performed as a cycle of immersing the surface of a film in an alkali solution, neutralizing with an acidic solution, washing with water, and drying the resultant.

As the alkali solution, a potassium hydroxide solution or a sodium hydroxide solution is exemplified, and the concentration of hydroxide ions is preferably in the range of 0.1 mole/L to 3.0 mole/L and more preferably in the range of 0.5 mole/L to 2.0 mole/L. The temperature of the alkali solution is preferably in the range of room temperature to 90° C. and more preferably in the range of 40° C. to 70° C.

The surface energy of a solid can be acquired using a contact angle method, a moist heat method, and an adsorption method described in “Bases and Applications of Wetting” (published in Dec. 10, 1989, Realize, Inc.). In the case of the cellulose ester film used in the present invention, it is preferable to use a contact angle method.

Specifically, two kinds of solutions with known surface energy are added dropwise to the cellulose acylate film, an angle between a tangent drawn from the droplet and the surface of the film on the side which contains droplets in an intersection between the surface of the droplet and the surface of the film is defined as a contact angle, and the surface energy of the film can be calculated.

### (Film Thickness)

The film thickness of the cellulose acylate film which is the substrate in the phase difference film of the present invention is preferably in the range of 20 μm to 60 μm, more preferably in the range of 20 μm to 50 μm, and still more preferably in the range of 20 μm to 45 μm. When the film thickness is 20 μm or greater, it is preferable in terms of handling ability or curl suppression of a polarizing plate at the time of processing onto a polarizing plate or the like. Further, unevenness in the film thickness of the cellulose ester film used in the present invention is preferably in the range of 0% to 2%, more preferably in the range of 0% to 1.5%, and particularly preferably in the range of 0% to 1% in both the conveying direction and the width direction.

### (Retardation of Cellulose Acylate Film)

In the present specification, Re(λ) and Rth(λ) each represent in-plane retardation in a wavelength λ, and retardation in the thickness direction. Re is measured by allowing light having a wavelength of λ nm in KOBRA 21ADH (manufactured by Oji Scientific Instruments Co., Ltd.) to be incident in the normal film direction. Rth is calculated based on a retardation value measured in three directions of the above-described Re, a retardation value measured by allowing light with a wavelength of λ nm to be incident from a direction inclined by ±40° C. with respect to the normal film direction using an in-plane slow axis (determined by KOBRA 21ADH) as an inclined axis (rotation axis), and a retardation value measured by allowing light with a wavelength of λ m to be inclined from the direction inclined by −40° C. with respect to the normal film direction using an in-plane slow axis as an inclined axis (rotation axis) with the KOBRA 21ADH. Here, as an assumed value of the average refractive index, values of catalogs of “Polymer Handbook” (JOHN WILEY&SONS, INC.) and various optical films can be used. When a value of the average refractive index is unknown, the value can be measured using an Abbe refractometer. Values of the refractive indexes of main optical films are exemplified as follows: cellulose acylate (1.48), a cycloolefin polymer (1.52), polycarbonate (1.59), polymethyl methacrylate (1.49), and polystyrene (1.59). The KOBRA 21ADH calculates nx, ny, and nz when the assumed values and the film thicknesses of these average refractive indexes are input. An expression of Nz=(nx−nz)/(nx−ny) is further calculated using the calculated nx, ny, and nz.

Further, Re is (nx−ny)×d and Rth is {(nx+ny)/2−nz}×d. Here, nx represents a refractive index in the slow axis direction in the film plane, and ny represents a refractive index in the fast axis direction in the film plane, nz represents a refractive index in the thickness direction of the film, and d represents the thickness (nm) of the film.

The cellulose acylate film is preferably used as a protective film of a polarizing plate and particularly preferably used as a phase difference film corresponding to various liquid crystal modes.

Re of the cellulose acylate film used as a substrate of the phase difference film of the present invention is preferably in the range of 30 nm to 200 nm and more preferably in the range of 80 nm to 150 nm Rth is preferably in the range of 70 nm to 400 nm and more preferably in the range of 80 nm to 150 nm.

In a case where Re is larger than Rth, it is necessary to increase the stretching ratio and the tear strength is decreased, accordingly, Re of the substrate is in the range of 80 nm to 150 nm, Rth is greater than Re, and Rth is preferably in the range of 80 nm to 150 nm from a viewpoint of maintaining the tear strength at the required strength.

Here, Re represents an in-plane retardation value measured using light having a wavelength of 550 nm at 25° C. and at 60% RH, and Rth represents a retardation value in the thickness direction measured using light having a wavelength of 550 nm at 25° C. and at 60% RH.

### (Haze of Film)

The haze of the cellulose acylate film or the phase difference film of the present invention is preferably in the range of 0.01% to 1.0%, more preferably in the range of 0.05% to 0.8%, and still more preferably in the range of 1.0% to 0.7%. When the transparency of the film is high as an optical film, light from a light source can be economically used, which is preferable. The haze can be measured in conformity with JIS K-6714 using a haze meter called “HGM-2DP” (manufactured by Suga Test Instruments Co., Ltd.).

### (Spectral Characteristics and Spectral Transmittance)

The transmittance in the wavelength range of 300 nm to 450 nm can be measured using a cellulose acylate film sample having dimensions of 13 mm×40 mm by a spectrophotometer of “U-3210” (manufactured by Hitachi, Ltd.) at 25° C. and at 60% RH. The inclined width can be acquired by subtracting a 5% wavelength from a 72% wavelength. A threshold wavelength is represented by (inclined width/2)+5% wavelength, and an absorption end can be represented by a wavelength having a transmittance of 0.4%.

In this manner, transmittance of a wavelength of 380 nm or a wavelength of 350 nm can be evaluated.

### (Glass Transition Temperature)

The glass transition temperature of the cellulose acylate film used in the present invention is preferably 120° C. or higher and more preferably 140° C. or higher.

The glass transition temperature can be acquired as an average value between a temperature whose base line derived from glass transition of a film begins to change when measured at a temperature rise rate of 10° C./min using a differential scanning calorimeter (DSC) and a temperature which returns to the base line again.

In addition, the glass transition temperature can be measured using a dynamic viscoelasticity measuring device as described below. The glass transition temperature of a cellulose acylate film sample (not stretched) used in the present invention, which has dimensions of 5 mm×30 mm, is measured under the conditions of a distance between grips of 20 mm, a temperature rise rate of 2° C./min, a measured temperature range of 30° C. to 250° C., and a frequency of 1 Hz using a dynamic viscoelasticity measuring device (Vibron: DVA-225 (manufactured by Keisoku Seigyo Co., Ltd.) after the humidity is controlled at 25° C. and at 60% RH for 2 hours or longer, and an intersection of a straight line 1 which is drawn in a solid area upon dramatic decrease of the storage elastic modulus which appears when the storage elastic modulus is moved to the glass transition area from the solid area and a straight line 2 which is drawn in the glass transition area is a temperature at which the storage elastic modulus is dramatically decreased at the time of temperature rise and the film begins to be softened and is also a temperature which begins to move to the glass transition area, accordingly the intersection is set to the glass transition temperature Tg (dynamic viscoelasticity) when the storage elastic modulus is shown with a logarithmic axis on the vertical axis and the temperature (° C.) is shown with a linear axis on the horizontal axis.

### [Moisture Permeability of Film]

The moisture permeability of a film can be measured under the conditions of a temperature of 60° C. and at 95% RH in conformity with JIS Z-0208.

The moisture permeability becomes decreased when the film thickness of the cellulose acylate film is thicker and becomes increased when the film thickness thereof is thinner. In samples with different film thicknesses, conversion is needed after a sample with a film thickness of 40 μm is provided as a reference. The conversion of the film thickness can be performed according to the following expression.

Expression: Moisture permeability of 40 μm conversion=Measured moisture permeability×Measured film thickness (μm)/40 (μm)

A method described in “Physical properties II of Macromolecules” (Macromolecule Experimental Course 4, Kyoritsu Shuppan Co., Ltd.), pp. 285 to 294 “Measurement of Vapor permeation amount (mass method, thermometer method, vapor pressure method, and adsorbed amount method)” can be applied for the measuring method of the moisture permeability.

The cellulose acylate film of the present invention and the moisture permeability of the phase difference film are each preferably in the range of 400 g/m²/24 hours to 2500 g/m²/24 hours, more preferably in the range of 400 g/m²/24 hours to 2350 g/m²/24 hours, and particularly preferably in the range of 400 g/m²/24 hours to 2200 g/m²/24 hours. When the moisture permeability is 2200 g/m²/24 hours or less, there is no inconvenience occurring when an absolute value of temperature dependence of the Re value or the Rth value of the film exceeds 0.5 nm/% RH, which is preferable.

### (Dimensional Change Rate of Film)

In regard to the dimensional stability of the cellulose acylate film used in the present invention, it is preferable that the dimensional change rate in a case where the film is left alone under the conditions of a temperature of 60° C. at 90% RH for 24 hours (high humidity) and the dimensional change rate in a case where the film is left alone under the conditions of a temperature of 80° C. at 5% RH for 24 hours (low humidity) be 0.5% or less, more preferably 0.3% or less, and still more preferably 0.15% or less.

### (Configuration of Cellulose Acylate Film)

The cellulose acylate film used in the present invention may be a single layer structure or a multilayer structure, but a single layer structure is preferable. Here, a film having a “single layer structure” means not a film to which a plurality of film materials are attached but a sheet of cellulose acylate film. Here, a case where a sheet of cellulose acylate film is produced using a sequential casting system or a co-casting system from a plurality of cellulose acylate solutions is included in a range of the “single layer structure.”

In this case, a cellulose acylate film which has an appropriate distribution in the thickness direction by adjusting the kind or the blending amount of an additive, molecular weight distribution of cellulose acylate, or the kind of cellulose acylate can be obtained. Further, a sheet of film including various functional portions such as an optically anisotropic portion, a gas barrier portion, a moisture resistance portion, and the like can be said to have a “single layer structure.”

### (Additive)

The substrate of the phase difference film of the present invention contains at least one kind of compound selected from a group consisting of i) and ii) described below.

Adjustment of the moisture permeability and the moisture content due to the application of hydrophobicity or adjustment of mechanical physical properties due to application of plasticity can be easily done by adding these compounds.

i) Polycondensation ester containing a dicarboxylic acid residue that contains at least one kind of aromatic dicarboxylic acid residue and has an average carbon number of 5.5 to 10.0, or

ii) Sugar ester having 1 to 12 pyranose structures or furanose structures in which at least one hydroxyl group is aromatically esterified

The compounds of i) and ii) have functions as a plasticizer, but polarizing plate durability can be improved using a phase difference film which contains a cellulose acylate film obtained by adding these compounds to the cellulose acylate whose substitution degree DS of an acyl group described above satisfies 2.0<DS<2.6 as a polarizing plate protective film.

### [i) Polycondensation Ester]

i) Polycondensation ester (also noted as “i) polycondensation ester”) containing a dicarboxylic acid residue that contains at least one kind of aromatic dicarboxylic acid residue and has the average carbon number of 5.5 to 10.0 will be described.

i) The polycondensation ester can be obtained from dicarboxylic acid (also referred to as aromatic dicarboxylic acid) having at least one kind of aromatic ring and from at least one kind of diol.

### (Aromatic Dicarboxylic Acid Residue)

The aromatic dicarboxylic acid residue is contained in polycondensation ester obtained from dicarboxylic acid containing diols and aromatic dicarboxylic acid.

In the present specification, a residue represents a partial structure of polycondensation ester, which has a characteristic of a monomer forming polycondensation ester. For example, a dicarboxylic acid residue formed of dicarboxylic acid HOOC—R—COOH (R represents a hydrocarbon group) is —OC—R—CO—.

The content ratio (ratio of the aromatic dicarboxylic acid residues) of the aromatic dicarboxylic acid residue in polycondensation ester is preferably 40% by mole or greater, more preferably in the range of 40% by mole to 95% by mole, still more preferably in the range of 45% by mole to 70% by mole, and particularly preferably in the range of 50% by mole to 70% by mole.

By adjusting the ratio of the aromatic dicarboxylic acid residues to be 40% by mole or greater, a cellulose acylate film sufficiently exhibiting optical anisotropy can be obtained and a polarizing plate with excellent durability can be obtained. In addition, when the ratio of the aromatic dicarboxylic acid residues is 95% by mole or less, compatibility with cellulose acylate becomes excellent and bleedout hardly occurs at the time when the cellulose acylate film is formed, and heated or stretched.

Examples of the aromatic dicarboxylic acid include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid, and 2,6-naphthalene dicarboxylic acid. Among these, phthalic acid, terephthalic acid, and isophthalic acid are preferable, phthalic acid and terephthalic acid are more preferable, and terephthalic acid is still more preferable.

i) An aromatic dicarboxylic acid residue is formed in polycondensation ester by aromatic dicarboxylic acid used as a raw material.

Specifically, the aromatic dicarboxylic acid residue preferably contains at least one kind from among a phthalic acid residue, a terephthalic acid residue, and an isophthalic acid residue, more preferably contains at least one kind from among a phthalic acid residue and a terephthalic acid residue, and still more preferably contains a terephthalic acid residue.

A cellulose acylate film which has further excellent compatibility with cellulose acylate and in which bleedout hardly occurs at the time when the cellulose acylate film is formed, and heated or stretched can be made using terephthalic acid as aromatic dicarboxylic acid. Further, the aromatic dicarboxylic acid can be used alone or as a combination of two or more kinds thereof. When two or more kinds thereof are used, phthalic acid and terephthalic acid are preferably used.

It is preferable to use a combination of two kinds of aromatic dicarboxylic acids which are phthalic acid and terephthalic acid in terms of softening polycondensation ester at room temperature and easy handling.

The content of the terephthalic acid residue in the dicarboxylic acid residue of polycondensation ester is preferably in the range of 40% by mole to 95% by mole, more preferably in the range of 45% by mole to 70% by mole, and still more preferably in the range of 50% by mole to 70% by mole.

A cellulose acylate film sufficiently exhibiting optical anisotropy can be obtained by adjusting the amount of the terephthalic acid residue to be 40% by mole or greater. Further, when the amount thereof is 95% by mole or less, compatibility with cellulose acylate becomes excellent and bleedout hardly occurs at the time when the cellulose acylate film is formed, and heated or stretched.

### (Aliphatic Dicarboxylic Acid Residue)

i) Polycondensation ester may contain an aliphatic dicarboxylic acid residue in addition to the aromatic dicarboxylic acid residue.

The aliphatic dicarboxylic acid residue is contained in polycondensation ester obtained from dicarboxylic acid containing diols and aliphatic dicarboxylic acid.

Examples of the aliphatic dicarboxylic acid include oxalic acid, malonic acid, succinic acid, maleic acid, fumaric acid, glutaric acid, adipic acid, pimelic acid, suberic acid, azelaic acid, sebacic acid, dodecane dicarboxylic acid, or 1,4-cyclohexane dicarboxylic acid.

The aliphatic dicarboxylic acid may be used alone or as a combination of two or more kinds thereof. When two or more kinds thereof are used, succinic acid and adipic acid are preferably used. When one kind thereof is used, succinic acid is preferably used. This is preferable in terms of adjusting the average carbon number of a diol residue to be a desired value and compatibility with cellulose acylate.

The average carbon number of the dicarboxylic acid residue contained in i) polycondensation ester is in the range of 5.5 to 10.0. The average carbon number of the dicarboxylic acid residue is preferably in the range of 5.5 to 8.0 and more preferably in the range of 5.5 to 7.0. When the average of carbon number of the dicarboxylic acid residue is 5.5 or greater, it is possible to obtain a polarizing plate with excellent durability. When the average of carbon number of the dicarboxylic acid residue is 10.0 or fewer, compatibility with cellulose acylate becomes excellent and occurrence of bleedout can be prevented at the time when the cellulose acylate film is formed.

In regard to the calculation of the average carbon number of the dicarboxylic acid residue, a value calculated by multiplying the composition ratio (molar fraction) of the dicarboxylic acid residue by the number of constituent carbon atoms is set to the average carbon number. For example, when the configuration is formed of 50% by mole of an adipic acid residue and 50% by mole of a phthalic acid reside, the average carbon number thereof becomes 7.0. In addition, in the same manner as the case of the diol residue, the average carbon number of the aliphatic diol residue is set to a value calculated by multiplying the composition ratio (molar fraction) of the aliphatic diol residue by the number of constituent carbon atoms. For example, in a case where the configuration is formed of 50% by mole of an ethylene glycol residue and 50% by mole of 1,2-propanediol residue, the average carbon number thereof becomes 2.5.

### (Aliphatic Diol)

The aliphatic diol residue is contained in polycondensation ester obtained from aliphatic diol and dicarboxylic acid.

In the present specification, a residue represents a partial structure of polycondensation ester, which has a characteristic of a monomer forming polycondensation ester. For example, a diol residue formed of diol HO—R—OH is —O—R—O—.

i) Examples of diols forming polycondensation ester include aromatic diol and aliphatic diol, and it is preferable to contain at least aliphatic diol.

i) The polycondensation ester contains preferably an aliphatic diol residue whose average carbon number is in the range of 2.5 to 7.0 and more preferably an aliphatic diol residue whose average carbon number is in the range of 2.5 to 4.0. When the average carbon number of the aliphatic diol residue is 7.0 or smaller, the compatibility with cellulose acylate is high and bleedout hardly occurs, the heating loss of a compound is small, and process contamination at the time of drying a web of cellulose acylate is reduced, accordingly, planar failure hardly occurs. Moreover, from a viewpoint of synthesis, it is preferable that the average carbon number of the aliphatic diol residue be 2.5 or greater.

Examples of the aliphatic diol used in the present invention include alkyldiol and alicyclic diols, specifically, ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol(neopentyl glycol), 2,2-diethyl-1,3-propanediol(3,3-dimethylolpentane), 2-n-butyl-2-ethyl-1,3-propanediol(3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, diethylene glycol, and cyclohexanedimethanol. Preferably, these may be used as one kind or a mixture two or more kinds thereof together with ethylene glycol.

As aliphatic diol, at least one kind from among ethylene glycol, 1,2-propanediol, and 1,3-propanediol is preferable and at least one kind between ethylene glycol and 1,2-propanediol is particularly preferable. In a case of using two kinds thereof, ethylene glycol and 1,2-propanediol are preferably used. It is possible to prevent crystallization of polycondensation ester by means of using 1,2-propanediol or 1,3-propanediol.

i) A diol residue is formed in polycondensation ester by diols used as a raw material.

The diol residue preferably contains at least one kind from among an ethylene glycol residue, a 1,2-propanediol residue, and a 1,3-propanediol residue and more preferably contains an ethylene glycol residue or a 1,2-propanediol residue.

### (Terminal Sealing)

The terminal of i) polycondensation ester used in the present invention is not sealed, accordingly, a hydroxyl group or carboxylic acid may be left to be exposed or so-called terminal sealing may be performed by reacting monocarboxylic acids or monoalcohols.

As the monocarboxylic acids used for terminal sealing, acetic acid, propionic acid, butanoic acid, and benzoic acid are preferable, acetic acid and propionic acid are more preferable, and acetic acid is most preferable. As the monoalcohols used for sealing, methanol, ethanol, propanol, isopropanol, butanol, and isobutanol are preferable and methanol is most preferable. When the number of carbon atoms of monocarboxylic acids used for terminal of i) polycondensation ester is 3 or fewer, the heating loss of a compound is not increased, so that planar failure does not occur.

It is more preferable that the terminal of i) polycondensation ester used in the present invention be not sealed, accordingly, a diol residue may be left to be exposed or still more preferable that the terminal thereof be sealed by acetic acid or propionic acid.

Both terminals of the polycondensation ester according to the present invention may or may not be sealed.

In the case where both terminals of a condensate are not sealed, it is preferable that polycondensation ester be polyester polyol.

As one form of i) polycondensation ester according to the present invention, polycondensation ester in which the carbon number of the aliphatic diol residue is in the range of 2.5 to 7.0 and both terminals of a condensate are not sealed can be exemplified.

In the case where both terminals of a condensate are sealed, it is preferable that the terminals be sealed by being reacted with monocarboxylic acid. At this time, both terminals of the polycondensation ester become monocarboxylic acid residues. In the present specification, the residue represents a partial structure of polycondensation ester, which has a characteristic of a monomer forming polycondensation ester. For example, a monocarboxylic acid residue formed of monocarboxylic acid R—COOH is R—CO—. The monocarboxylic acid residue is preferably an aliphatic monocarboxylic acid residue, more preferably an aliphatic monocarboxylic acid residue in which the monocarboxylic acid residue has a carbon number of 22 or fewer, and still more preferably an aliphatic monocarboxylic acid residue having a carbon number of 3 or fewer. Further, an aliphatic monocarboxylic acid residue having a carbon number of 2 or more is preferable and an aliphatic monocarboxylic acid residue having a carbon number of 2 is particularly preferable.

As one mode of i) polycondensation ester according to the present invention, polycondensation ester in which the carbon number of the aliphatic diol residue is in the range of more than 2.5 to 7.0 and both terminals of a condensate are monocarboxylic acid residues can be exemplified.

When the carbon number of the monocarboxylic acid residue of both terminals of i) polycondensation ester is 3 or fewer, the volatility is decreased and the loss caused by heating the polycondensation ester is not increased, accordingly, it is possible to reduce the generation of process contamination or planar failure.

That is, as the monocarboxylic acids used for sealing, aliphatic monocarboxylic acid is preferable. The monocarboxylic acid is more preferably aliphatic monocarboxylic acid having a carbon number of 2 to 22, still more preferably aliphatic monocarboxylic acid having a carbon number of 2 to 3, and particularly preferably an aliphatic monocarboxylic acid residue having a carbon number of 2.

As the aliphatic monocarboxylic acid, acetic acid, propionic acid, butanoic acid, or derivatives thereof are preferable, acetic acid or propionic acid is more preferable, and acetic acid is most preferable. Monocarboxylic acid used for sealing may be used by mixing two or more kinds thereof.

It is preferable that both terminals of the polycondensation ester used in the present invention be sealed by acetic acid or propionic acid and most preferable that both terminals thereof become actyl ester residues (also referred to as an acetyl residue) from sealing with acetic acid.

In the case where both terminals thereof are sealed, the shape of a state at room temperature hardly changes into a solid shape and handling becomes easy, accordingly, a cellulose ester film with excellent humidity stability and polarizing plate durability can be obtained.

The number average molecular weight of the i) polycondensation ester is preferably in the range of 500 to 2000, more preferably in the range of 600 to 1500, and still more preferably in the range of 700 to 1200. When the number average molecular weight of the polycondensation ester is 600 or greater, the volatility is decreased, and film failure or process contamination due to volatilization under the condition of the high temperature at the time of stretching the cellulose acylate film hardly occurs. In addition, when the number average molecular weight of the polycondensation ester is 2000 or less, compatibility with cellulose acylate becomes excellent and bleedout hardly occurs at the time when the cellulose acylate film is formed, and heated or stretched.

The number average molecular weight of i) the polycondensation ester used in the present invention can be measured or evaluated by gel permeation chromatography and polystyrene can be generally used as a standard sample. Further, in a case of polyester polyol whose terminal is not sealed, the number average molecular weight can be calculated using the amount of hydroxyl groups (hereinafter, hydroxyl value) per weight. The hydroxyl value can be obtained by measuring the amount (mg) of potassium hydroxide necessary for neutralization of an excessive amount of acetic acids after polyester polyol is acetylated.

Specific examples A-1 to A-31 and B-1 to B-10 of i) the polycondensation ester according to the present invention are listed in Table 1 below, but polycondensation ester is not limited thereto.

TABLE 1

| | Dicarboxylic acid *1) | | | | Diol | | | | | Number |
|---|---|---|---|---|---|---|---|---|---|---|
| | Aromatic | Aliphatic | Ratio of | Average | | | Ratio of | Average | | average |
| | dicarboxylic | dicarboxylic | dicarboxylic acid | carbon | | | diol | carbon | | molecular |
| | acid | acid | (% by mole) | number | Diol 1 | Diol 2 | (% by mole) | number | Terminal | weight |
| A-1 | TPA | SA | 45/55 | 5.80 | ethanediol | propanediol | 45/55 | 2.55 | Acetyl ester residue | 750 |
| A-2 | TPA | SA | 50/50 | 6.00 | ethanediol | propanediol | 45/55 | 2.55 | Acetyl ester residue | 750 |
| A-3 | TPA | SA | 55/45 | 6.20 | ethanediol | propanediol | 45/55 | 2.55 | Acetyl ester residue | 750 |
| A-4 | TPA | SA | 65/35 | 6.60 | ethanediol | propanediol | 45/55 | 2.55 | Acetyl ester residue | 750 |
| A-5 | TPA | SA | 55/45 | 6.20 | ethanediol | propanediol | 25/75 | 2.75 | Acetyl ester residue | 800 |
| A-6 | TPA | SA | 55/45 | 6.20 | ethanediol | propanediol | 10/90 | 2.90 | Acetyl ester residue | 800 |
| A-7 | 2,6-NPA | SA | 50/50 | 6.00 | ethanediol | propanediol | 45/55 | 2.55 | Acetyl ester residue | 850 |
| A-8 | 2,6-NPA | SA | 50/50 | 9.00 | ethanediol | propanediol | 45/55 | 2.55 | Acetyl ester residue | 850 |
| A-9 | TPA/PA | SA | 45/5/50 | 6.00 | ethanediol | propanediol | 45/55 | 2.55 | Acetyl ester residue | 1500 |
| A-10 | TPA/PA | SA | 40/10/50 | 6.00 | ethanediol | propanediol | 45/55 | 2.55 | Acetyl ester residue | 1200 |
| A-11 | TPA | SA/AA | 50/30/20 | 6.40 | ethanediol | propanediol | 45/55 | 2.55 | Acetyl ester residue | 1200 |
| A-12 | TPA | SA/AA | 50/20/30 | 6.60 | ethanediol | propanediol | 45/55 | 2.55 | Acetyl ester residue | 1000 |
| A-13 | TPA | AA | 50/50 | 7.00 | ethanediol | propanediol | 45/55 | 2.55 | Acetyl ester residue | 750 |
| A-14 | TPA | SA | 55/45 | 6.20 | ethanediol | butanediol | 25/75 | 3.50 | Acetyl ester residue | 1800 |
| A-15 | TPA | SA | 55/45 | 6.20 | ethanediol | Cyclohexane | 25/75 | 5.50 | Acetyl ester residue | 850 |
| | | | | | | dimethanol | | | | |
| A-16 | TPA | SA | 45/55 | 5.80 | ethanediol | propanediol | 45/55 | 2.55 | Hydroxyl group | 750 |
| A-17 | TPA | SA | 50/50 | 6.00 | ethanediol | propanediol | 45/55 | 2.55 | Hydroxyl group | 750 |
| A-18 | TPA | SA | 55/45 | 6.20 | ethanediol | propanediol | 45/55 | 2.55 | Hydroxyl group | 750 |
| A-19 | TPA | SA | 55/35 | 6.60 | ethanediol | propanediol | 45/55 | 2.55 | Hydroxyl group | 750 |
| A-20 | TPA | SA | 55/45 | 6.20 | ethanediol | propanediol | 25/75 | 2.75 | Hydroxyl group | 1800 |
| A-21 | TPA | SA | 55/45 | 6.20 | ethanediol | propanediol | 10/90 | 2.90 | Hydroxyl group | 1200 |
| A-22 | 2,6-NPA | SA | 50/50 | 6.00 | ethanediol | propanediol | 25/75 | 2.75 | Hydroxyl group | 1000 |
| A-23 | 2,6-NPA | AA | 50/50 | 9.00 | ethanediol | propanediol | 25/75 | 2.75 | Hydroxyl group | 850 |
| A-24 | TPA/PA | SA | 45/5/50 | 6.00 | ethanediol | propanediol | 25/75 | 2.75 | Hydroxyl group | 850 |
| A-25 | TPA/PA | SA | 40/10/50 | 6.00 | ethanediol | propanediol | 25/75 | 2.75 | Hydroxyl group | 900 |
| A-26 | TPA | SA/AA | 50/30/20 | 6.40 | ethanediol | propanediol | 25/75 | 2.75 | Hydroxyl group | 750 |
| A-27 | TPA | SA/AA | 50/20/30 | 6.60 | ethanediol | propanediol | 25/75 | 2.75 | Hydroxyl group | 850 |
| A-28 | TPA | AA | 50/50 | 7.00 | ethanediol | propanediol | 25/75 | 2.75 | Hydroxyl group | 900 |
| A-29 | TPA | SA | 55/45 | 6.20 | ethanediol | butanediol | 25/75 | 3.50 | Hydroxyl group | 1800 |
| A-30 | TPA | SA | 55/45 | 6.20 | ethanediol | Cyclohexane | 25/75 | 5.50 | Hydroxyl group | 550 |
| | | | | | | dimethanol | | | | |
| A-31 | TPA | SA | 55/45 | 6.20 | ethanediol | propanediol | 45/55 | 2.25 | Propionyl ester | 750 |
| | | | | | | | | | residue | |
| B-1 | TPA | SA | 55/45 | 5.20 | ethanediol | propanediol | 50/50 | 2.50 | Acetyl ester residue | 1000 |
| B-2 | TPA | — | 100 | 6.00 | — | propanediol | 100 | 3.00 | Benzoyl ester | 1000 |
| | | | | | | | | | residue | |
| B-3 | TPA | AA | 35/55 | 6.70 | ethanediol | propanediol | 45/55 | 2.55 | Acetyal ester | 750 |
| | | | | | | | | | residue | |
| B-4 | 2,6-NPA | SA | 50/50 | 8.00 | ethanediol | propanediol | 45/55 | 2.55 | Acetyal ester | 850 |
| | | | | | | | | | residue | |
| B-5 | TPA | SA/AA | 20/20/60 | 5.20 | ethanediol | propanediol | 50/50 | 2.50 | Acetyal ester | 1000 |
| | | | | | | | | | residue | |
| B-6 | TPA | SA | 55/45 | 5.20 | — | butanediol | 100 | 4.00 | Hydroxyl group | 900 |
| B-7 | TPA | SA | 55/45 | 6.20 | — | Cyclohexane | 100 | 8.00 | Hydroxyl group | 850 |
| | | | | | | dimethanol | | | | |
| B-8 | TPA | SA | 55/45 | 6.20 | ethanediol | — | 100 | 2.00 | Hydroxyl group | 750 |
| B-9 | TPA | SA | 55/45 | 6.20 | ethanediol | propanediol | 45/55 | 2.55 | Hydroxyl group | 450 |
| B-10 | TPA | SA | 55/45 | 6.20 | ethanediol | propanediol | 45/55 | 2.55 | Hydroxyl group | 2500 |

*1) PA: phthalic acid, TPA: terephthalic acid, IPA: isophthalic acid, AA: Adipic acid, SA: succinic acid, 2,6-NPA: 2,6-naphthalene dicarboxylic acid

i) Polycondensation ester can be easily synthesized using any method of a heat melting condensation method by a transesterification reaction or a polyesterification reaction between diols and dicarboxylic acid using a normal method or an interface condensation method between acid chloride of these acids and glycols. In addition, i) the polycondensation ester according to the present invention is specifically described in “Theory and Applications of Plasticizer” edited by Koichi Murai (Saiwai Shobo Co., Ltd. first edition published in Mar. 1, 1973). Moreover, materials described in respective publications in JP-A-05-155809, JP-A-05-155810, JP-A-5-197073, JP-A-2006-259494, JP-A-07-330670, JP-A-2006-342227, and JP-A-2007-003679 can be used.

The content of i) polycondensation ester of the cellulose acylate film is preferably in the range of 1% by mass to 30% by mass, more preferably in the range of 3% by mass to 25% by mass, and still more preferably in the range of 5% by mass to 20% by mass relative to cellulose acylate.

The content of aliphatic diol, dicarboxylic acid ester, or diol ester which is a by-product that can be synthesized at the time of synthesizing i) polycondensation ester in cellulose acylate film is preferably less than 1% by mass and more preferably less than 0.5% by mass. Examples of the dicarboxylic acid ester include phthalic acid dimethyl, phthalic acid di(hydroxyethyl), terephthalic acid dimethyl, terephthalic acid di(hydroxyethyl), adipic acid di(hydroxyethyl), and succinic acid di(hydroxyethyl). Examples of diol ester include ethylene diacetate and propylene acetate.

The kinds and ratios of respective residues of a dicarboxylic acid residue, a diol residue, and a monocarboxylic acid residue which are contained in i) polycondensation ester used in the present invention can be measured by a normal method using H-NMR. In general, deuterated chloroform can be used as a solvent.

An acetic anhydride method described in Japanese Industrial Standards JIS K3342 (abolition) can be applied to measurement of the hydroxyl value of i) polycondensation ester. In a case where the polycondensate is polyester polyol, the hydroxyl value is preferably in the range of 50 to 190 and more preferably in the range of 50 to 130.

### [ii) Sugar Ester]

ii) Sugar ester (also referred to as “ii) sugar ester”) having 1 to 12 pyranose structures or furanose structures in which at least one hydroxyl group is aromatically esterified will be described.

Since exhibition of optical characteristics is not degraded and the internal haze at the time when a moist heat treatment is performed after stretching is not deteriorated by adding a ii) sugar ester compound to a cellulose acylate film, front contrast can be highly improved using a phase difference film with this cellulose acylate film for a liquid crystal display device.

A structure (hereinafter, also referred to as a sugar residue) derived from a monosaccharide or a di- or higher polysaccharide constituting a sugar ester compound is included in ii) the sugar ester compound. The structure derived from a monosaccharide of the sugar residue is referred to as a structure unit of the sugar ester compound. The structure unit of the sugar ester compound has 1 to 12 pyranose structure units or furanose structure units. The structure unit thereof may include a sugar residue other than the pyranose structure unit or the furanose structure unit, but the whole sugar residues are preferably pyranose structure units or furanose structure units. In addition, in the case where ii) the sugar ester is configured of a polysaccharide, it is preferable that the whole sugar residues contain both the pyranose structure units and the furanose structure units.

The sugar residue of ii) the sugar ester compound may be derived from pentoses or hexoses, but the sugar residue thereof is preferably derived from hexoses.

The number of structure units included in ii) the sugar ester compound is preferably in the range of 1 to 12, more preferably in the range of 1 to 6, and particularly preferably 1 or 2.

In the present invention, ii) the sugar ester compound is a sugar ester compound having 1 to 12 pyranose structure units or furanose structure units in which at least one hydroxyl group is aromatically esterified, and preferably a sugar ester compound having one or two pyranose structure units or furanose structure units in which at least one hydroxyl group is aromatically esterified.

Examples of saccharides having the monosaccharide or 2 to 12 monosaccharide units include erythrose, threose, ribose, arabinose, xylose, lyxose, allose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbeliferose, lycotetraose, maltotetraose, stachyose, maltopentaose, verbascose, maltohexaose, α-cyclodextrin, β-cyclodextrin, γ-cyclodextrin, δ-cyclodextrin, xylitol, and sorbitol.

Among these, ribose, arabinose, xylose, lyxose, glucose, fructose, mannose, galactose, trehalose, maltose, cellobiose, lactose, sucrose, sucralose, α-cyclodextrin, β-cyclodextrin, γ-cyclodextrin, δ-cyclodextrin, xylitol, and sorbitol are preferable; arabinose, xylose, glucose, fructose, mannose, galactose, maltose, cellobiose, sucrose, β-cyclodextrin, and γ-cyclodextrin are more preferable; and xylose, glucose, fructose, mannose, galactose, maltose, cellobiose, sucrose, xylitol, and sorbitol are particularly preferable. The paragraph [0059] of JP-A-2009-1696 describes ii) the sugar ester compound which has a glucose skeleton or a sucrose skeleton as a compound 5, and a glucose skeleton or a sucrose skeleton is particularly preferable from a viewpoint of compatibility with cellulose acylate when compared to a sugar ester compound having a maltose skeleton used in examples of the same document.

### —Structure of Substituent—

It is more preferable that ii) the sugar ester compound used in the present invention contain a substituent being already used and have a structure represented by the following general formula (1).

(OH)ₚ-G-(L¹-R¹¹)_{q}(O—R¹²)ᵣ General Formula (1)

In the general formula (1), G represents a sugar residue, L¹ represents any one of —O—, —CO—, and —NR¹³—, R¹¹ represents a hydrogen atom or a monovalent substituent, and R¹² represents a monovalent substituent bonded by an ester bond. Further, each of p, q, and r independently represents an integer of 0 or more, p+q+r is equivalent to the number of hydroxyl groups when it is assumed that G represents unsubstituted saccharides having a cyclic acetal structure.

The preferable range of G is the same as that of the sugar residue.

L′ is preferably —O— or —CO— and more preferably —O—. In the case where L′ is —O—, L′ is particularly preferably a linking group derived from an ether bond or an ester bond and more particularly preferably a linking group derived from an ester bond.

Further, when a plurality of L¹'s are present, each L¹ may be the same as or different from every other L¹.

It is preferable that at least one of R¹¹ and R¹² include an aromatic ring.

Particularly, when L¹ is —O— (that is, in a case where R¹¹ and R¹² are substituted in a hydroxyl group in the sugar ester compound), R¹¹, R¹², and R¹³ are preferably selected from a substituted or unsubstituted acyl group, a substituted or unsubstituted aryl group, a substituted or unsubstituted alkyl group, and a substituted or unsubstituted amino group; more preferably selected from a substituted or unsubstituted acyl group, a substituted or unsubstituted alkyl group, and a substituted or unsubstituted aryl group; and particularly preferably selected from an unsubstituted acyl group, a substituted or unsubstituted alkyl group, and an unsubstituted aryl group.

Further, when a plurality of R¹¹'s, R¹²'s, and R¹³'s are present, each of R¹¹, R¹², and R¹³ may be the same as or different from every other R¹¹, R¹², and R¹³.

p represents an integer of 0 or greater, and the preferable range thereof is the same as that of the number of hydroxyl groups per monosaccharide unit described below, but p is preferably zero in the present invention.

Preferably, r represents the number greater than the number of pyranose structure units or furanose structure units contained in G

Preferably, q represents 0.

Further, since p+q+r is equivalent to the number of hydroxyl groups when it is assumed that G represents unsubstituted saccharides having a cyclic acetal structure, the upper limits of p, q, and r are uniquely determined according to the structure of G

Preferred examples of the substituent of the sugar ester compound include an alkyl group (an alkyl group preferably having a carbon number of 1 to 22, more preferably carbon number of 1 to 12, and particularly preferably having a carbon number of 1 to 8, and, for example, a methyl group, an ethyl group, a propyl group, a hydroxyethyl group, a hydroxylpropyl group, a 2-cyanoethyl group, a benzyl group, and the like); an aryl group (an aryl group preferably having a carbon number of 6 to 24, more preferably a carbon number of 6 to 18, and particularly preferably a carbon number of 6 to 12, and, for example, a phenyl group, and a naphthyl group); an acyl group (an acyl group preferably having a carbon number of 1 to 22, more preferably a carbon number of 2 to 12, and particularly preferably a carbon number of 2 to 8, and, for example, an acetyl group, a propionyl group, a butyryl group, a pentanoyl group, a hexanoyl group, an octanoyl group, a benzoyl group, a toluyl group, a phthalyl group, and the like); an amide group (an amide group preferably having a carbon number of 1 to 22, more preferably a carbon number of 2 to 12, and particularly preferably a carbon number of 2 to 8, and, for example, a formamide group, an acetamide group, and the like); an imide group (an imide group preferably having a carbon number of 4 to 22, more preferably a carbon number of 4 to 12, and particularly preferably a carbon number of 4 to 8, and, for example, a succinimide group, a phthalimide group, and the like); and an arylalkyl group (an arylalkyl group preferably having a carbon number of 7 to 25, more preferably a carbon number of 7 to 19, and particularly preferably a carbon number of 7 to 13, and, for example, a benzyl group). Among these, an alkyl group and an acyl group are more preferable; a methyl group, an acetyl group, a benzoyl group, and a benzyl group are still more preferable; and an acetyl group and a benzyl group are particularly preferable. Further, in a case where the constituent sugar of the sugar ester compound is a sucrose skeleton among the examples described above, the sugar ester compound having an acetyl group and a benzyl group as a substituent is described in the paragraph [0058] in the publication of JPA-2009-1696 as a compound 3, and the sugar ester compound having an acetyl group and a benzyl group is particularly preferable from a viewpoint of compatibility with a polymer when compared to a sugar ester compound having a benzoyl group used in the examples of the same document.

Further, the number of hydroxyl groups (hereinafter, also referred to as the content of hydroxyl groups) per constituent unit in the sugar ester compound is preferably 3 or fewer, more preferably 1 or fewer, and particularly preferably zero. By controlling the content of hydroxyl groups to be in the above-described range, movement of the sugar ester compound to a polarizer layer and breakage of a PVA-iodine complex at a high temperature and high humidity which occur with time can be prevented, and it is preferable in terms of suppressing deterioration of polarizer performance (polarizing plate durability) at a high temperature and high humidity from occurring with time.

It is preferable that an unsubstituted hydroxyl group be not present in the sugar ester compound used for the cellulose acylate film used in the present invention and a substituent be formed of only an acetyl group and/or a benzyl group.

In addition, as the ratio of the acetyl group and the benzyl group to the sugar ester compound, it is preferable that the ratio of the benzyl group be small to some extent since values of wavelength dispersion ΔRe and ΔRe/Re(550) of the obtained cellulose acylate film tend to be greater and black color change at the time of incorporation in a liquid crystal display device becomes decreased. Specifically, the ratio of the benzyl groups to the sum of whole unsubstituent hydroxyl groups and whole substituents in the sugar ester compound is preferably 60% or less and more preferably 40% or less.

As a method of obtaining the sugar ester compound, products manufactured by Tokyo Chemical Industry Co., Ltd., Sigma-Aldrich Co. Ltd., and the like are commercially available or the sugar ester compound can be synthesized by perform a known ester derivative method (for example, a method described in the publication of JP-A-8-245678) on commercially available carbonhydrates.

The number average molecular weight of the sugar ester compound is preferably in the range of 200 to 3500, more preferably in the range of 200 to 3000, and particularly preferably in the range of 250 to 2000.

Hereinafter, specific examples of the sugar ester compound which can be preferably used in the present invention will be described, but the present invention is not limited thereto.

In the following structural formulae, each of R's independently represents an arbitrary substituent, and each R may be the same as or different from every other R. In the following formulae, each of substituents 1 and 2 independently represents an arbitrary R. In addition, the substitution degree means the number represented by R in the substituent. “None” means that R represents a hydrogen atom.

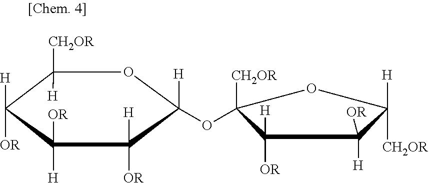

TABLE 2

| | Substituent 1 | | Substituent 2 | | |
|---|---|---|---|---|---|
| | | Substitution | | Substitution | Molecular |
| Compound | Type | degree | Type | degree | weight |
| 100 | Acetyl | 8 | None | 0 | 679 |
| 101 | Acetyl | 7 | Benzyl | 1 | 727 |
| 102 | Acetyl | 6 | Benzyl | 2 | 775 |
| 103 | Acetyl | 5 | Benzyl | 3 | 817 |
| 104 | None | 0 | Benzyl | 8 | 1063 |
| 105 | Acetyl | 7 | Benzoyl | 1 | 741 |
| 106 | Acetyl | 6 | Benzoyl | 2 | 802 |
| 107 | Benzyl | 2 | None | 0 | 523 |
| 108 | Benzyl | 3 | None | 0 | 613 |
| 109 | Benzyl | 4 | None | 0 | 702 |
| 110 | Acetyl | 7 | Phenyl | 1 | 771 |
| | | | acetyl | | |
| 111 | Acetyl | 6 | Phenyl | 2 | 847 |
| | | | acetyl | | |

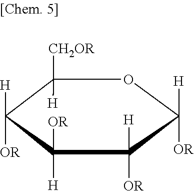

TABLE 3

| | Substituent 1 | | Substituent 2 | | |
|---|---|---|---|---|---|
| | | Substitution | | Substitution | Molecular |
| Compound | Type | degree | Type | degree | weight |
| 201 | Acetyl | 4 | Benzoyl | 1 | 468 |
| 202 | Acetyl | 3 | Benzoyl | 2 | 514 |
| 203 | Acetyl | 2 | Benzoyl | 3 | 577 |
| 204 | Acetyl | 4 | Benzyl | 1 | 454 |
| 205 | Acetyl | 3 | Benzyl | 2 | 489 |
| 206 | Acetyl | 2 | Benzyl | 3 | 535 |
| 207 | Acetyl | 4 | Phenyl | 1 | 466 |
| | | | acetyl | | |
| 208 | Acetyl | 3 | Phenyl | 2 | 543 |
| | | | acetyl | | |
| 209 | Acetyl | 2 | Phenyl | 3 | 619 |
| | | | acetyl | | |
| 210 | Phenyl | 1 | None | 0 | 298 |
| | acetyl | | | | |
| 211 | Phenyl | 2 | None | 0 | 416 |
| | acetyl | | | | |
| 212 | Phenyl | 3 | None | 0 | 535 |
| | acetyl | | | | |
| 213 | Phenyl | 4 | None | 0 | 654 |
| | acetyl | | | | |

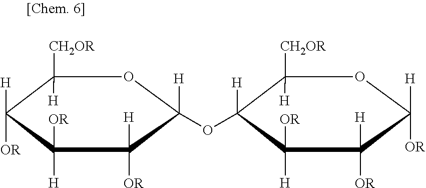

TABLE 4

| | Substituent 1 | | Substituent 2 | | |
|---|---|---|---|---|---|
| | | Substitution | | Substitution | Molecular |
| Compound | Type | degree | Type | degree | weight |
| 301 | Acetyl | 6 | benzoyl | 2 | 803 |
| 302 | Acetyl | 6 | Benzyl | 2 | 775 |
| 303 | Acetyl | 6 | Phenyl | 2 | 831 |
| | | | acetyl | | |
| 304 | Benzoyl | 2 | None | 0 | 551 |
| 305 | Benzyl | 2 | None | 0 | 522 |
| 306 | Phenyl | 2 | None | 0 | 579 |
| | acetyl | | | | |

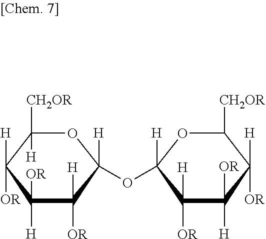

TABLE 5

| | Substituent 1 | | Substituent 2 | | |
|---|---|---|---|---|---|
| | | Substitution | | Substitution | Molecular |
| Compound | Type | degree | Type | degree | weight |
| 401 | Acetyl | 6 | Benzoyl | 2 | 803 |
| 402 | Acetyl | 6 | Benzyl | 2 | 775 |
| 403 | Acetyl | 6 | Phenyl | 2 | 831 |
| | | | acetyl | | |
| 404 | Benzoyl | 2 | None | 0 | 551 |
| 405 | Benzyl | 2 | None | 0 | 523 |
| 406 | Phenyl | 2 | None | 0 | 579 |
| | acetyl | | | | |

The content of ii) the sugar ester compound with respect to cellulose acylate is preferably in the range of 1% by mass to 30% by mass, more preferably in the range of 2% by mass to 30% by mass, still more preferably in the range of 3% by mass to 25% by mass, and particularly preferably in the range of 5% by mass to 20% by mass.

Moreover, in a case where an additive whose intrinsic birefringence described below is negative is used together with ii) the sugar ester compound, the addition amount (parts by mass) of ii) the sugar ester compound with respect to the addition amount (parts by mass) of an additive whose intrinsic birefringence is negative is preferably in the range of 2 times to 10 times (mass ratio) and more preferably in the range of 3 times to 8 times (mass ratio).

Further, in a case where a polyester-based plasticizer described below is used together with ii) the sugar ester compound, the addition amount (parts by mass) of ii) the sugar ester compound with respect to the addition amount (parts by mass) of the polyester-based plasticizer is preferably in the range of 2 times to 10 times and more preferably in the range of 3 times to 8 times.

Furthermore, ii) the sugar ester compound may be used alone or in combination of two or more kinds thereof.

Various low molecules and macromolecular additives (for example, a deterioration inhibitor, a UV inhibitor, a retardation (optical anisotropy) regulator, a peeling accelerator, a plasticizer, an infrared absorbent, fine particles, and the like) according to the purposes in respective preparation processes can be added to the cellulose acylate film, and these may be solids or oily matters. That is, melting points or boiling points thereof are not particularly limited. For example, mixture of a UV absorbing material whose melting point is lower than 20° C. and a UV absorbing material whose melting point is 20° C. or higher, or mixture of deterioration inhibitors in the same manner can be made. Further, an infrared absorbing dye is described in the publication of JP-A-2001-194522. In regard to the adding time, any one of additives may be added in the process of preparing a cellulose acylate solution (dope), but an additive may be added by adding a process of adding and preparing an additive to the final preparation process in the dope preparation process. Moreover, the addition amount of each material is not particularly limited as long as the function thereof is expressed. Further, in a case where a cellulose acylate resin layer is formed of multilayers, the kinds or the addition amounts of additives in respective layers may be different from one another.

### (Retardation Developer)

In order to express a retardation value, a compound having at least two aromatic rings can be used as a retardation developer.

Preferably, compounds each having at least two or more aromatic rings express optically positive uniaxiality when uniformly aligned. Further, a compound whose two aromatic rings form a rigid portion and which exhibits liquid crystallinity is preferable.

The molecular weight of the compound having at least two or more aromatic rings is preferably in the range of 300 to 1200 and more preferably in the range of 400 to 1000.

Stretching is effective for controlling optical characteristics, particularly, Re to have a preferable value. The refractive index anisotropy in a film plane is necessary to be increased for increasing Re and improvement in main chain alignment of a polymer film by stretching is one of methods. In addition, it is possible to increase refractive index anisotropy of a film using a compound with large refractive index anisotropy as an additive. For example, in the compound having two or more aromatic rings described above, alignment of the compounds is improved by transmission of the force in which polymer main chains are arranged by stretching and controlling optical characteristics to be desirable can be easily done.

As the compound having at least two aromatic rings, a triazine compound described in the publication of JP-A-2003-344655, a rod-shaped compound described in the publication of JP-A-2002-363343, and liquid crystal compounds described in the publications of JP-A-2005-134884 and JP-A-2007-119737 can be exemplified. More preferable examples are the triazine compound and the rod-shaped compound.

The compound having at least two or more aromatic rings may be used in combination of two or more kinds thereof

Preferably, the substrate in the phase difference film of the present invention contains the compound represented by the following formula (IIIA) or (IIIB) as a retardation developer. By containing the compound represented by the following formula (MA) or (IIIB), expression of the optical characteristics per unit film thickness is improved and contribution to thinning a film can be made.

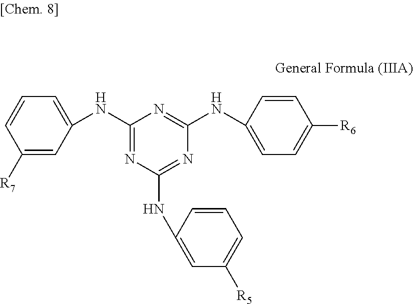

Each of R₅ to R₇ independently represents —OCH₃ or —CH₃.

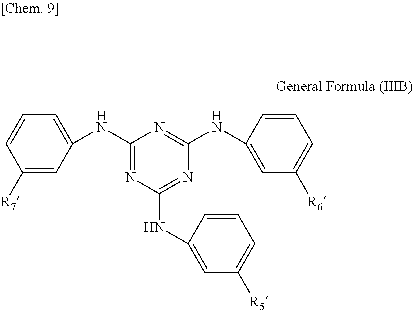

Each of R₅′ to R₇′ independently represents —OCH₃ or —CH₃.

The addition amount of the compound having at least two aromatic rings is preferably in the range of 0.05% to 10%, more preferably in the range of 0.5% to 8%, and still more preferably in the range of 1% to 5% in terms of the mass ratio of the substrate to the cellulose acylate.

### [Other Additives]

Other additives such as an antioxidant, a peeling accelerator, and fine particles can be added to the cellulose acylate film

### [Antioxident]

In the phase difference film of the present invention, an antioxidant can be used for preventing deterioration like depolymerization or the like caused by oxidation. As an antioxidant which can be used, a phenol-based antioxidant, a hydroquinone-based antioxidant, or a phosphorus-based antioxidant described in the paragraph [0120] in the publication of JP-A-2012-181516 can be exemplified. The addition amount of the antioxidant is preferably in the range of 0.05 parts by mass to 5.0 parts by mass with respect to 100 parts by mass of cellulose acylate.

### (Peeling Accelerator)

As an additive which decreases peeling resistance from a metal substrate for casting of the cellulose acylate film, a surfactant with remarkable effects is widely known. Examples of preferred and effective releasing agents include a phosphoric acid ester-based surfactant, a carboxylic acid-based or carboxylate-based surfactant, a sulfonic acid-based or sulfonate-based surfactant, and a sulfuric acid ester-based surfactant. Further, a fluorine-based surfactant in which a part of a hydrogen atom bonded to the hydrocarbon chain of the above-described surfactant is substituted with a fluorine atom is effective. As a specific example, compounds described in the section of (organic acid) of the paragraphs of [0124] to [0138] in the publication of JP-A-2012-181516 can be referenced.

The addition amount of the releasing agent is preferably in the range of 0.05% by mass to 5% by mass, more preferably in the range of 0.1% by mass to 2% by mass, and most preferably in the range of 0.1% by mass to 0.5% by mass with respect to the cellulose acylate.

### [Fine Particles]

The phase difference film of the present invention can contain fine particles from viewpoints of slidability of a film and stable production. The fine particles are also referred to as a matting agent, and may be an inorganic compound or an organic compound.

As a preferred example of the fine particles, specifically, fine particles described in the section of (matting agent fine particles) of the paragraphs [0024] to [0027] in the publication of JP-A-2012-177894 and fine particles described in the section of a (matting agent) of the paragraphs [0122] to [0123] in the publication of JP-A-2012-181516 can be referenced.

Since the fine particles are smaller than the wavelength of light, the haze of the film is not increased if not added in a large amount. In a case where the fine particles are used for an LCD in practical, decrease in the contrasts or failure such as generation of bright spots hardly occurs. In addition, when the fine particles are not extremely small, creak resistance and scratch resistance can be realized. From these viewpoints, the content of the fine particles in the cellulose acylate film is preferably in the range of 0.01% by mass to 5.0% by mass, more preferably in the range of 0.03% by mass to 3.0% by mass, and particularly preferably 0.05% by mass to 1.0% by mass.

### [Intermediate Layer]

The intermediate layer included in the phase difference film of the present invention will be described.

The intermediate layer contains a polyvinyl alcohol based resin or an acrylic resin having a polar group.

### (Polyvinyl Alcohol Resin)

A polyvinyl alcohol resin can be used as a material of the intermediate layer and a modified or unmodified polyvinyl alcohol can be used as a polyvinyl alcohol resin.

A polyvinyl alcohol resin can be selected from a known material as a horizontal alignment film in addition to a known material as a vertical alignment film. Modified or unmodified polyvinyl alcohol can be used as a horizontal alignment film, but liquid crystal molecules can be homeotropically aligned on the intermediate layer interface by adding the onium compound to a composition for forming a phase difference layer using an action between the onium compound and the intermediate layer and an action between the onium compound and the liquid crystal compound. In the modified polyvinyl alcohol, when an intermediate layer containing modified polyvinyl alcohol with a unit having a polymerizable group is used, an adhesion property with the phase difference layer can be more improved, which is preferable.

In a group including a vinyl portion, an oxiranyl portion, or an aziridinyl portion, polyvinyl alcohol with which at least one hydroxyl group is substituted is preferable, for example, modified polyvinyl alcohol described in the paragraphs [0071] to [0095] of Japanese Patent No. 3907735 is preferable.

### (Acrylic Resin Having Polar Group)

As a material of an intermediate layer, an acrylic resin having a polar group can be used. In a case where the intermediate layer is formed using an acrylic resin having a polar group, since a sufficient adhesion property can be obtained without performing a saponification treatment on the cellulose acylate film serving as a substrate, a production process of the phase difference film can be simplified, which is preferable from a viewpoint of productivity.

It is preferable that an acrylic resin having a polar group be a resin having a repeating unit derived from a compound which includes a polar group and a (meth)acryloyl group.

In addition, an acryloyl group and a methacryloyl group in the present invention are collectively referred to as a “(meth)acryloyl group.”

A polar group indicates that a difference in electronegativity between two atoms bonded to each other is large. Specifically, at least one polar group selected from a group consisting of a hydroxyl group, a carbonyl group, a carboxyl group, an amino group, a nitro group, an ammonium group, and a cyano group can be exemplified, and a hydroxyl group is particularly preferable.

An acrylic resin having a polar group in the present invention may include a repeating unit having no polar group or may include a repeating unit other than a repeating unit derived from a compound containing a (meth)acryloyl group.

It is preferable that an acrylic resin having a polar group be a resin having a repeating unit derived from a compound which includes three or more functional groups in one molecule and a repeating unit derived from a compound which contains a polar group and one (meth)acyryloyl group from a viewpoint of improving an adhesion property with a substrate layer.

### (Compound Having Three or More Functional Groups in One Molecule)

Examples of the compound having three or more functional groups in one molecule include a compound having a polymerizable functional group (polymerizable unsaturated double bond) such as a (meth)acryloyl group, a vinyl group, a styryl group, or an allyl group, and among these, a compound having a (meth)acryloyl group and —C(O)OCH═CH₂ is preferable. In addition, a compound containing three or more (meth)acryloyl groups in one molecule described below is particularly preferable.

Specific examples of the compound having a polymerizable functional group include (meth)acrylic acid diesters of alkylene glycol, (meth)acrylic acid diesters of polyoxyalkylene glycol, (meth)acrylic acid diesters of polyvalent alcohol, (meth)acrylic acid diesters of ethyleneoxide or a propyleneoxide adduct, epoxy(meth)acrylates, urethane(meth)acrylates, and polyester(meth)acrylates.

Among these, esters of polyvalent alcohol and (meth)acrylic acid are preferable. Examples thereof include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, urethane acrylate, polyester polyacrylate, and caprolactone-modified tris(acryloxyethyl)isocyanurate.

As the compound having three or more functional groups in one molecule, a commercially available product can be used. Examples of multifunctional acrylate-based compounds having (meth)acryloyl groups include KAYARAD PET30, KAYARAD DPHA, KAYARAD DPCA-30, and KAYARAD DPCA-120 (all manufactured by Nippon Kayaku Co., Ltd.). Further, examples of urethane acrylate include U15HA, U4HA and A-9300 (manufactured by Shin-Nakamura Chemical Co., Ltd.), and EB5129 (manufactured by Daicel UCB, Co., Ltd.).

It is particularly preferable that the intermediate layer be a layer containing an acrylic resin which has a polar group, the acrylic resin be a layer obtained by crosslinking an acrylic monomer using light or heat, and the polar group be a hydroxyl group. In this manner, in the phase difference layer described below, a rod-shaped liquid crystal compound can be effectively homeotropically aligned.

### (Method of Forming Intermediate Layer)

The intermediate layer can be formed by coating the cellulose acylate film serving as a substrate with a composition for forming an intermediate layer directly or through another layer, and drying the film.

In a case where a material of the intermediate layer is a polyvinyl alcohol resin, it is preferable to use a solvent to which an organic solvent is appropriately added using water and an alcohol-based solvent as main components.

In a case where a material of the intermediate layer is an acrylic resin having a polar group, it is preferable to use a solvent having lytic potential with respect to cellulose acylate and a solvent having swelling ability with respect to cellulose acylate.

A compound forming an acrylic resin which has a polar group infiltrates into the cellulose acylate film accompanied by the solvent having swelling ability with respect to cellulose acylate allowing the cellulose acylate film to be swollen. In addition, cellulose acylate is diffused to the intermediate layer side by the solvent having lytic potential with respect to the cellulose acylate dissolving the cellulose ester film. In this manner, an adhesion property with the intermediate layer is excellent without performing a saponification treatment on the cellulose acylate film.

Since it is preferable that the intermediate layer have isotropy so as not to optically influence on another structure and hydrophilicity of the material be high when the adhesion property with the substrate layer and the phase difference layer is considered, selecting a material whose SP value is close to that of the substrate layer or the phase difference layer is preferable from a viewpoint of making the adhesion property to be more rigid.

Further, for example, an intermediate layer material whose SP value is close to that of the substrate layer is selected, a more rigid interface can be obtained by adding a compound which generates hydrophilic interaction (for example, hydrogen bonding) with the intermediate layer to a phase difference layer composition for compensating adhesion between the phase difference layer and the intermediate layer.

At this time, the material of the intermediate layer for the SP value may be a simple material or a mixed material, and the SP value when the material is a mixed material (mixing SP value) is obtained by multiplication of the mixed composition by the SP value of the simple material.

In a case of a blend (A+B=100) which contains a material A and a material B and whose mass ratio of the material A to the material B is A:B, the mixing SP value can be acquired by the following expression.

Mixing SP value=(SP value of Material A)×A/100+(SP value of Material B)×B/100

[Solvent Having Lytic Potential with Respect to Cellulose Acylate]

A solvent having lytic potential with respect to cellulose acylate means a solvent having a peak area of cellulose acylate of 400 mV/sec or greater when a cellulose acylate film having dimensions of 24 mm×36 mm (thickness: 80 μm) is immersed in a bottle to which the solvent is added and which has dimensions of 15 cm³ at room temperature (25° C.) for 60 seconds, and taken out, and then the immersed solution is analyzed using gel permeation chromatography (GPC). Alternatively, when a cellulose acylate film having dimensions of 24 mm×36 mm (thickness: 80 μm) is left in a bottle to which the solvent is added and which has dimensions of 15 cm³ at room temperature (25° C.) for 24 hours and the bottle is appropriately is shaken such that the film is completely dissolved therein to be shapeless, the solvent also means a solvent having lytic potential with respect to cellulose acylate.

The solvent having lytic potential with respect to cellulose acylate may be used alone or two or more kinds thereof.

Examples of the solvent having lytic potential with respect to cellulose acylate include methyl acetate, acetone, and methylene chloride, and methyl acetate and acetone are preferable.

[Solvent Having Swelling Ability with Respect to Cellulose Acylate]

The solvent having swelling ability with respect to cellulose acylate means a solvent obtained by vertically adding the cellulose acylate film having dimensions of 24 mm×36 mm (thickness: 80 μm) to a bottle to which the solvent is added and which has dimensions of 15 cm³ to be immersed at 25° C. for 60 seconds and by appropriately shaking the bottle. When the solvent is observed, the solvent appears to be deformed and bent (when the film is observed, a swollen portion is dimensionally changed, bend, and deformed. In a case of a solvent with no swelling ability, the change such as bending or deformation is not seen).

As the solvent having swelling ability with respect to cellulose acylate, a solvent described in the paragraph [0026] in the publication of JP-A-2008-112177 can be used.

Examples thereof to be used include ethers having 3 to 12 carbon atoms such as dibutyl ether and tetrahydrofuran; ketons having 3 to 12 carbon atoms such as acetone, methyl ethyl ketone, diethylketone, cyclopentanone, and cyclohexanone; esters having 3 to 12 carbon atoms such as methyl acetate and ethyl acetate; and an organic solvent having two or more kinds of functional groups, and these can be used alone or two or more kinds thereof can be used.

Further, in order to control effects of the above-described solvent, a solvent with no lytic potential or swelling ability with respect to cellulose acylate film can be used together.

A solvent described in the paragraph [0027] in the publication of JP-A-2008-112177 can be used as the solvent with no lytic potential or swelling ability.

Examples thereof include methyl isobutyl ketone (MIBK), methanol, ethanol, 1-butanol, 2-butanol, tert-butanol, 1-pentanol, 2-propanol, 2-methyl-2-butanol, cyclohexanol, 2-octanone, 2-pentanone, 2-hexanone, 2-heptanone, 3-pentanone, 3-heptanone, 4-heptanone, and isobutyl acetate.

A solvent with no lytic potential or swelling ability with respect to cellulose acylate may be used as the solvent, and the addition amount of the solvent with no lytic potential or swelling ability is preferably 90% by mass or less, more preferably 85% by mass or less, and still more preferably 80% by mass or less with respect to the entire solvent being used.

From viewpoints of swelling the substrate layer and improving the adhesion property, it is preferable that the solvent contain at least one from among methyl acetate, acetone, and methyl ethyl ketone. A mixed solvent containing methyl acetate or acetone, and methyl ethyl ketone is preferable.

From a viewpoint of appropriate solubility of the substrate layer and balance with adhesion, the ratio of the content of the solvent having lytic potential or swelling ability with respect to cellulose acylate to the solvent with no swelling ability with respect to cellulose acylate is preferably in the range of 10:90 to 60:40.

In the total amount of the solvent in the composition for forming the intermediate layer, the concentration of the solid content in the composition is preferably in the range of 1% by mass to 70% by mass, more preferably in the range of 2% by mass to 50% by mass, and still more preferably in the range of 3% by mass to 40% by mass.

It is preferable that the phase difference film of the present invention include a mixed layer having a main component of the substrate and a main component of the intermediate layer between the substrate and the intermediate layer, more preferable that the film thickness of the mixed layer be in the range of 0.3 μm to 5.0 μm, and still more preferably in the range of 0.5 μm to 4 μm.

The adhesion between the substrate and the intermediate layer is strengthened by the presence of the mixed layer. The adhesion is sufficient when the film thickness of the mixed layer is 0.3 μm or greater, concentration distribution in the mixed layer does not cause phase separation when the film thickens thereof is 5.0 μm or smaller, and the contrast is not decreased when the film is mounted on a liquid crystal panel, which is preferable.

The film thickness of the mixed layer can be measured by cutting the cross section of the phase difference film in the thickness direction using a microtome, dying the cross section with osmic acid, and observing the cross section using a SEM.

The mixed layer can be formed by allowing the composition for forming an intermediate layer to contain the solvent having swelling ability or lytic potential with respect to the cellulose acylate. The film thickness of the mixed layer can be controlled by the kind or the concentration of the solvent having lytic potential or swelling ability.

[Phase Difference Layer to which Alignment State of Liquid Crystal Compound is Fixed (Phase Difference Layer)]

The phase difference layer to which an alignment state of a liquid crystal compound included in the phase difference film of the present invention is fixed (phase difference layer) will be described.

The phase difference layer is a layer to which a state in which a liquid crystal compound is homeotropically aligned is fixed.

The homeotropic alignment is an alignment state in which liquid crystal molecules are aligned in the normal direction of the layer and the slow axis becomes parallel to the normal direction of the layer. In addition, particularly preferably, the slow axis of the phase difference layer is parallel to the normal direction of the layer, but an inclination due to the alignment state of liquid crystal molecules is generated in some cases. When the inclination is within 3.5°, the in-plane phase difference can be adjusted to be 10 nm or smaller, which is preferable.

### (Liquid Crystal Compound)

As the liquid crystal compound, a layer obtained by fixing homeotropic alignment of a composition containing a rod-shaped liquid crystal compound as a main component is preferable from a viewpoint of optical characteristics of the phase difference film.

The layer obtained by fixing homeotropic alignment of the rod-shaped liquid crystal compound can be functioned as a positive C-plate.

The rod-shaped liquid crystal compound which can be used is described in paragraphs [0045] to [0066] of the publication of JP-A-2009-217256 and can be referenced. An additive which can be used for the phase difference layer in the present invention, an alignment film which can be used, and a method of forming the homeotropic alignment liquid crystal layer are described in paragraphs [0076] to [0079] of the publication of JP-A-2009-237421 and can be referenced.

From a viewpoint of optical expression, it is preferable that the liquid crystal compound forming the phase difference layer be at least one kind of compound selected from a group consisting of a compound represented by the following general formula (IIA) and a compound represented by the following general formula (IIB).

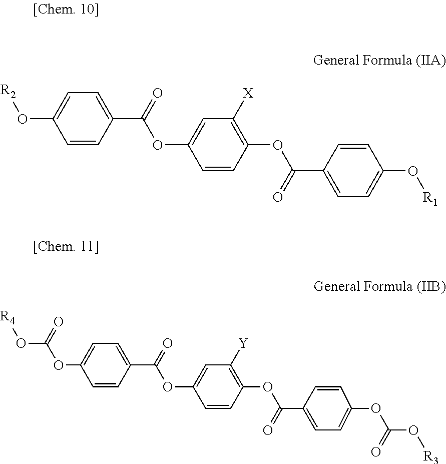

Each of R₁ to R₄ independently represents —(CH₂)ₙ—OOC—CH═CH₂ and n represents an integer of 2 to 5. Each of X and Y independently represents a hydrogen atom or a methyl group.

From a viewpoint of suppressing crystal deposition, it is preferable that X and Y each represent a methyl group in the general formula (IIA) or (JIB). Further, from a viewpoint of suppressing crystal deposition, it is preferable that the content of the liquid crystal compound forming the phase difference layer be 70% by mass or greater and particularly preferably 80% by mass or greater in the phase difference layer. Moreover, in a case where the compound represented by the general formula (IIA) and the compound represented by the general formula (IIB) are used as the liquid crystal compound, each of the contents thereof is preferably 3% by mass or greater, more preferably 5% by mass or greater, and particularly preferably 8% by mass or greater with respect to the solid content of the phase difference layer.

### (Onium Compound Represented by General Formula (I))

Preferably, the phase difference layer included in the phase difference film of the present invention contains an onium compound represented by the following general formula (I). The onium compound acts as a vertical alignment agent accelerating homeotropic alignment on the alignment film interface of a liquid crystal compound and contributes to improvement of the adhesion property of the interface between the phase difference layer and the intermediate layer. The phase difference layer may contain an alignment control agent (for example, a co-polymer that includes a repeating unit having a fluoro-aliphatic group) on an air interface side, which controls the alignment of the air interface side.

The onium compound represented by the general formula (I) is added for the purpose of controlling alignment on the intermediate layer interface of the liquid crystal compound and acts for increasing the tilt angle in the vicinity of the intermediate layer interface of molecules of the liquid crystal compound.

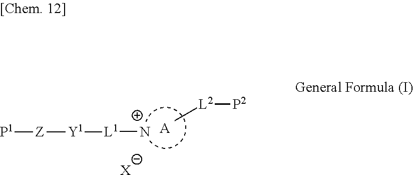

In the general formula (I), the ring A represents a quaternary ammonium ion, X represents an anion, L¹ represents a divalent linking group, L² represents a single bond or a divalent linking group, Y¹ represents a divalent linking group having 5- or 6-membered ring as a partial structure, Z represents a divalent linking group which includes an alkylene group having a carbon number of 2 to 20 as a partial structure, each of P¹ and P² independently represents a monovalent substituent having a hydrogen atom, a hydroxyl group, a carbonyl group, a carboxyl group, an amino group, a nitro group, an ammonium group, a cyano group, or a polymerizable ethylenically unsaturated group.

The ring A represents a quaternary ammonium ion formed of a nitrogen-containing heterocyclic ring. Examples of the ring A include a pyridine ring, a picoline ring, a 2,2′-bipyridyl ring, a 4,4′bipyridyl ring, a 1,10-phenanthroline ring, a quinoline ring, a oxazole ring, a thiazole ring, an imidazole ring, a pyrazine ring, a triazole ring, and a tetrazole ring, and a quaternary imidazolium ion and a quaternary pyridinium ion are preferable.

X represents an anion. Examples of X include a halogen anion (for example, a fluorine ion, a chlorine ion, a bromine ion, and iodine ion), a sulfonate ion (for example, a methane sulfonic acid ion, a trifluoromethane sulfonic acid ion, a methyl sulfuric acid ion, a vinyl sulfonic acid ion, an allyl sulfonic acid ion, a ρ-toluenesulfonic acid ion, a ρ-chlorobenzene sulfonic acid ion, a ρ-vinylbenzene sulfonic acid ion, a 1,3-benzene disulfonic acid ion, a 1,5-naphthalene disulfonic acid ion, and a 2,6-naphthalene disulfonic acid ion), a sulfuric acid ion, a carbonic acid ion, a nitric acid ion, a thiocyanic acid ion, a perchloric acid ion, a tetrafluoroboric acid ion, a picric acid ion, an acetic acid ion, a benzoic acid ion, a ρ-vinylbenzoic acid ion, a formic acid ion, a trifluoroacetic acid ion, a phosphoric acid ion (for example, a hexafluorophosphoric acid ion), and a hydroxide ion. A halogen anion, a sulfonate ion, and a hydroxide ion are preferable. Further, a chlorine ion, a bromine ion, an iodine ion, a methanesulfonic acid ion, a vinylsulfonic acid ion, a ρ-toluenesulfonic acid ion, a ρ-vinylbenzene sulfonic acid ion are particularly preferable.

L¹ represents a divalent linking group. Examples of L¹ include a divalent linking group having 1 to 20 carbon atoms formed by combining an alkylene group, —O—, —S—, —CO—, —SO₂—, —NRa— (in this case, Ra represents an alkyl group having 1 to 5 carbon atoms or a hydrogen atom), an alkenylene group, an alkynylene group, or an arylene group. L¹ is preferably -AL- having 1 to 10 carbon atoms, —O-AL-, —CO—O-AL-, or —O—CO-AL-, more preferably -AL- having 1 to 10 carbon atoms, or —O-AL-, and most preferably -AL- having 1 to 5 carbon atoms or —O-AL-. In addition, AL represents an alkylene group.

L² represents a single bond or a divalent linking group. Examples of L² include a divalent linking group having 1 to 10 carbon atoms formed by combining an alkylene group, —O—, —S—, —CO—, —SO₂—, —NRa— (in this case, Ra represents an alkyl group having 1 to 5 carbon atoms or a hydrogen atom), an alkenyl group, an alkynylene group, or an arylene group, a single bond, —O—, —O—CO—, —CO—O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, and —O—CO-AL-CO—O—. Further, AL represents an alkylene group. L² is preferably a single bond, -AL- having 1 to 10 carbon atoms, —O-AL-, or —NRa-AL-O—, more preferably a single bond, -AL- having 1 to 5 carbon atoms, —O-AL-, or —NRa-AL-O—, and most preferably a single bond, —O-AL- having 1 to 5 carbon atoms, or —NRa-AL-O—.

Y¹ represents a divalent linking group having 5- or 6-membered ring as a partial structure. Examples of Y¹ include a cyclohexyl ring, an aromatic ring, or a heterocyclic ring. Examples of the aromatic ring include a benzene ring, an indene ring, a naphthalene ring, a fluorene ring, a phenanthrene ring, an anthracene ring, a biphenyl ring, and a pyrene ring, and a benzene ring, a biphenyl ring, and a naphthalene ring are particularly preferable. As the heteroatom constituting a heterocyclic ring, a nitrogen atom, an oxygen atom, and a sulfur atom are preferable, and examples thereof include a furan ring, a thiophene ring, a pyrrole ring, a pyrrolilne ring, a pyrrolidine ring, an oxazole ring, an isoxazole ring, a thiazole ring, an isothiazole ring, an imidazole ring, an imidazoline ring, an imidazolidine ring, a pyrazole ring, a pyrazoline ring, a pyrazolidine ring, a triazole ring, a furazan ring, a tetrazole ring, a pyran ring, a dioxane ring, a dithiane ring, a thiin ring, a pyridine ring, a piperidine ring, an oxazine ring, a morpholine ring, a thiazine ring, a pyridazine ring, a pyrimidine ring, a pyrazine ring, a piperazine ring, and a triazine ring. A heterocyclic ring is preferably a 6-membered ring. A divalent linking group having 5- or 6-membered ring represented by Y¹ as a partial structure may further include a substituent.

Examples of the substituent include a halogen atom, a cyano group, an alkyl group having 1 to 12 carbon atoms (more preferably 1 to 10 carbon atoms and still more preferably 1 to 5 carbon atoms), an alkenyl group having 2 to 12 carbon atoms (more preferably 2 to 10 carbon atoms and still more preferably 2 to 5 carbon atoms), and alkoxy group having 1 to 12 carbon atoms (more preferably 1 to 10 carbon atoms and still more preferably 1 to 5 carbon atoms). The alkyl group and the alkoxy group may be substituted to an acyl group having 2 to 12 carbon atoms (more preferably 2 to 10 carbon atoms and still more preferably 2 to 5 carbon atoms) or an acyloxy group having 2 to 12 carbon atoms (more preferably 2 to 10 carbon atoms and still more preferably 2 to 5 carbon atoms). The acyl group is represented by —CO—R, the acyloxy group is represented by —O—CO—R, and R represents an aliphatic group (an alkyl group, a substituted alkyl group, an alkenyl group, a substituted alkenyl group, an alkynyl group, or a substituted alkynyl group) or an aromatic group (an aryl group or a substituted aryl group). R is preferably an aliphatic group and more preferably an alkyl group or an alkenyl group.

It is preferable that a divalent linking group represented by Y′ be a divalent linking group having two or more 5- or 6-membered rings and more preferable that a divalent linking group have a structure in which two or more rings are connected by linking groups. Examples of the linking group include the examples of the linking groups represented by L′ and L², —CH≡CH—, —CH═N—, —N═CH—, and —N═N—.

Z includes an alkylene group having 2 to 20 carbon atoms as a partial structure and represents a divalent linking group formed by combining —O—, —S—, —CO—, and —SO₂—. In addition, the alkylene group may have a substituent. Examples of the divalent linking group include an alkyleneoxy group and a polyalkyleneoxy group. The number of carbon atoms of the alkylene group represented by Z is more preferably in the range of 2 to 16, still more preferably in the range of 2 to 12, and particularly preferably in the range of 2 to 8.

Each of P¹ and P² independently represents a monovalent substituent having a polymerizable ethylenically unsaturated group, a hydrogen atom, a hydroxyl group, a carbonyl group, a carboxyl group, an amino group, a nitro group, an ammonium group, or a cyano group. Examples of the monovalent substituent having the polymerizable ethylenically unsaturated group include structures of the following formulae (M-1) to (M-8). That is, the monovalent substituent having the polymerizable ethylenically unsaturated group may be a substituent formed of only an ethenyl group similarly to the formula (M-8).

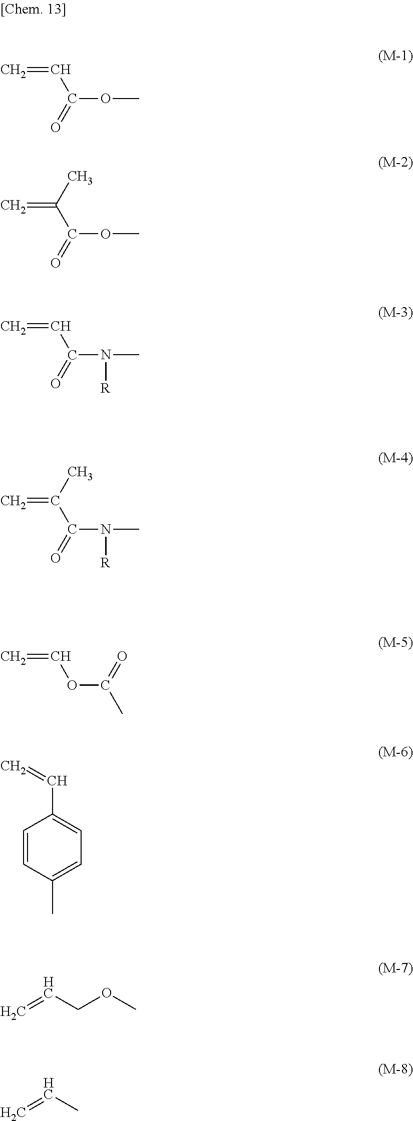

In the formulae (M-3) and (M-4), R represents a hydrogen atom or an alkyl group, and preferably a hydrogen atom or a methyl group. In the formulae (M-1) to (M-8), (M-1), (M-2), and (M-8) are preferable, (M-1) or (M-8) is more preferable. Particularly, the formula (M-1) is preferable as P¹. In addition, the formula (M-1) or (M-8) is preferable as P²; the formula (M-8) or (M-1) is preferable as P² in a compound whose ring A is a quaternary imidazolium ion; and the formula (M-1) is preferable as P² in a compound whose ring A is a quaternary pyridinium ion.

The onium compounds represented by the following general formulae (I-1) and (I-2) are included in the onium compound represented by the general formula (I).

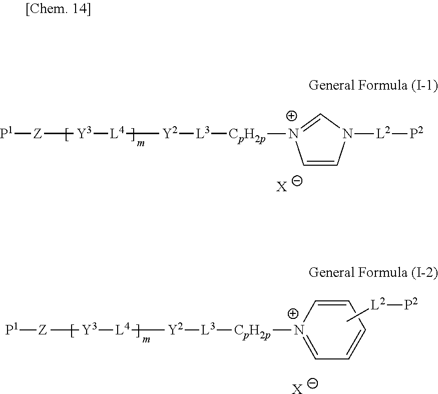

Definitions of respective symbols in the general formulae (I-1) and (I-2) are the same as those in the general formula (I). Each of L³ and L⁴ independently represents a divalent linking group, each of Y² and Y³ independently represents a 6-membered ring which may have a substituent, m represents 1 or 2, each of L⁴ and Y³ may be the same as or different from every other L⁴ and Y³ when m is 2, and p represents an integer of 1 to 10.

L³ represents a divalent linking group, examples of L³ include a single bond, —O—, —O—CO—, —CO—O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, and —O—CO-AL-CO—O—. Further, AL represents an alkylene group having 1 to 10 carbon atoms. L³ preferably represents a single bond, —O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O—; more preferably a single bond or —O—; and most preferably —O—.

L⁴ represents a divalent linking group, and examples of L⁴ include a single bond, —O—, —O—CO—, —CO—O—, —CH═CH—, —CH═N—, —N═CH—, —N═N—, —NH—CO—, and —CO—NH—. L⁴ preferably represents a single bond, —O—CO—, —CO—O—, —C≡C—, —NH—CO—, or —CO—NH—; more preferably a single bond, —O—CO—, or —CO—O—; and most preferably —O—CO— or —CO—O—.

Each of Y² and Y³ independently represents a 6-membered ring which may have a substituent, and examples of the 6-membered ring include an aliphatic ring, an aromatic ring (benzene ring), and a heterocyclic ring. Examples of the aliphatic 6-membered ring include a cyclohexane ring, a cyclohexene ring, and a cyclohexadiene ring. Examples of the aromatic ring include a benzene ring, an indene ring, a naphthalene ring, a fluorene ring, a phenanthrene ring, an anthracene ring, a biphenyl group, and a pyrene ring. Examples of the 6-membered heterocyclic ring include a pyran ring, a dioxane ring, a dithiane ring, a thiin ring, a pyridine ring, a piperidine ring, an oxazine ring, a morpholine ring, a thiazine ring, a pyridazine ring, a pyrimidine ring, a pyrazine ring, a piperazine ring, and a triazine ring. Further, another 6-membered ring or 5-membered ring may be condensed to the 6-membered ring. Each of Y² and Y³ preferably represents a cyclohexane ring, a pyridine ring, a pyrimidine ring, or a benzene ring; more preferably a pyrimidine ring or a benzene ring; and most preferably a benzene ring.

Examples of the substituent include a halogen atom, a cyano group, an alkyl group having 1 to 12 carbon atoms (more preferably 1 to 10 carbon atoms and still more preferably 1 to 5 carbon atoms) and alkoxy group having 1 to 12 carbon atoms. The alkyl group and the alkoxy group may be substituted to an acyl group having 2 to 12 carbon atoms or an acyloxy group having 2 to 12 carbon atoms. The acyl group is represented by —CO—R, the acyloxy group is represented by —O—CO—R, and R represents an aliphatic group (an alkyl group, a substituted alkyl group, an alkenyl group, a substituted alkenyl group, an alkynyl group, or a substituted alkynyl group) or an aromatic group (an aryl group or a substituted aryl group). R is preferably an aliphatic group and more preferably an alkyl group or an alkenyl group.

In the formulae (I-1) and (I-2), at least one Y³ is preferably a substituted benzene ring; more preferably a benzene ring having one or more halogen groups, an alkyl group, or an alkoxy group; and still more preferably a benzene ring having two or more alkyl groups or an alkenyl group.

m represents an integer of 1 or 2, and each L⁴ and Y³ may be different from every other L⁴ and Y³ when m is 2.

C_{P}H_{2P} represents a chain alkylene group which may include a branched structure. C_{P}H_{2P} is preferably a linear alkylene group (—(CH₂)ₚ—).

p represents an integer of 1 to 10, more preferably an integer of 1 to 5, and most preferably an integer of 1 or 2.

The onium compounds represented by the general formulae (I-3) and (I-4) are included in the onium compound represented by the general formula (I).

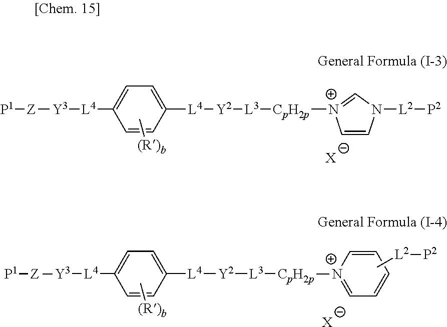

Definitions of respective symbols in the general formulae (I-3) and (I-4) are the same as those in the general formulae (I-1) or (I-2). R′ represents a substituent and b represents an integer of 1 to 4.

Examples of R′ are the same as those of the examples of substituents included in the 6-membered ring represented by Y² and Y³ in the general formula (I-1) or (I-2), and the preferable range is the same as that described above. That is, R′ is preferably a halogen group, an alkyl group, or an alkoxy group.

b represents an integer of 1 to 4, more preferably an integer of 1 to 3, and still more preferably an integer of 2 or 3.

Hereinafter, specific examples of the compound represented by the general formula (I) will be described.

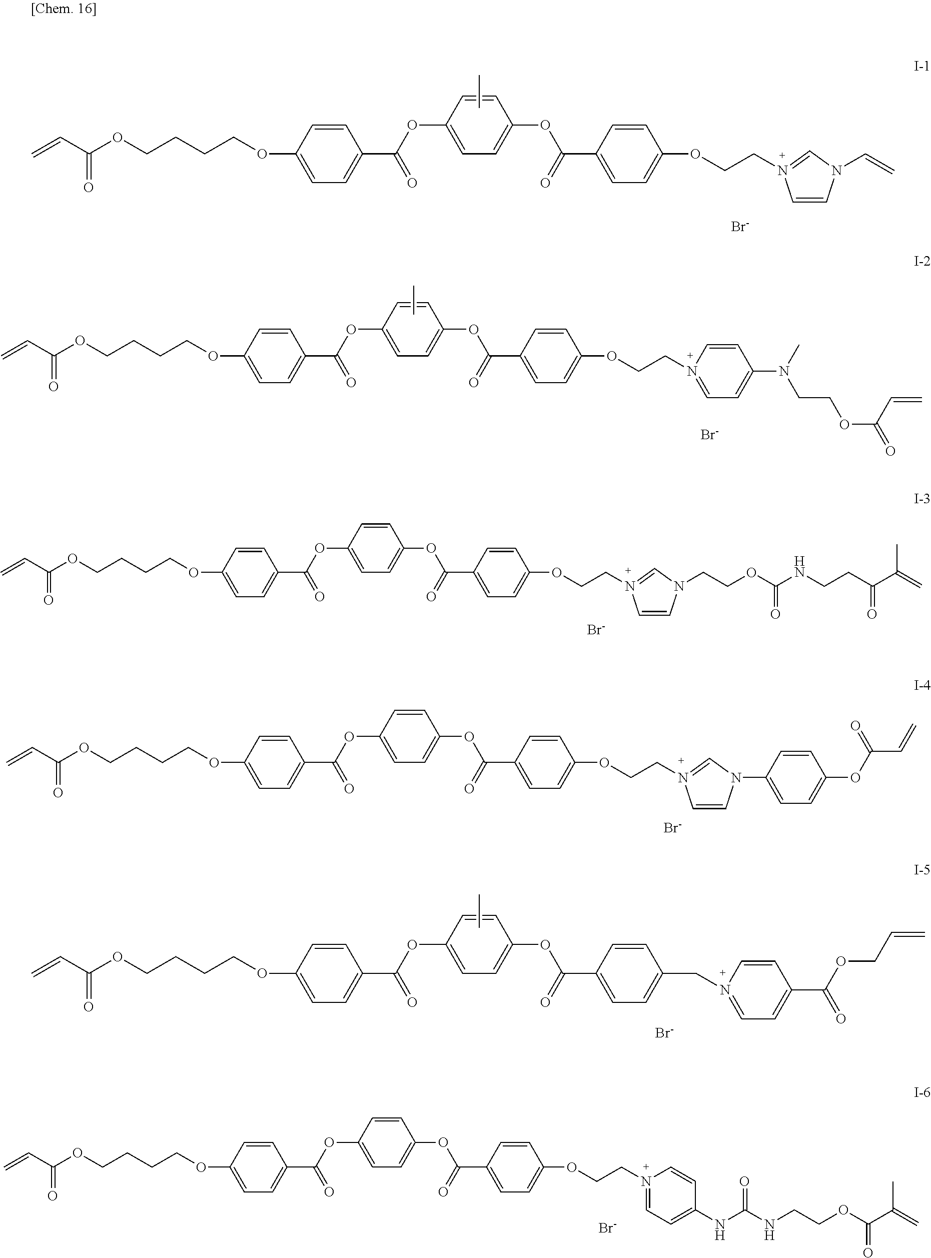

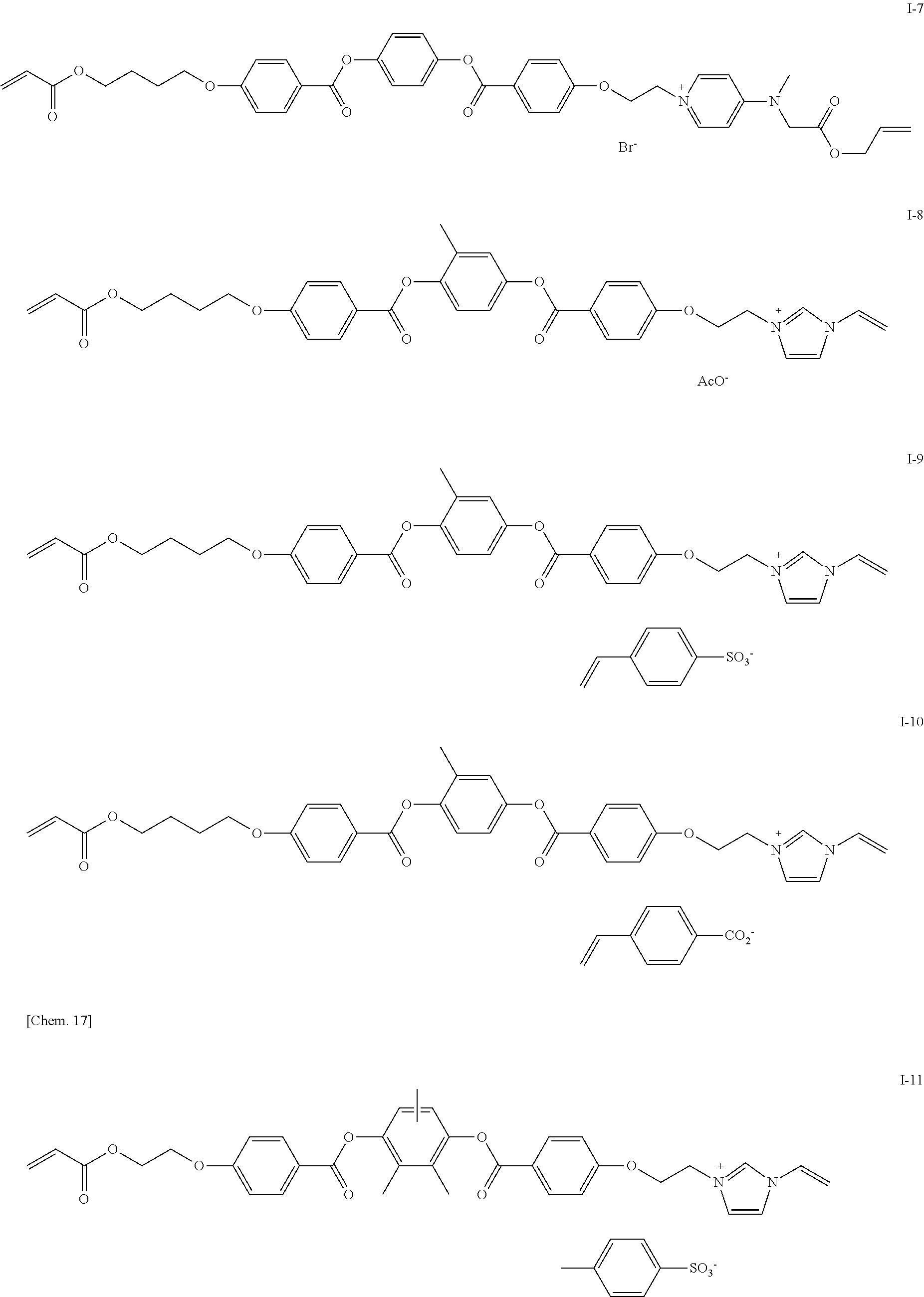

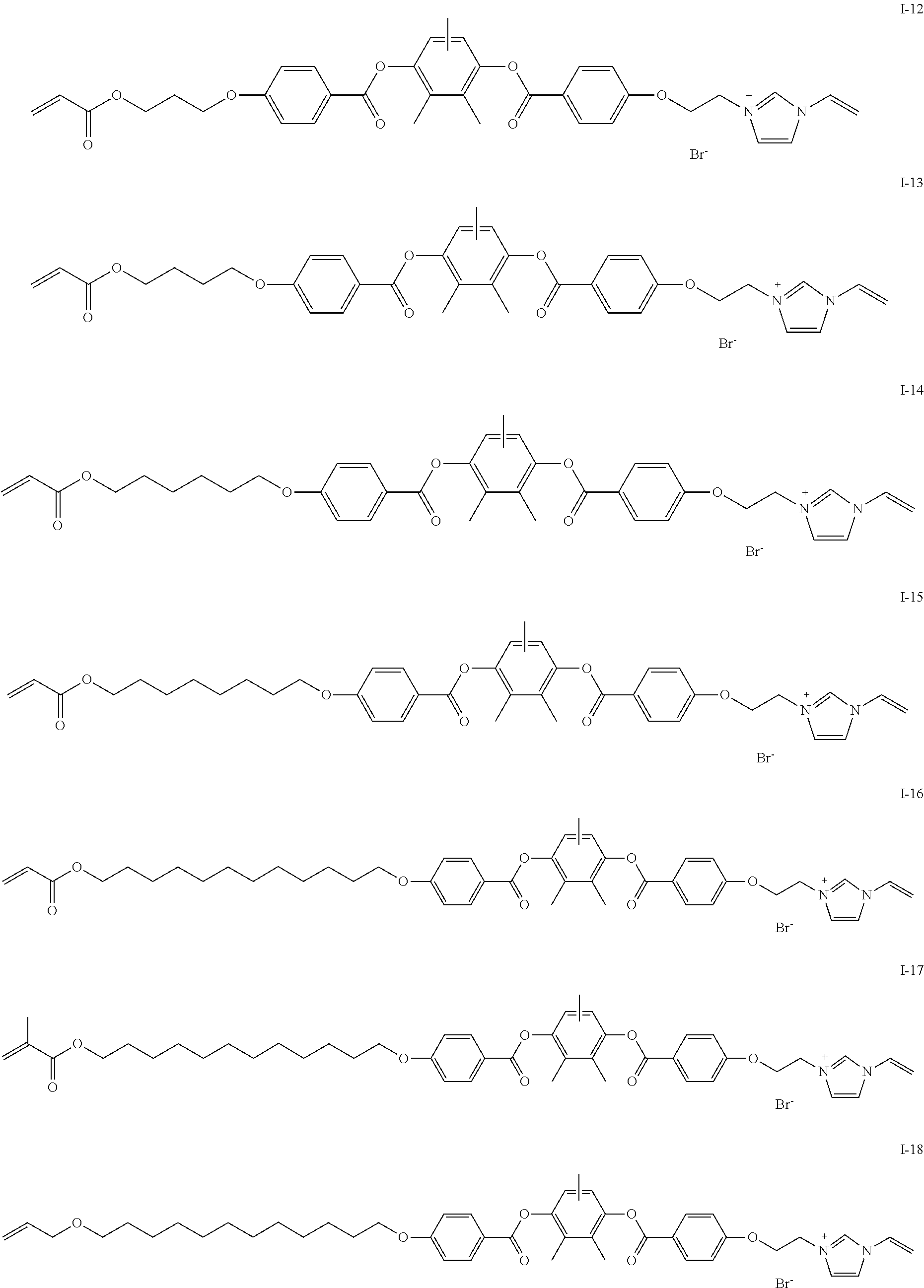

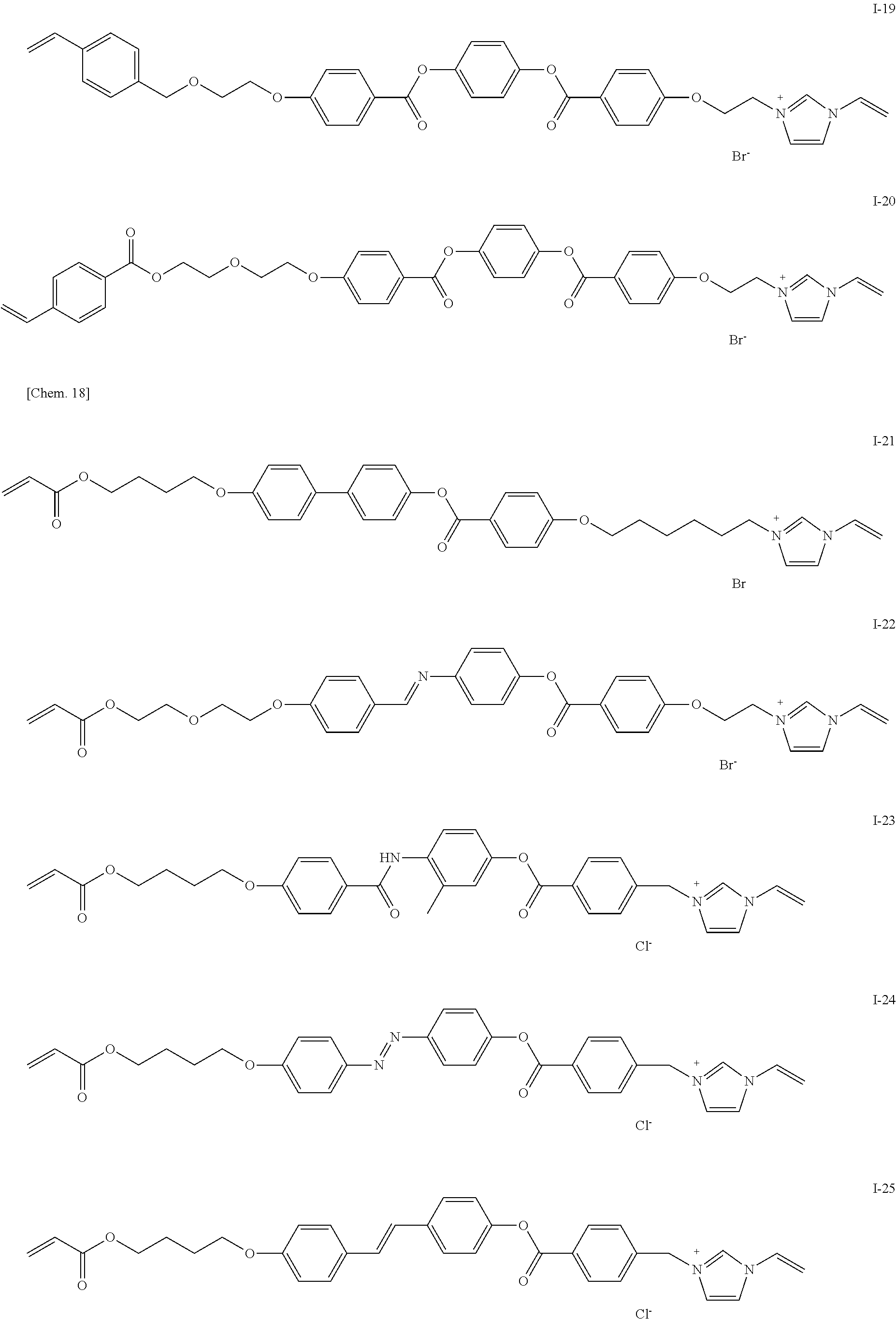

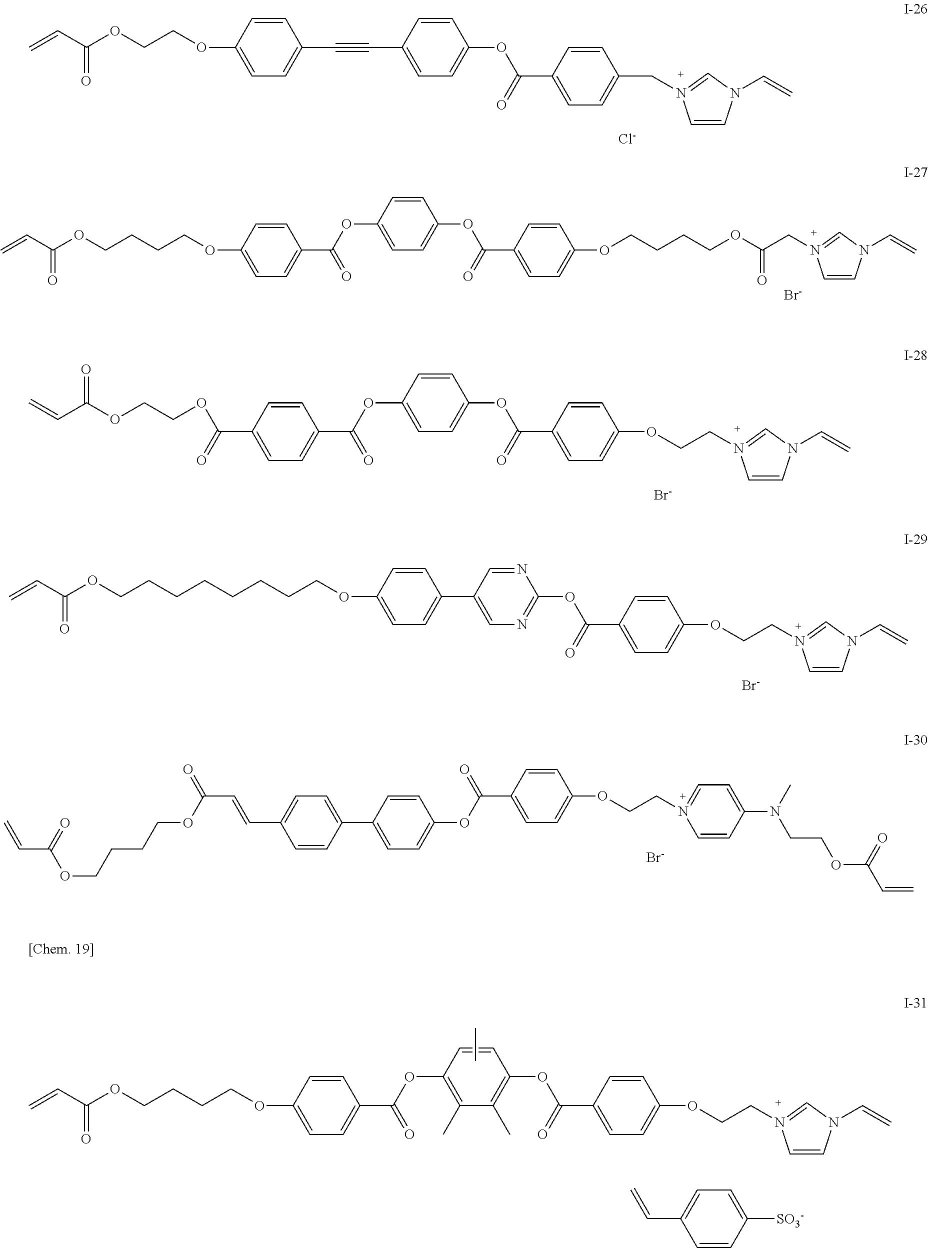

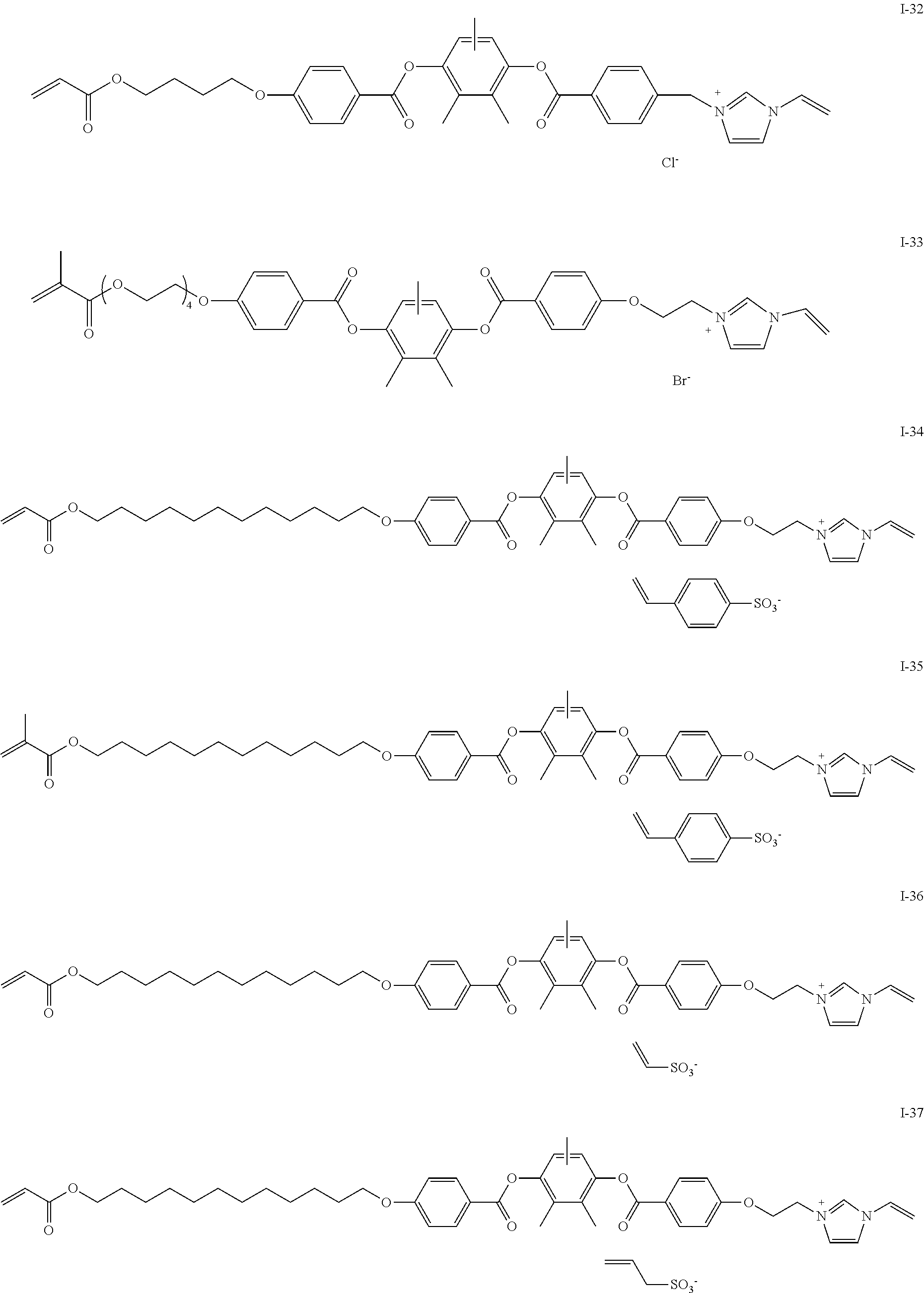

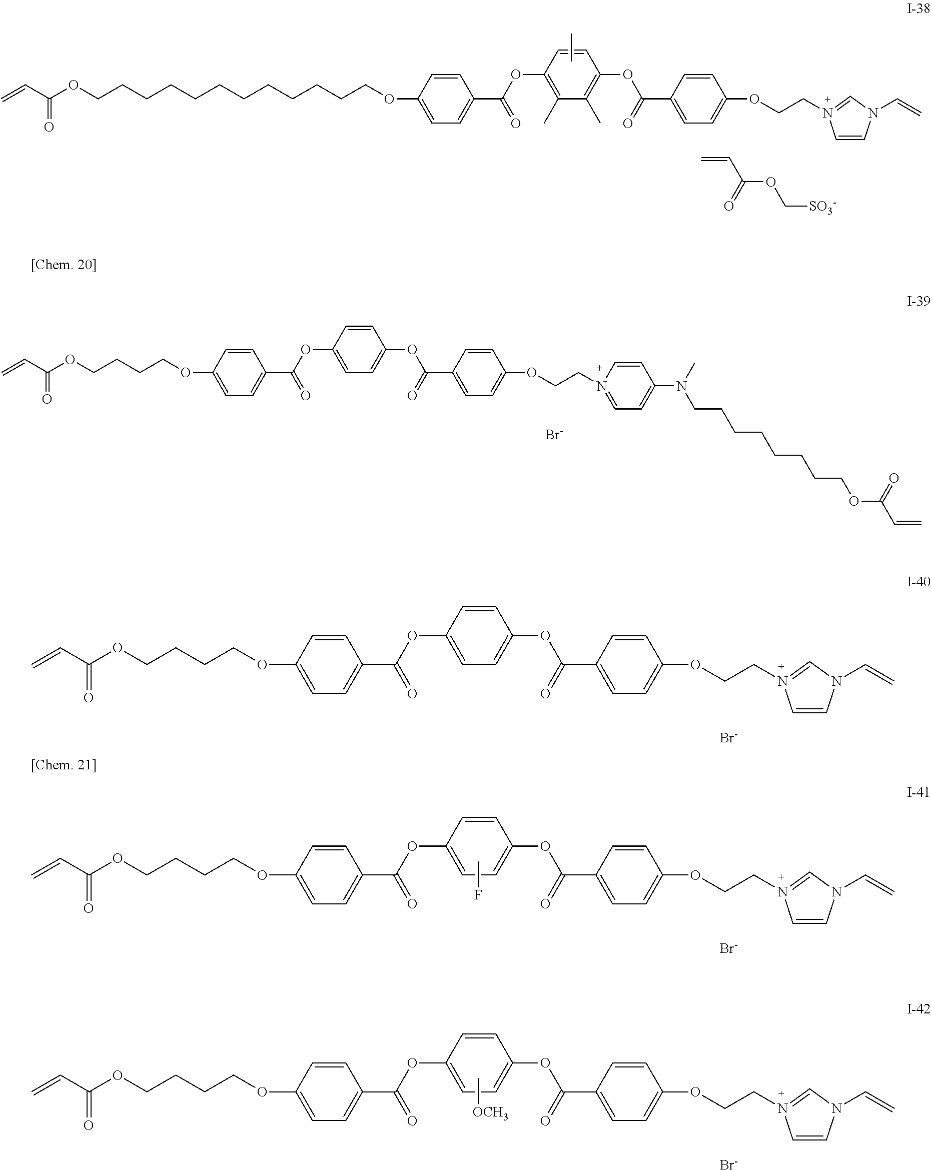

The onium compound of the general formula (I) can be synthesized by allowing a nitrogen-containing hetero ring to be alkylated (Menschutkin reaction) in general.

From a viewpoint that a vertical alignment agent is likely to be unevenly distributed to the intermediate layer including a polar group, it is preferable that the phase difference layer contain at least one kind of element selected from bromine, boron, and silicon and more preferable that at least one kind of element selected from bromine, boron, and silicon be unevenly and largely distributed to the side close to the intermediate layer.

As the extent of the distribution to the intermediate layer in which the vertical alignment agent has a polar group, three times or greater the abundance ratio of the substrate side interface on the intermediate layer side to the surface side interface is preferable.

### (Optical Characteristics of Phase Difference Layer)

The value of Re of the phase difference layer is preferably in the range of 0 nm to 10 nm, more preferably in the range of 0 nm to 3 nm, still more preferably in the range of 0 nm to 2 nm, and particularly preferably in the range of 0 nm to 1 nm.

The value of Rth of the phase difference layer is preferably in the range of −100 nm to −250 nm, more preferably in the range of −120 nm to −230 nm, and still more preferably in the range of −140 nm to −210 nm.

In addition, the retardation of the phase difference layer can be measured by performing measurement on the value of a film obtained by coating a glass plate with an intermediate layer and a phase difference layer in this order.

Here, Re represents a value of in-plane retardation measured using light having a wavelength of 550 nm at 25° C. and at 60% RH, and Rth represents a value of retardation in a thickness direction measured using light having a wavelength of 550 nm at 25° C. and at 60% RH.

### (Film Thickness of Phase Difference Layer)

From viewpoints of contribution to thinning a film and improvement of curling of a film, the film thickness phase difference layer is preferably in the range of 0.5 μm to 2.0 μm and more preferably in the range of 1.0 μm to 2.0 μm.

### [Phase Difference Film]

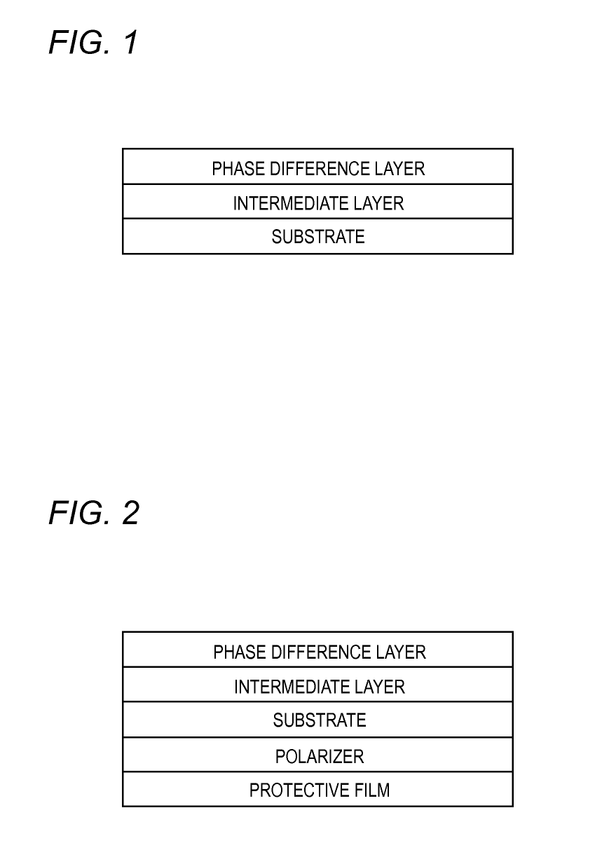

The phase difference film of the present invention is a phase difference film which includes at least the substrate, the intermediate layer, and the phase difference layer to which an alignment state of the liquid crystal compound is fixed. That is, the phase difference film of the present invention is a lamination type phase difference film. FIG. 1 illustrates an example of the phase difference film according to the embodiment of the present invention.

### (Optical Characteristics of Phase Difference Film)

The optical characteristics of the phase difference film of the present invention satisfy the following formulae (1), (2), and (3).

80 nm≦Re≦150 nm Formula (1)

−100 nm≦Rth≦10 nm Formula (2)

0.05≦|Rth/Re|≦1.0 Formula (3)

Here, Re represents a value of in-plane retardation (unit: nm) measured using light having a wavelength of 550 nm at 25° C. and at 60% RH, Rth represents a value of retardation (unit: nm) in a thickness direction measured using light having a wavelength of 550 nm at 25° C. and at 60% RH.

Re of the phase difference film is preferably in the range of 80 nm to 150 nm and more preferably in the range of 90 nm to 120 nm.

Rth of the phase difference film is preferably in the range of −100 nm to 10 nm and more preferably in the range of −50 nm to −10 nm.

|Rth/Re| of the phase difference film is preferably in the range of 0.05 to 1.0 and more preferably in the range of 0.1 to 0.5.

### (Film Thickness of Phase Difference Film)

From a viewpoint of capable of coping with thinning of a film in recent years, the film thickness of the phase difference film is preferably in the range of 20 μm to 50 μm, more preferably in the range of 22 μm to 50 μm, and sill more preferably in the range of 25 μm to 45 μm.

From a viewpoint of making a film with no problems concerning handling and punching, the tear strength of the phase difference film is preferably in the range of 1.5 g·cm/cm to 6.0 g·cm/cm.

The stretching conditions are needed to be taken into consideration because the tear strength is affected by the alignment state of the cellulose acylate of the substrate.

The dynamic friction coefficient of both surfaces of the phase difference film is preferably 0.6 or smaller. In this manner, slidability is provided to the film and the film is difficult to creak. The dynamic friction coefficient of both surfaces can be controlled by the addition amount of an additive.

### (Method of Producing Phase Difference Film)

The phase difference film of the present invention can be formed by the following method, but the method is not limited thereto.

First, a cellulose acylate film serving as a substrate is prepared.

Next, a composition for forming an intermediate layer is prepared, and the substrate is coated with the composition using a dip coating method, an air knife coating method, a curtain coating method, a roller coating method, a wire bar coating method, a gravure coating method, and a die coating method, and then the resultant is heated and dried. A macrogravure coating method, a wire bar coating method, a die coating method (see the specification of U.S. Pat. No. 2,681,294 and the publication of JP-A-2006-122889) are more preferable and a die coating method is particularly preferable.

After coating is performed, the resultant is dried, irradiated with light, and cured to form an intermediate layer.

Continuously, a composition for forming a phase difference layer is prepared and applied to the intermediate layer to form a phase difference layer.

In this manner, the phase difference film of the present invention can be obtained. Further, another layer can be provided if necessary. In the method of producing the phase difference film of the present invention, a plurality of layers may be coated simultaneously or sequentially.

In addition, when the intermediate layer and the phase difference layer are formed, a technique of improving the adhesion property of an interface can be used since a polymerization reaction occurs on the interface between the intermediate layer and the phase difference layer by leaving a non-reacted polymerizable group on the intermediate layer without completing polymerization of the intermediate layer and by allowing the non-reacted polymerizable group of the intermediate layer to be all reacted during polymerization curing of the phase difference film.

The liquid crystal display device that is operated in a horizontal electric field mode includes two sheets of cell substrates; a liquid crystal cell which is interposed therebetween and has a liquid crystal layer aligned in the vicinity of the cell substrates in a voltage non-applied state in substantially parallel with the substrates; a pair of polarizing plates arranged on the outside of the respective substrates of the liquid crystal cell; a first phase difference film arranged between one polarizing plate and one cell substrate; and a second phase difference film arranged between another polarizing plate and another cell substrate, the slow axis of the first phase difference film is arranged so as to orthogonal to the long axis in the voltage non-applied state of liquid crystal molecules in the vicinity of the inside of the cell substrates which are adjacent to the slow axis, and it is preferable that the phase difference film of the present invention be used as one of the first phase difference film or the second phase difference film.

### [Protective Film for Polarizing Plate]

In a case where the phase difference film is used as a surface protective film (protective film for a polarizing plate) of a polarizing film (polarizer), it is possible to improve the adhesion property with the polarizing film having polyvinyl alcohol as a main component by hydrophilizing and saponifying the surface of the substrate, that is, the surface on the side which attached to the polarizing film.

### [Polarizing Plate]

The polarizing plate of the present invention is a polarizing plate having two sheets of protective films that protect a polarizing film and both surfaces of the polarizing film, and at least one of the protective film is the phase difference film of the present invention. FIG. 2 illustrates an example of the polarizing plate according to the embodiment of the present invention.

In two sheets of protective films, it is preferable that one be the phase difference film of the present invention and the other be a film formed of an acrylic resin from a viewpoint of curling of the polarizing plate after the polarizing plate is processed. Examples of the film formed of an acrylic resin include ACRYPLEN (manufactured by Mitsubishi Rayon Co., Ltd.), TECHNOLLOY (manufactured by Sumitomo Chemical Co., Ltd.), and SUNDUREN (manufactured by KANEKA CORPORATION).

Examples of the polarizing film include an iodine-based polarizing film, a dye-based polarizing film using a dichroic dye, and a polyene-based polarizing film. The iodine-based polarizing film and the dye-based polarizing film can be produced using a polyvinyl alcohol-based film in general.

A configuration in which the cellulose acylate film of the phase difference film is adhered to the polarizing film through an adhesive layer or the like formed of polyvinyl alcohol if necessary and the other polarizing film has a protective film is preferable. An adhesive layer may be included on the surface on the opposite side to the polarizing film of the other protective film.

The film thickness of the entire polarizing plate (total film thickness of the phase difference film, the polarizing film, and the protective film) is preferably in the range of 80 μm to 120 μm.

### [Liquid Crystal Display Device]

The liquid crystal display device of the present invention includes the phase difference film or the polarizing plate of the present invention.

The phase difference film of the present invention can be advantageously used for the liquid crystal display device having a horizontal electric field mode.

The liquid crystal display device that is operated in a horizontal electric field mode includes two sheets of cell substrates; a liquid crystal cell which is interposed therebetween and has a liquid crystal layer aligned in the vicinity of the cell substrates in a voltage non-applied state in substantially parallel with the substrates; a pair of polarizing plates arranged on the outside of the respective substrates of the liquid crystal cell; a first phase difference film arranged between one polarizing plate and one cell substrate; and a second phase difference film arranged between another polarizing plate and another cell substrate, the slow axis of the first phase difference film is arranged so as to orthogonal to the long axis in the voltage non-applied state of liquid crystal molecules in the vicinity of the inside of the cell substrates which are adjacent to the slow axis, and it is preferable that one of the first phase difference film or the second phase difference film be the phase difference film of the present invention.

Further, in another preferred embodiment of a liquid crystal display device of the present invention, the liquid crystal display device includes a first substrate on which unit pixels are arranged; a second substrate which faces the first substrate; a liquid crystal layer which is formed between the first and second substrates and arranged in a first direction; a first polarizing plate which is formed on the outside of the first substrate and has a polarization transmission axis parallel to the first direction; and a second polarizing plate which is formed on the outside of the second substrate and has a polarization transmission axis vertical to the first direction, the first polarizing plate includes a polyvinyl alcohol film having a polarization function and a triacetyl cellulose film or acrylic film on the surfaces of the inside and the outside of the polyvinyl alcohol film, the second polarizing plate includes a polyvinyl alcohol film having a polarization function and a tricetyl cellulose film or acrylic film on one surface of the polyvinyl alcohol film, a phase difference film formed on the other surface of the polyvinyl alcohol film, and the lamination phase difference film is the phase difference film of the present invention.

### EXAMPLES

The present invention will be described with reference to examples in detail. The materials, the used amounts, the ratios, the contents of processes, and the procedures of processes shown in the examples below can be appropriately changed within the range not departing the scope of the present invention. Accordingly, the present invention is not limited to the specific examples described below.

### 1. Preparation of Substrate

### (1) Preparation of Cellulose Acylate Film

Cellulose acylate films were produced using the following method.

### (1)-1 Preparation of Cellulose Acylate Solution for Preparing Dope

A main agent, an additive, and a solvent listed in Table below were added to a mixing tank, stirred, dissolved respective components, and the solution was heated at 90° C. for approximately 10 minutes and then filtered with filter paper having an average hole diameter of 34 μm and a sintered metal filter having an average hole diameter of 10 μm.

In addition, the addition amount of the additive was expressed by “parts by mass” with respect to 100 parts by mass of the main agent. The composition ratio of a solvent 1 to a solvent 2 was listed in Table in terms of the mass ratio. Further, the solid content concentration (unit: % by mass) of the cellulose acylate solution was listed in the column of “concentration” in Table.

Preparation of Fine Particle Dispersion Liquid

Next, a fine particle dispersion liquid containing respective cellulose acylate solutions prepared using the above-described method was prepared by adding the components described below to a disperser.

Fine particle dispersion liquid

| | | |
|---|---|---|
| Inorganic fine particles (Aerosil R972, | 0.2 | parts by mass |
| manufactured by Nippon Aerosil Co., Ltd.) | | |
| Methylene chloride | 72.4 | parts by mass |
| Methanol | 10.8 | parts by mass |
| each cellulose acylate solution | 10.3 | parts by mass |

The fine particle dispersion liquid was mixed to each cellulose acylate solution to prepare a dope for producing a film in an amount of 0.02 parts by mass of inorganic fine particles with respect to 100 parts by mass of cellulose acylate.

### (1)-2 Casting

The above-described dope was case using a band casting machine. In addition, the band was made of stainless steel.

### (1)-3 Drying

The obtained cast web (film) was dried at a drying temperature of 120° C. for 20 minutes after the web was peeled from the band and a pass roll was conveyed. Further, the drying temperature herein means a film surface temperature.

### (1)-4 Stretching

The obtained web (film) was peeled from the band, interposed between clips, and stretched in a direction (TD) orthogonal to the film conveying direction (MD) under the condition of fixed end uniaxial stretching at the stretching temperature and the stretching ratio listed in Table using a tenter.

The stretching ratio and the stretching temperature are listed in Table below.

### (1)-5 Saponification Treatment

A saponification treatment was performed on a sample of a substrate as described below.

The prepared substrate was immersed in a 2.3 mol/L aqueous sodium hydroxide solution at 55° C. for 3 minutes. The substrate was washed in a water washing bath at room temperature and then neutralized using 0.05 mol/L of sulfuric acid at 30° C. The resultant was washed again in a water washing bath at room temperature and then dried at 100° C. with warm air. In this manner, the saponification treatment was performed on the surface of the substrate.

TABLE 6

| | Substrate | | | | | | | |
|---|---|---|---|---|---|---|---|---|
| | Dose | | | | | | | |
| | | | | Average carbon | | | | |
| | | | | number of | | | | |
| | | | Addition | carboxylic | | Addition | | |
| Substrate | Main | Additive | amount of | acid of | Additive | amount of | Solvent | Solvent |
| No. | agent | 1 | additive 1 | additive 1 | 2 | additive 2 | 1 | 2 |
| 1 | Apper 3000 | — | — | — | — | — | Methylene | Methanol |
| | | | | | | | chloride | |
| 2 | CTA: 1.9 | S1 | 15 | 6.2 | L1 | 3.5 | Methylene | Methanol |
| | | | | | | | chloride | |
| 3 | CTA: 2.1 | S1 | 19 | 6.2 | — | — | Methylene | Methanol |
| | | | | | | | chloride | |
| 4 | CTA: 2.53 | S1 | 15 | 6.2 | L1 | 2.5 | Methylene | Methanol |
| | | | | | | | chloride | |
| 5 | CTA: 2.65 | S1 | 15 | 6.2 | L1 | 3.5 | Methylene | Methanol |
| | | | | | | | chloride | |
| 6 | CTA: 2.43 | S3 | 15 | 5.2 | — | — | Methylene | Methanol |
| | | | | | | | chloride | |
| 7 | CTA: 2.43 | S4 | 15 | 5 | — | — | Methylene | Methanol |
| | | | | | | | chloride | |
| 8 | CTA: 2.43 | Sugar3 | 15 | — | — | — | Methylene | Methanol |
| | | | | | | | chloride | |
| 9 | CTA: 2.43 | TPP/ | 15 | — | — | — | Methylene | Methanol |
| | | BDP | | | | | chloride | |
| 10 | CTA: 2.43 | S1 | 15 | 6.2 | — | — | Methylene | Methanol |
| | | | | | | | chloride | |
| 11 | CTA: 2.43 | S1 | 15 | 6.2 | L1 | 3.5 | Methylene | Methanol |
| | | | | | | | chloride | |
| 12 | CTA: 2.43 | S2 | 9 | 8 | Sugar2 | 3 | Methylene | Methanol |
| | | | | | | | chloride | |
| 13 | CTA: 2.43 | S1 | 15 | 6.2 | L2 | 3.5 | Methylene | Methanol |
| | | | | | | | chloride | |
| 14 | CTA: 2.43 | S2 | 9 | 8 | Sugar2 | 3 | Methylene | Ethanol |
| | | | | | | | chloride | |
| 15 | CTA: 2.43 | S1 | 10 | 6.2 | — | — | Methylene | Methanol |
| | | | | | | | chloride | |
| 16 | CTA: 2.43 | S1 | 10 | 6.2 | — | — | Methylene | Methanol |
| | | | | | | | chloride | |
| 17 | CTA: 2.43 | S1 | 10 | 6.2 | — | — | Methylene | Methanol |
| | | | | | | | chloride | |
| 18 | CTA: 2.43 | S1 | 10 | 6.2 | — | — | Methylene | Methanol |
| | | | | | | | chloride | |
| 19 | CTA: 2.43 | S1 | 10 | 6.2 | — | — | Methylene | Methanol |
| | | | | | | | chloride | |
| 20 | CTA: 2.43 | S1 | 10 | 6.2 | — | — | Methylene | Methanol |
| | | | | | | | chloride | |
| 21 | CTA: 2.43 | S1 | 10 | 6.2 | — | — | Methylene | Methanol |
| | | | | | | | chloride | |
| 22 | CTA: 2.43 | S1 | 10 | 6.2 | — | — | Methylene | Methanol |
| | | | | | | | chloride | |
| 23 | CTA: 2.43 | S1 | 10 | 6.2 | — | — | Methylene | Methanol |
| | | | | | | | chloride | |
| 24 | CTA: 2.43 | Sugar 1 | 10 | — | — | — | Methylene | Ethanol |
| | | | | | | | chloride | |
| 25 | CAP | S1 | 15 | 6.2 | L2 | 3.5 | Methylene | Methanol |
| | | | | | | | chloride | |
| 26 | CTA: 2.58 | S1 | 15 | 6.2 | — | — | Methylene | Methanol |
| | | | | | | | chloride | |
| 27 | CTA: 2.53 | S1 | 15 | 6.2 | L1 | 6.5 | Methylene | Methanol |
| | | | | | | | chloride | |
| 28 | CTA: 2.53 | S1 | 15 | 6.2 | L1 | 2.5 | Methylene | Methanol |
| | | | | | | | chloride | |
| 29 | CTA: 2.43 | S2 | 9 | 8 | Sugar2 | 3 | Methylene | Ethanol |
| | | | | | | | chloride | |
| 30 | CTA: 2.43 | S2 | 9 | 8 | Sugar2 | 3 | Methylene | Ethanol |
| | | | | | | | chloride | |
| 31 | CTA: 2.43 | S2 | 9 | 8 | Sugar2 | 3 | Methylene | Ethanol |
| | | | | | | | chloride | |
| 32 | CTA2.81 | S1 | 15 | 6.2 | L1 | 3.5 | Methylene | Methanol |
| | CTA: 2.43 | | | | | | chloride | |
| | CTA: 2.81 | | | | | | | |
| 33 | CTA: 2.43 | S1 | 19 | 6.2 | L2 | 5 | Methylene | Ethanol |
| | | | | | | | chloride | |
| 34 | CTA: 1.9 | S1 | 15 | 6.2 | L1 | 3.5 | Methylene | Methanol |
| | | | | | | | chloride | |

| | Substrate | | | | | | | |
|---|---|---|---|---|---|---|---|---|
| | Dose | | Stretching condition | | | Optical | | |
| | Solvent | Concen- | Temper- | Magni- | Film | characteristic | | Saponification |
| Substrate | compo- | tration | ature | fication | thickness | Re | Rth | treatment on |
| No. | sition | (% by mass) | (° C.) | (%) | (μm) | (nm) | (nm) | substrate |
| 1 | 92/8 | 22 | 150 | 30 | 60 | 50 | 220 | — |
| 2 | 87/13 | 24 | 185 | 60 | 44 | 160 | 170 | Yes |
| 3 | 87/13 | 23 | 185 | 60 | 43 | 102 | 108 | Yes |
| 4 | 87/13 | 22 | 185 | 60 | 44 | 95 | 95 | Yes |
| 5 | 87/13 | 20 | 185 | 60 | 44 | 65 | 68 | Yes |
| 6 | 87/13 | 22 | 189 | 60 | 44 | 72 | 90 | Yes |
| 7 | 87/13 | 22 | 189 | 60 | 44 | 52 | 70 | Yes |
| 8 | 87/13 | 20 | 192 | 60 | 44 | 70 | 92 | Yes |
| 9 | 87/13 | 20 | 192 | 60 | 44 | 75 | 90 | Yes |
| 10 | 87/13 | 22 | 188 | 90 | 30 | 95 | 95 | Yes |
| 11 | 87/13 | 22 | 184 | 60 | 43 | 100 | 108 | No |
| 12 | 87/13 | 21 | 188 | 70 | 40 | 100 | 105 | No |
| 13 | 87/13 | 22 | 185 | 62 | 42 | 102 | 112 | No |
| 14 | 87/13 | 19 | 186 | 70 | 43 | 95 | 113 | Yes |
| 15 | 87/13 | 22 | 190 | 88 | 42 | 90 | 93 | No |
| 16 | 87/13 | 22 | 190 | 88 | 42 | 90 | 93 | Yes |
| 17 | 87/13 | 22 | 190 | 88 | 42 | 90 | 93 | Yes |
| 18 | 87/13 | 22 | 190 | 88 | 42 | 90 | 93 | Yes |
| 19 | 87/13 | 22 | 190 | 88 | 42 | 90 | 93 | Yes |
| 20 | 87/13 | 22 | 190 | 88 | 42 | 90 | 93 | Yes |
| 21 | 87/13 | 22 | 190 | 88 | 42 | 90 | 93 | Yes |
| 22 | 87/13 | 22 | 190 | 88 | 42 | 90 | 93 | No |
| 23 | 87/13 | 22 | 190 | 88 | 42 | 90 | 93 | Yes |
| 24 | 85/15 | 23 | 186 | 50 | 46 | 85 | 110 | Yes |
| 25 | 87/13 | 22 | 185 | 62 | 41 | 98 | 100 | Yes |
| 26 | 87/13 | 22 | 185 | 60 | 53 | 81 | 90 | Yes |
| 27 | 87/13 | 22 | 185 | 40 | 45 | 81 | 220 | Yes |
| 28 | 87/13 | 22 | 185 | 60 | 44 | 95 | 95 | Yes |
| 29 | 87/13 | 19 | 186 | 70 | 43 | 95 | 113 | Yes |
| 30 | 87/13 | 19 | 186 | 70 | 43 | 95 | 113 | Yes |
| 31 | 87/13 | 19 | 186 | 70 | 43 | 95 | 113 | Yes |
| 32 | 87/13 | 19 | 182 | 57 | 1 | 98 | 108 | Yes |
| | | 22 | | | 41 | | | |
| | | 19 | | | 1 | | | |
| 33 | 87/13 | 22 | 189 | 70 | 38 | 100 | 100 | No |
| 34 | 87/13 | 24 | 185 | 60 | 44 | 160 | 170 | Yes |

The used compounds are respectively shown below.

In Table, “CTA” represents cellulose triacetate and the numerical value represents the acyl group substitution degree.

CAP represents cellulose acetate propionate, the acyl group substitution degree is 0.7, and the propionyl group substitution degree is 1.6.

In addition, a substrate 32 was prepared by setting cellulose triacetate having an acetyl group substitution degree of 2.43 as a core layer and co-casting a film containing cellulose triacetate having an acetyl group substitution degree of 2.81 as skin layers on both sides of a core layer. The acetyl group substitution degree of the entire cellulose triacetate of the substrate 32 was 2.45.

Appear3000 is a cyclic olefin resin manufactured by Ferraania, Inc.

TABLE 7

| | Glycol unit | | | | Dicarboxylic acid unit | | | | Number |
|---|---|---|---|---|---|---|---|---|---|
| | Sealing | EG | PG | Average | TPA | AA | SA | Average | average |
| Polyester | rate (%) of both | (% by | (% by | carbon | (% by | (% by | (% by | carbon | molecular |
| polyol | terminals | mole) | mole) | number | mole) | mole) | mole) | number | weight |
| S1 | 100% | 50 | 50 | 2.5 | 55 | 0 | 45 | 6.2 | 1000 |
| | acetyl group | | | | | | | | |
| S2 | 100% | 0 | 100 | 3 | 100 | 0 | 0 | 8 | 1000 |
| | benzoyl group | | | | | | | | |
| S3 | 100% | 50 | 50 | 2.5 | 20 | 20 | 60 | 5.2 | 1000 |
| | acetyl group | | | | | | | | |
| S4 | 100% | 0 | 100 | 3 | 0 | 50 | 50 | 5 | 1000 |
| | acetyl group | | | | | | | | |

EG: ethylene glycol
PG: 1,2-propanediol
TPA: terephthalic acid
AA: Adipic acid
SA: Succinic acid

In Sugar 1, five R's are substituted to the following substituents (benzoyl groups) and the rest of three R's are hydrogen atoms in the following general formula (10).

In Sugar 2, six R's are substituted to the following substituents (benzoyl groups) and the rest of two R's are hydrogen atoms in the following general formula (10).

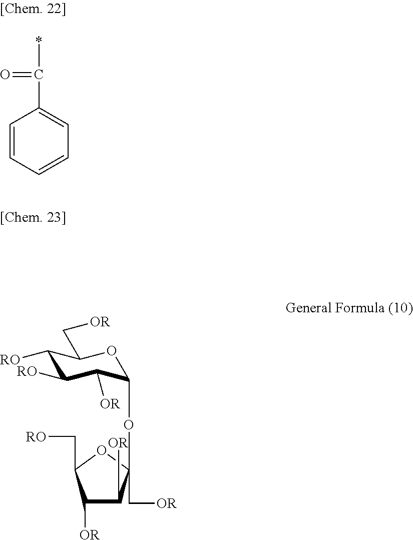

Sugar 3 is a compound having the following structure. Ac represents an acetyl group.

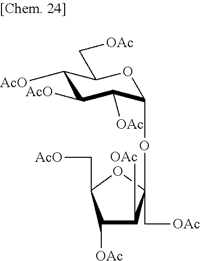

TPP represents triphenyl phosphate and BDP represents a biphenyl diphenyl phosphate. TPP/BDP means that TPP and BDP are contained in a mass ratio of 3:2.

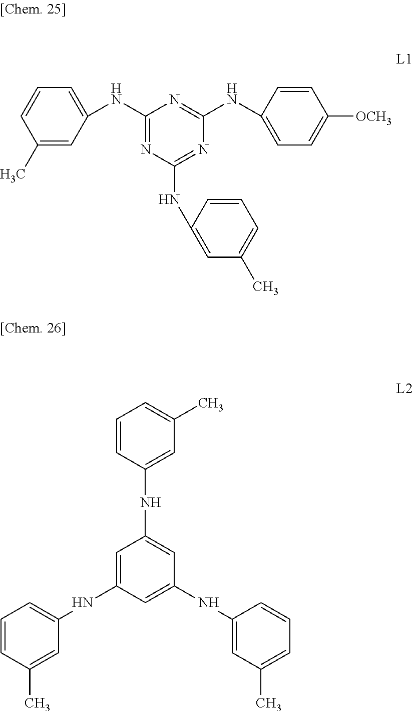 [SMILES: COc1ccc(Nc2nc(Nc3cccc(C)c3)nc(Nc3cccc(C)c3)n2)cc1 ; Cc1cccc(Nc2cc(Nc3cccc(C)c3)cc(Nc3cccc(C)c3)c2)c1]

### 2. Formation of Intermediate Layer

A composition for forming an intermediate layer was prepared by mixing the contents described in Table 8 and solvents.

### (Acrylic Layer)

100 parts by mass of two kinds of acrylic compounds, 4 parts by mass of a photopolymerization initiator (Irgacure 127, manufactured by Ciba Specialty Chemicals Co., Ltd.), and a solvent were mixed to prepare a composition for forming an acrylic layer so as to have the concentration listed in Table 8. The composition for forming an acrylic layer prepared in this manner was applied to a substrate using a wire bar coater #1.6, dried at 60° C. for 0.5 minutes, and irradiated with UV rays at 30° C. for 30 seconds using a 120 W/cm high-pressure mercury lamp, and then an intermediate layer was crosslinked.

### (PVA Layer)

100 parts by mass of a compound (PVA 1 or PVA 2) represented by the following general formula PVA and 5 parts by mass of a compound represented by T1 below were dissolved in a solvent having a mass ratio of water to methanol of 75:25 such that the solution had the concentration listed in Table 8, thereby preparing a composition for forming a PVA layer.

In addition, the composition ratios of the contents to the solvents were listed in Table in terms of mass ratios. In addition, the solid content concentration (unit: % by mass) of the composition for forming an intermediate layer was listed in the column of “concentration” in Table.

The composition for forming an intermediate layer was applied to a substrate and the composition for forming an acrylic layer was applied using a wire bar coater #1.6. Next, the resultant was dried at 60° C. for 0.5 minutes and irradiated at 30° C. for 30 seconds with UV rays with an oxygen concentration under nitrogen purge of approximately 0.1%, an luminance of 40 mW/cm², and an irradiation amount of 120 mJ/cm² using a high-pressure mercury lamp, and then the intermediate layer was cured. The composition for forming a PVA layer and the other compositions were applied using a wire bar coater #8, and then dried at 60° C. for 0.5 minutes.

The film thickness of the obtained intermediate layer was listed in Table below.

TABLE 8

| | Intermediate layer | | | | | | | |
|---|---|---|---|---|---|---|---|---|
| | | Contents | | | | | | |
| Intermediate | Thickness | Concentration | | | Solvent | | | Content |
| layer No. | (μm) | (% by mass) | Solvent 1 | Solvent 2 | composition | Content 1 | Content 2 | ratio |
| 1 | 0.6 | 15 | cyclohexanone | — | 100/0 | ACR1 | ACR2 | 67/33 |
| 2 | 0.25 | 4 | water | Methanol | 75/25 | PVA2 | — | 100/0 |
| 3 | 0.25 | 4 | water | Methanol | 75/25 | PVA2 | — | 100/0 |
| 4 | 0.25 | 4 | water | Methanol | 75/25 | PVA2 | — | 100/0 |
| 5 | 0.25 | 4 | water | Methanol | 75/25 | PVA2 | — | 100/0 |
| 6 | 0.25 | 4 | water | Methanol | 75/25 | PVA2 | — | 100/0 |
| 7 | 0.25 | 4 | water | Methanol | 75/25 | PVA2 | — | 100/0 |
| 8 | 0.25 | 4 | water | Methanol | 75/25 | PVA2 | — | 100/0 |
| 9 | 0.25 | 4 | water | Methanol | 75/25 | PVA2 | — | 100/0 |
| 10 | 0.25 | 4 | water | Methanol | 75/25 | PVA1 | — | 100/0 |
| 11 | 0.5 | 15 | IPA | Methyl | 75/25 | ACR1 | ACR2 | 67/33 |
| | | | | acetate | | | | |
| 12 | 0.6 | 15 | IPA | Methyl | 75/25 | ACR1 | ACR2 | 67/33 |
| | | | | acetate | | | | |
| 13 | 0.5 | 15 | IPA | Methyl | 75/25 | ACR1 | ACR2 | 67/33 |
| | | | | acetate | | | | |
| 14 | 0.25 | 4 | water | Methanol | 75/25 | PVA1 | — | |
| 15 | 0.5 | 15 | IPA | Methyl | 75/25 | ACR1 | Fluorine- | 97/3 |
| | | | | acetate | | | containing | |
| | | | | | | | compound | |
| 16 | 0.5 | 15 | IPA | Methyl | 75/25 | Polystyrene | — | 100/0 |
| | | | | acetate | | | | |
| 17 | 0.5 | 15 | IPA | Methyl | 75/25 | Cyclic olefin | — | 100/0 |
| | | | | acetate | | | | |
| 18 | 0.5 | 15 | IPA | Methyl | 75/25 | Polyvinylidene | — | 100/0 |
| | | | | acetate | | chloride | | |
| 19 | 0.25 | 4 | water | Methanol | 75/25 | PVA1 | — | 100/0 |
| 20 | 0.25 | 4 | water | Methanol | 75/25 | PVA1 | — | 100/0 |
| 21 | 0.25 | 4 | water | Methanol | 75/25 | PVA1 | — | 100/0 |
| 22 | None | None | None | None | None | None | None | None |
| 23 | 0.25 | 4 | water | Methanol | 75/25 | PVA1 | — | 100/0 |
| 24 | 0.25 | 4 | water | Methanol | 75/25 | PVA1 | — | 100/0 |
| 25 | 0.25 | 4 | water | Methanol | 75/25 | PVA1 | — | 100/0 |
| 26 | 0.25 | 4 | water | Methanol | 75/25 | PVA1 | — | 100/0 |
| 27 | 0.25 | 4 | water | Methanol | 75/25 | PVA1 | — | 100/0 |
| 28 | 0.25 | 4 | water | Methanol | 75/25 | PVA1 | — | 100/0 |
| 29 | 0.25 | 4 | water | Methanol | 75/25 | PVA2 | — | 100/0 |
| 30 | 0.25 | 4 | water | Methanol | 75/25 | PVA2 | — | 100/0 |
| 31 | 0.25 | 4 | water | Methanol | 75/25 | PVA2 | — | 100/0 |
| 32 | 0.25 | 2.5 | water | Methanol | 75/25 | PVA2 | — | 100/0 |
| 33 | 0.5 | 20 | MIBK | Methyl | 30/70 | ACR1 | ACR2 | 67/33 |
| | | | | acetate | | | | |
| 34 | 0.25 | 4 | water | Methanol | 75/25 | PVA2 | — | 100/0 |

Used compounds are shown below.

IPA: isopropyl alcohol

MIBK: methyl isobutyl ketone

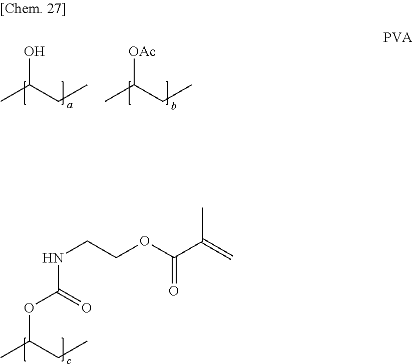

a, b, and c respectively represent a molar ratio of respective units.

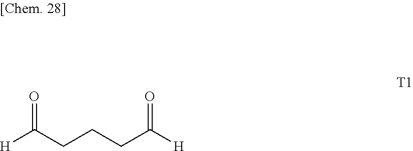

PVA1: a=96, b=2, and c=2 in the above PVA

PVA2: a=85, b=13, and c=2 in the above PVA

ACR1: Blenmer GLM, manufactured by NOF Corporation, compound having the following structure

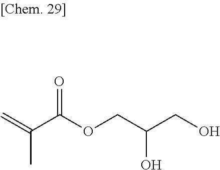

ACR2: KAYARAD PET30, manufactured by Nippon Kayaku Co., Ltd., mixture of compounds (pentaerythritol triacrylate and pentaerythritol tetraacrylate) having the following structure

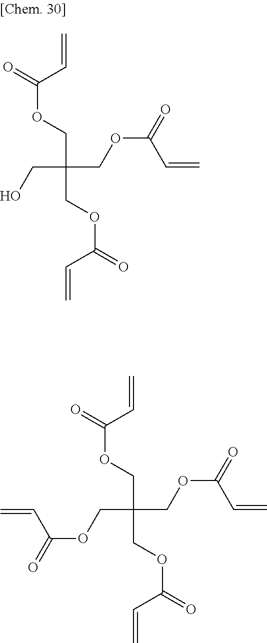

Polystyrene: PS Japan Corporation, G9504

Cyclic olefin: Appear 3000 (Ferraania, Inc.)

Polyvinylidene chloride: Wako Pure Chemical Industries, Ltd.

Fluorine-containing compound: compound having the following structure

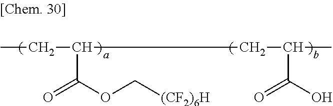

a and b each represent a mass ratio of a repeating unit, and the values thereof are respectively 90 and 10.

### 3. Formation of Phase Difference Layer

A solution obtained by dissolving 1.8 g of a liquid crystal compound (mixture containing a liquid crystal compound 1 and a liquid crystal compound 2 listed in Table below in a composition ratio (mass ratio) listed in Table below) listed in Table below, 0.06 g of a photopolymerization initiator (Irgacure 907, manufactured by Nihon Ciba-Geigy K.K.), 0.02 g of a thickner (Kayacure DETX, manufactured by Nippon Kayaku Co., Ltd.), and 0.002 g of a vertical alignment agent listed in Table below in 9.2 g of a mixture of cyclohexane and cyclopentanone (=65/35 (% by mass)) was applied to the intermediate layer using a #3.2 wire bar. The resultant was attached to a metal frame, and heated in a thermostatic bath at 100° C. for 2 minutes, and a rod-shaped liquid crystal compound was aligned (homeotropic alignment). Next, the resultant was cooled to 50° C., and irradiated with UV rays with a luminance of 190 mW/cm² and an irradiation amount of 300 mJ/cm² using a 160 W/cm air-cooled metal halide lamp (manufactured by Eye Graphics Co., Ltd.) having an oxygen concentration under nitrogen purge of approximately 0.1%, and then the coated layer was cured. Thereafter, the resultant was left to be cooled to room temperature.

In addition, the solvent composition of the rod-shaped liquid crystal compound was changed and the mixture of cyclohexane and cyclopentanone (=65/35 (% by mass)) was changed to a mixture of methyl ethyl ketone (MEK) and cyclohexanone (=86/14 (% by mass)) only in Example 33.

TABLE 9

| | Liquid crystal layer | | | | | | |
|---|---|---|---|---|---|---|---|
| | Liquid crystal | | | | | | |
| | compound | | | Composition | | Optical | |
| Phase | Liquid | Liquid | Vertical | ratio of liquid | | characteristic | |
| difference | crystal | crystal | alignment | crystal | Thickness | Re | Rth |
| layer No. | compound 1 | compound 2 | agent | compound | (μm) | (nm) | (nm) |
| 1 | B01 | B02 | S01 | 80:20 | 1.3 | 0 | −165 |
| 2 | B01 | B02 | S01 | 85:15 | 1.3 | 0 | −165 |
| 3 | B01 | B02 | S01 | 85:15 | 1.3 | 0 | −165 |
| 4 | B01 | B02 | S01 | 85:15 | 1.3 | 0 | −165 |
| 5 | B01 | B02 | S01 | 85:15 | 1.3 | 0 | −165 |
| 6 | B01 | B02 | S01 | 85:15 | 1.3 | 0 | −165 |
| 7 | B01 | B02 | S01 | 85:15 | 1.3 | 0 | −165 |
| 8 | B01 | B02 | S01 | 85:15 | 1.3 | 0 | −165 |
| 9 | B01 | B02 | S01 | 85:15 | 1.3 | 0 | −165 |
| 10 | B01 | B02 | S01 | 85:15 | 1.3 | 0 | −165 |
| 11 | B01 | B02 | S01 | 80:20 | 1.3 | 0 | −165 |
| 12 | B01 | B02 | S01 | 80:20 | 1.3 | 0 | −165 |
| 13 | B01 | B02 | S01 | 80:20 | 1.3 | 0 | −165 |
| 14 | B01 | B02 | S01 | 85:15 | 1.3 | 0 | −165 |
| 15 | B01 | B02 | S01 | 85:15 | 1.3 | 0 | −165 |
| 16 | B01 | B02 | S01 | 85:15 | Impossible to measure | | |
| 17 | B01 | B02 | S01 | 85:15 | Impossible to measure | | |
| 18 | B01 | B02 | S01 | 85:15 | Impossible to measure | | |
| 19 | B01 | None | S01 | 100:0 | 1.5 | 0 | −165 |
| 20 | B02 | None | S01 | 100:0 | 1.3 | 0 | −145 |
| 21 | B01 | B03 | S01 | 85:15 | 1.3 | 0 | −165 |
| 22 | B01 | B02 | S01 | 85:15 | — | — | — |
| 23 | None | None | None | None | — | — | — |
| 24 | B01 | B02 | S01 | 85:15 | 1.5 | 0 | −185 |
| 25 | B01 | B02 | S01 | 85:15 | 1.3 | 0 | −165 |
| 26 | B01 | B02 | S01 | 85:15 | 1.3 | 0 | −165 |
| 27 | B01 | B02 | S01 | 85:15 | 2.2 | 0 | −280 |
| 28 | B01 | B02 | S02 | 85:15 | 1.3 | 0 | −165 |
| 29 | B01 | B02 | S03 | 85:15 | 1.3 | 0 | −165 |
| 30 | B01 | B02 | S04 | 85:15 | 1.3 | 0 | −165 |
| 31 | B01 | B02 | S05 | 85:15 | 1.3 | 0 | −165 |
| 32 | B01 | B02 | S01 | 90:10 | 1.3 | 0 | −165 |
| 33 | B01 | B02 | S01 | 90:10 | 1.35 | 0 | −165 |
| 34 | B01 | B02 | S01 | 85:15 | 1.45 | 0 | −192 |

Since layer boundaries of the phase difference layers 16 to 18 were not able to be recognized by SEM observation and the films were pure white, the thicknesses and optical characteristics were not able to be measured.

Since the phase difference layer 22 did not have an alignment film layer, and liquid crystals were not aligned and the color thereof was pure white, the thickness and the optical characteristics were not able to be measured, so “-” was written in the corresponding column.

Further, the phase difference layer 23 was not provided with a phase difference layer.

The used compounds are respectively shown below.

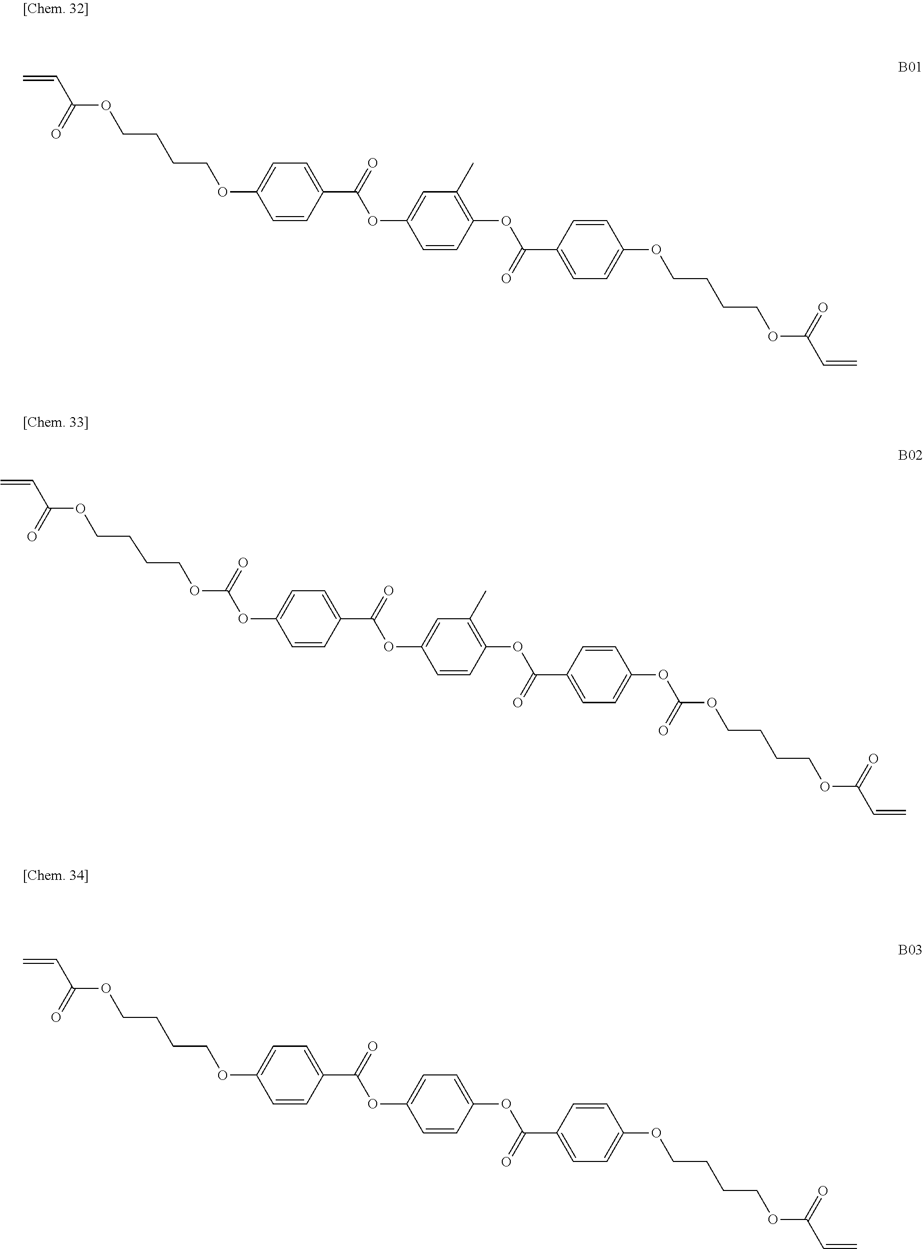

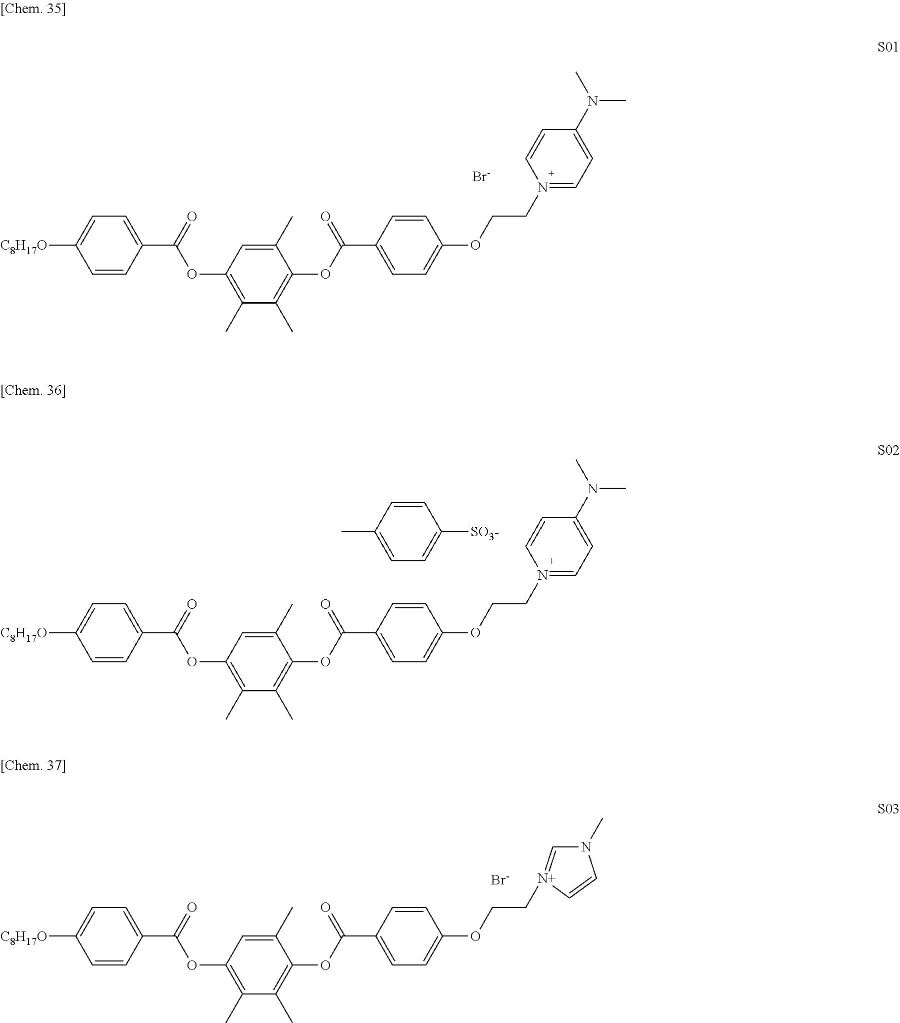

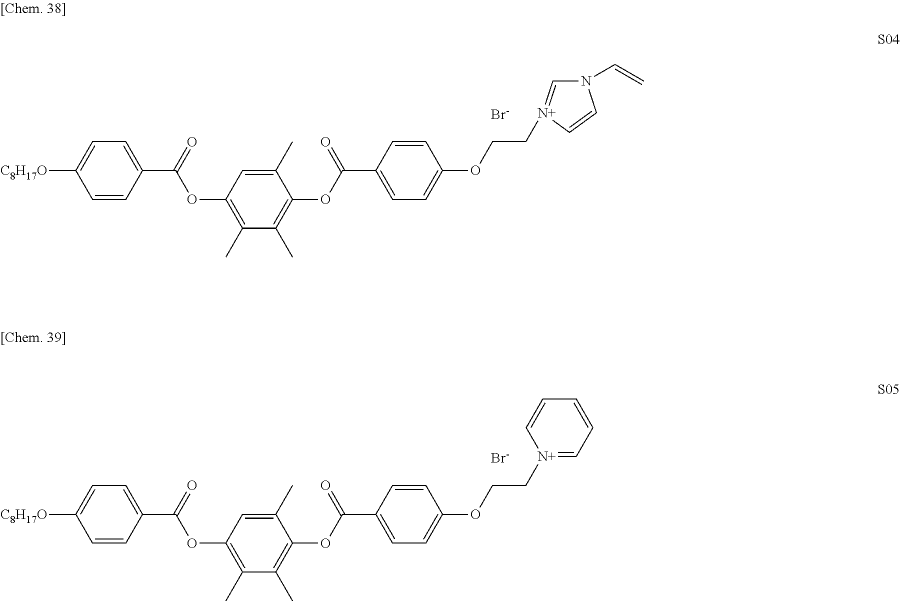

In this manner, each lamination type phase difference film including a phase difference layer formed of a homeotropic alignment liquid crystal layer were respectively prepared on the intermediate layer.

### <Evaluation of Phase Difference Film>

In each of the obtained phase difference film, the thickness, the film thickness of the cross section, Re, Rth, |Rth/Re|, the haze, the moisture permeability, the adhesion property, generation of crystals, and tear strength were evaluated.

### (Film Thickness of Cross Section)

After the cross section of the phase difference film was cut in the thickness direction using a microtome and dyed with osmic acid, the cross section was observed using an SEM, and measurement on the film thickness of a mixed layer containing a main component of the substrate and a main component of the intermediate layer between the substrate and the intermediate layer was performed.

The film thickness of the mixed layer of a phase difference film 1 was 5.5 μm, the film thickness of the mixed layer of a phase difference film 10 was 0.1 μm, and the film thickness of the mixed layer of a phase difference film 12 was 0.6 μm.

### (Tear Strength)

A film sample having dimensions of 50 mm×64 mm was humidified at a temperature of 23° C. and at a relative humidity of 65% for 2 hours, the weight necessary for tearing was measured in conformity with ISO6383/2-1983 using a light load tear strength tester (Toyo Seiki Seisaku-sho, Ltd.), and the values were averaged in directions of MD and TD to evaluate the tear strength.

### (Measurement of Haze)

The haze of the obtained film was measured using a haze meter of “HGM-2DP” (manufactured by Suga Test Instruments Co., Ltd.) in conformity with JIS K-6714.

### (Evaluation of Adhesion Property)

The adhesion property between the phase difference layer and the intermediate layer of the film was examined using a grid peeling test. 100 grids each having 2 mm×2 mm square were generated with a cutter, a Nitto Scotch tape (registered trademark) was attached thereto, and the grids were peeled from the tape, and then the number of remaining grids on the film without being peeled was scored based on the index below. When the number of grids remaining on the film was larger, the adhesion property was high.

A: grids were not peeled

B: the number was in the range of 80 to less than 100

C: the number was in the range of 60 to less than 80

D: the number was less than 60

### (Observation on Generation of Crystals)

The observation was performed using a polarizing microscope in a cross-nicol environment in a state in which a film slow axis was arranged so as to be parallel to at least one axis of the polarizing plate mounted on the microscope. At this time, Maltese cross or bright spot failures were visually confirmed at the time of observation by focusing on the liquid crystal layer.

### (Film Moisture Permeability)

The value of the moisture permeability is a value obtained by measuring the weight (g) of water vapor passing through a sample having an area of 1 m² for 24 hours in an atmosphere of a temperature of 40° C. and at a relative humidity of 92% in conformity with a moisture permeability test (cup method) of JIS Z0208.

A: the value was in the range of 400 g/m²/24 h to smaller than 2000 g/m²/24 h

B: the value was in the range of 2000 g/m²/24 h to smaller than 2200 g/m²/24 h

C: the value was in the range of 2200 g/m²/24 h to smaller than 2400 g/m²/24 h

D: the value was equal to or greater than 2400 g/m²/24 h or smaller than 400 g/m²/24 h

### 4. Preparation of Polarizing Plate

Respective phase difference films prepared in the above were attached to a polyvinyl alcohol-based polarizer using an adhesive, and FUJITAC T60 (manufactured by Fuji Photo Film Co., Ltd.) was attached to the surface on the opposite side of the polarizer in the same manner, thereby preparing polarizing plates respectively. When the phase difference films were attached to the polarizer, the surface of cellulose acylate serving as a substrate was attached to the surface of the polarizer.

In addition, at the time of mounting the phase difference films on the liquid crystal display device, the phase difference films were arranged between the liquid crystal cell and the polarizer in both cases.

Further, respective polarizing plates prepared in the above were used as polarizing plates on the display surface side as described below. As a polarizing plate on the backlight side used by combining with the polarizing plate on the display surface side, a polarizing plate prepared by attaching Z-TAC (manufactured by Fuji Photo Film Co., Ltd.) to one surface of the polarizer and attaching FUJITAC TD60UL (thickness: 60 μm, manufactured by Fuji Photo Film Co., Ltd.) to another surface thereof was used. At the time of mounting the Z-TAC film on the liquid crystal display device, the Z-TAC film was arranged between the liquid crystal cell and the polarizer.

### <Evaluation of Polarizing Plate>

[Preparation of Polarizing Plate with Adhesive Layer]

### (Formation of Adhesive Layer)

A separate film which was subjected to a surface treatment with a silicone-based releasing agent was coated with a die coater using the adhesive layer composition described below as a coating liquid, which was used between the liquid crystal cell and the polarizing plate prepared in the above, and the resultant was dried at 90° C. for 5 minutes, and then an acrylate-based adhesive layer was formed. The film thickness of the adhesive layer at this time was 35 μm.

### (Creation of Adhesive)

An acrylate-based polymer used as an adhesive was prepared according to the following procedures. 100 parts by mass of acrylic acid butyl, 3 parts by mass of acrylic acid, and 0.3 parts by mass of 2,2′-azobisisobutyronitrile were added to a reaction container including a cooling tube, a nitrogen inlet tube, a thermometer, and a stirrer together with ethyl acetate to have a solid content concentration of 30% by mass, and the resultant was reacted at 60° C. for 4 hours under nitrogen gas stream, thereby obtaining an acrylate-based polymer (A1).

Next, an acrylate-based adhesive was prepared according to the following procedures using the obtained acrylate-based polymer (A1).

A separate film which was subjected to a surface treatment using a silicone-based releasing agent was coated with a mixture obtained by adding 2 parts by mass of trimethylol propane tolylene diisocyanate (CORONATE L, manufactured by Nippon Polyurethane Industry Co., Ltd.) and 0.1 parts by mass of 3-glycidoxypropyltrimethoxysilane to 100 parts by mass of an acrylate-based polymer (A1) solid content, and the resultant was dried at 150° C. for 3 hours, thereby obtaining an acrylate-based adhesive. CORONATE L (Nippon Polyurethane Industry Co., Ltd.) serving as a crosslinking agent is a crosslinking agent having two or more aromatic rings.

### (Transferring and Aging of Adhesive Layer)

The adhesive layer was transferred to one surface of the polarizing plate prepared in the above, and allowed to be aged under the conditions of a temperature of 23° C. and at a relative humidity of 65% for 7 days to obtain a polarizing plate with an adhesive layer. In this manner, the polarizing plate with the adhesive layer was obtained.

### (Evaluation of Polarizing Plate Durability)

In regard to the polarizing plate with the adhesive layer prepared in the above, the orthogonal transmissivity of the polarizing plate was measured using UV3100PC (manufactured by Shimadzu Corporation). Measurement was performed under the conditions of a temperature of 25° C. and at 60% RH and an average value of measurement results performed 10 times was used. Specifically, first, the obtained polarizing plate with the adhesive layer was cut to have a size of 50 mm×50 mm, and the end portion thereof was attached such that the adhesive layer was brought into contact with an alkali glass plate having a size of 50 mm×50 mm. Further, the entire polarizing plate with the adhesive layer was attached to the glass plate using a laminator roll, and a sample for measurement was obtained. In regard to the sample for measurement, the orthogonal transmissivity of the polarizing plate with a wavelength of 680 nm in a moist heat environment before time elapse was measured.

Subsequently, the sample was stored at a relative humidity of 95% for 500 hours, and the orthogonal transmissivity at a wavelength of 680 nm was measured.

The change of the orthogonal transmissivity before and after time elapse was acquired on the index, and the results were listed in Table below as the polarizing plate durability of the polarizing plate with the adhesive layer of Examples. The results were calculated and the change in orthogonal transmissivity at 680 nm was evaluated using the following index.

Z=(Orthogonal transmissivity after time elapse/orthogonal transmissivity before time elapse)×100−100

A: Z was smaller than 0.5

B: Z was in the range of 0.5 to 1

C: Z was greater than 1

### 5. Preparation and Evaluation of Liquid Crystal Display Device

### <Evaluation of Liquid Crystal Display Device>

### (Preparation of Liquid Crystal Cell)

A liquid crystal panel was extracted from an iPad 2 (trade name, manufactured by Apple, Inc.) including an IPS mode liquid crystal cell, and a front glass surface of the liquid crystal cell was washed by removing only a polarizing plate on the front side (display surface side) among polarizing plates arranged on the front side (display surface side) and the rear side (backlight side) of the liquid crystal cell.

### (5) Preparation of Liquid Crystal Display Device

A polarizing plate with a phase difference film was attached to the surface on the display surface side of the IPS mode liquid crystal cell.

In this manner, an IPS mode liquid crystal display device LCD was prepared.

### (6) Evaluation of Liquid Crystal Display Device

The prepared LCD was returned to the iPad 2 from which the LCD was extracted, and the following evaluation was performed.

### (Evaluation of Front Surface Contrast)

In regard to the prepared IPS mode liquid crystal display devices described above, backlights were provided thereon, luminances were measured at the time of black display and white display using a measuring machine (EX-Contrast XL88, manufactured by ELDIM, Inc.), and the front surface contrast ratio (CR) was calculated and evaluated according to the following criteria.

A: 800≦CR

B: 700≦CR<800

C: 600≦CR<700

D: 600>CR

### (Evaluation of Color Shift (Viewing Angle of Tint))

In regard to the prepared IPS mode liquid crystal display devices described above, backlights were provided thereon, the front surface in the black display was observed from a direction of a polar angle of 60° using a measuring machine (EX-Contrast XL88, manufactured by ELDIM, Inc.), an index obtained by averaging maximum ΔEs of respective picture elements of azimuths of 0° to 90° (first picture element), 90° to 180° (second picture element), 180° to 280° (third picture element), and 270° C. to 360° C. (fourth picture element) was defined as color shift and evaluated according to the following criteria.

A: almost no color shift was observed

B: color shift was observed, but there was no problem in practical use

C: color shift was observed and there was a problem in practical use

### (Evaluation of Viewing Angle CR)

In regard to the prepared IPS mode liquid crystal display devices described above, backlights were provided thereon, luminances were measured at the time of black display and white display in a darkroom using a measuring machine (EX-Contrast XL88, manufactured by ELDIM, Inc.), an average value of the minimum values of respective picture elements in a direction of a polar angle of 60° was defined as a viewing angle contrast ratio (viewing angle CR), and the viewing angle contrast ratio was calculated and then evaluated according to the following criteria.

A: the viewing angle CR was 100 or greater

B: the viewing angle CR was in the range of 70 to smaller than 100

C: the viewing angle CR was in the range of 50 to smaller than 70

D: the viewing angle CR was smaller than 50

The evaluation results are listed in Table below.

TABLE 10

| | | | | Evaluation results | | | | | |
|---|---|---|---|---|---|---|---|---|---|
| Phase | | | Phase | Thickness | | | | | |
| difference | | Intermediate | difference | of phase | | | | | Generation |
| film | Substrate | layer | layer | difference | Re | Rth | \|Rth/ | Haze | of |
| No. | No. | No. | No. | film | (nm) | (nm) | Re\| | (%) | crystal |
| 1 | 1 | 1 | 1 | 62 | 50 | 80 | 1.60 | 0.6 | None |
| 2 | 2 | 2 | 2 | 46 | 160 | 30 | 0.19 | 0.3 | None |
| 3 | 3 | 3 | 3 | 45 | 102 | −32 | 0.31 | 0.4 | None |
| 4 | 4 | 4 | 4 | 46 | 95 | −45 | 0.47 | 0.4 | None |
| 5 | 5 | 5 | 5 | 46 | 65 | −72 | 1.11 | 0.4 | None |
| 6 | 6 | 6 | 6 | 46 | 72 | −50 | 0.69 | 0.4 | None |
| 7 | 7 | 7 | 7 | 46 | 52 | −70 | 1.35 | 0.5 | None |
| 8 | 8 | 8 | 8 | 46 | 70 | −48 | 0.69 | 0.4 | None |
| 9 | 9 | 9 | 9 | 46 | 75 | −50 | 0.67 | 0.4 | None |
| 10 | 10 | 10 | 10 | 32 | 95 | −45 | 0.47 | 0.4 | None |
| 11 | 11 | 11 | 11 | 45 | 100 | −32 | 0.32 | 0.2 | None |
| 12 | 12 | 12 | 12 | 42 | 100 | −35 | 0.35 | 0.5 | None |
| 13 | 13 | 13 | 13 | 44 | 102 | −28 | 0.27 | 0.2 | None |
| 14 | 14 | 14 | 14 | 45 | 95 | −27 | 0.28 | 0.3 | None |
| 15 | 15 | 15 | 15 | 44 | 90 | −47 | 0.52 | 0.4 | None |
| 16 | 16 | 16 | 16 | Impossible to measure | | 50 | — | 15 | None |
| 17 | 17 | 17 | 17 | Impossible to measure | | 50 | — | 24 | None |
| 18 | 18 | 18 | 18 | Impossible to measure | | 50 | — | 10 | None |
| 19 | 19 | 19 | 19 | 44 | 90 | −47 | 0.52 | 0.4 | Slight |
| | | | | | | | | | crystal- |
| | | | | | | | | | inity |
| 20 | 20 | 20 | 20 | 44 | 90 | −27 | 0.30 | 0.3 | Slight |
| | | | | | | | | | crystal- |
| | | | | | | | | | inity |
| 21 | 21 | 21 | 21 | 44 | 90 | −47 | 0.52 | 0.3 | Slight |
| | | | | | | | | | crystal- |
| | | | | | | | | | inity |
| 22 | 22 | 22 | 22 | — | — | — | — | 25 | None |
| 23 | 23 | 23 | 23 | 42 | 90 | 118 | 1.31 | 0.2 | None |
| 24 | 24 | 24 | 24 | 48 | 85 | −50 | 0.59 | 0.4 | None |
| 25 | 25 | 25 | 25 | 43 | 98 | −40 | 0.41 | 0.4 | None |
| 26 | 26 | 26 | 26 | 55 | 81 | −50 | 0.62 | 0.4 | None |
| 27 | 27 | 27 | 27 | 47 | 81 | −35 | 0.43 | 0.4 | None |
| 28 | 28 | 28 | 28 | 46 | 95 | −45 | 0.47 | 0.5 | None |
| 29 | 29 | 29 | 29 | 45 | 95 | −27 | 0.28 | 0.4 | None |
| 30 | 30 | 30 | 30 | 45 | 95 | −27 | 0.28 | 0.4 | None |
| 31 | 31 | 31 | 31 | 45 | 95 | −27 | 0.28 | 0.3 | None |
| 32 | 32 | 32 | 32 | 44.8 | 100 | −31 | 0.31 | 0.2 | None |
| 33 | 33 | 33 | 33 | 40 | 101 | −30 | 0.30 | 0.2 | None |
| 34 | 34 | 34 | 34 | 45.55 | 160 | −5 | 0.03 | 0.3 | None |

| | Evaluation results | | | | | | |
|---|---|---|---|---|---|---|---|
| Phase | Performance at the time of IPS mounting | | | | | | |
| difference | Front | Viewing | Viewing | | Polarizing | | |
| film | surface | angle | angle | Moisture | plate | Adhesion | |
| No. | contrast | of tint | CR | permeability | durability | property | Remark |
| 1 | D | C | D | D | C | D | Comparative |
| | | | | | | | Example |
| 2 | C | B | C | D | C | B | Comparative |
| | | | | | | | Example |
| 3 | B | A | A | C | B | A | Example |
| 4 | B | A | B | B | B | B | Example |
| 5 | C | A | D | B | B | C | Comparative |
| | | | | | | | Example |
| 6 | C | A | D | B | C | B | Comparative |
| | | | | | | | Example |
| 7 | C | A | D | B | C | B | Comparative |
| | | | | | | | Example |
| 8 | C | A | D | B | B | B | Comparative |
| | | | | | | | Example |
| 9 | D | C | D | B | B | B | Comparative |
| | | | | | | | Example |
| 10 | C | B | C | B | B | C | Example |
| 11 | A | A | A | B | A | A | Example |
| 12 | A | A | A | B | B | A | Example |
| 13 | A | A | A | B | A | A | Example |
| 14 | A | A | A | B | B | B | Example |
| 15 | B | A | B | B | B | B | Example |
| 16 | D | C | D | — | — | — | Comparative |
| | | | | | | | Example |
| 17 | D | C | D | — | — | — | Comparative |
| | | | | | | | Example |
| 18 | D | C | D | — | — | — | Comparative |
| | | | | | | | Example |
| 19 | C | A | C | B | B | B | Example |
| 20 | C | A | C | B | B | B | Example |
| 21 | C | A | C | B | B | B | Example |
| 22 | D | C | D | B | B | B | Comparative |
| | | | | | | | Example |
| 23 | D | C | D | B | B | B | Comparative |
| | | | | | | | Example |
| 24 | B | A | B | B | B | B | Example |
| 25 | B | A | B | B | B | B | Example |
| 26 | C | B | C | B | B | B | Example |
| 27 | C | B | C | B | B | B | Example |
| 28 | C | B | C | B | B | C | Example |
| 29 | B | A | B | B | B | B | Example |
| 30 | B | A | B | B | B | B | Example |
| 31 | B | A | B | B | B | B | Example |
| 32 | A | A | A | A | A | A | Example |
| 33 | A | A | A | A | A | A | Example |
| 34 | C | B | C | D | C | B | Comparative |
| | | | | | | | Example |

When tear strength was measured on a sample 10 of the phase difference film, the value was 1.2 g·cm/cm.

Cross section TOF-SIM was performed on a sample 9 of the phase difference film and the state in which bromine fragments were unevenly distributed in the liquid crystal layer was confirmed. Further, in cutting the cross section, when a film thickness direction was set to 0° and an in-plane direction was set to 90°, an intercept was cut out at an inclined angle of 87°.

TOF-SIMS5 (manufactured by ION-TOF, Inc.), Bi³⁺ primary ion x, and an electron gun of 20 eV charge corrected was used with respect to the film. The measurement range was 500 μm², the raster was 256× 256, the number of integrations was 64, the polarity was negative, and Br was analyzed. As a result, it was understood that Br was largely and unevenly distributed to the intermediate layer side with respect to the liquid crystal layer surface. Further, in the film sample 10 of Example, it was understood that Br was largely and unevenly distributed to the intermediate layer side with respect to the liquid crystal layer surface. Moreover, uneven distribution was not largely confirmed in the film sample 22 on which the intermediate layer was not arranged. It was confirmed that 5 times or greater the amount of br was largely and unevenly distributed with respect to the film sample 22 in the film samples 9 and 10 with uneven distribution.

A film described in Example 7 of the publication of JP-A-2007-279083 was prepared to be set as a film sample 35. In addition, a substrate in the sample 35 was cellulose triacetate having an acetyl substitution degree of 2.8.

An optically-compensatory film 5A described in Example 1 of the publication of JP-A-2002-236216 was prepared to be set as a film sample 36. In addition, a substrate in the sample 36 was cellulose acetate propionate having an acyl substitution degree of 2.8.

In regard to the films, evaluation results performed in the same manner as that described above were listed in Table below.

Table 11

| | Evaluation result | | | | | | |
|---|---|---|---|---|---|---|---|
| | Performance at time | | | | | | |
| | of IPS mounting | | | | | | |
| | | Viewing | Viewing | | Polarizing | | |
| Sample | Front | angle of | angle | Moisture | plate | Adhesion | |
| No. | contrast | tint | CR | permeability | durability | property | Remark |
| 35 | B | C | C | B | C | D | Comparative |
| | | | | | | | Example |
| 36 | C | C | C | B | C | D | Comparative |
| | | | | | | | Example |

An IPS mode liquid crystal display device was prepared by mounting respective polarizing plates having the phase difference films prepared above on the display surface side of the IPS mode liquid crystal cell (value of liquid crystal layer of d·Δn was 300 nm) and mounting the polarizing plate having a Z-TAC film prepared above on the backlight side. When evaluation was performed in the same manner, the same results were obtained.

### INDUSTRIAL APPLICABILITY

According to the present invention, it is possible to provide a phase difference film which has an excellent adhesion property between a substrate and an intermediate layer and has excellent polarizing plate durability in a moist heat environment when attached to a polarizer to be used as a polarizing plate.

Further, the phase difference film of the present invention provides optical characteristics suitable for optical compensation of a liquid crystal display device having a horizontal electric field mode, maintains appropriate tear strength, and can satisfy requirement for thinning a film which is required recently, at the same time.

Further, it is possible to provide a polarizing plate having such a phase difference film, and to provide a liquid crystal display device.

The present invention has been described in detail with reference to specific embodiments, but the fact that various changes and modifications are possible within a range not departing the scope of the present invention is obvious by a person in the art.

The present application is based on Japanese Patent Application (Japanese Patent Application No. 2012-92497) filed in Apr. 13, 2012 and Japanese Patent Application (Japanese Patent Application No. 2012-251648) filed in Nov. 15, 2012, and the contents of which are incorporated herein by reference.

1. A phase difference film comprising at least a substrate, an intermediate layer, and a phase difference layer in this order,
wherein the substrate is a cellulose acylate film which contains:
i) polycondensation ester containing a dicarboxylic acid residue that contains at least one kind of aromatic dicarboxylic acid residue and has an average carbon number of 5.5 to 10.0, or
ii) sugar ester having 1 to 12 pyranose structures or furanose structures in which at least one hydroxyl group is aromatically esterified,
and in which an average substitution degree DS of an acyl group of the cellulose acylate is 2.0<DS<2.6,
the intermediate layer contains a polyvinyl alcohol resin or an acrylic resin having a polar group,
the phase difference layer is a layer to which a state of homeotropic alignment of a liquid crystal compound is fixed, and
optical characteristics of the phase difference film satisfy the following expressions (1), (2), and (3):
80 nm≦Re≦150 nm Expression (1)
−100 nm≦Rth≦10 nm Expression (2)
0.05≦|Rth/Re|≦1.0 Expression (3)
in the expressions, Re represents a value of in-plane retardation (unit: nm) measured using light having a wavelength of 550 nm at 25° C. and at 60% RH, and Rth represents a value of a retardation (unit: nm) in a thickness direction measured using light having a wavelength of 550 nm at 25° C. and at 60% RH.

2. The phase difference film according to claim 1, containing i) the polycondensation ester or ii) the sugar ester in the content of 1% by mass to 30% by mass with respect to the cellulose acylate which is a main component of the substrate.

3. The phase difference film according to claim 1, comprising a mixed layer which contains a main component of the substrate and a main component of the intermediate layer between the substrate and the intermediate layer,
wherein the film thickness of the mixed layer is in the range of 0.3 μm to 5.0 μm.

4. The phase difference film according to claim 1,
wherein the phase difference layer contains at least one kind of onium compound represented by the following general formula (I): 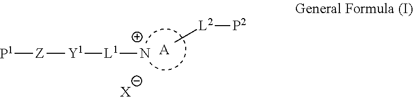
in the general formula (I),
a ring A represents a quaternary ammonium ion formed of a nitrogen-containing heterocyclic ring;
X represents an anion;
L¹ represents a divalent linking group;
L² represents a single bond or a divalent linking group;
Y¹ represents a divalent linking group having 5- or 6-membered ring as a partial structure;
Z represents a divalent linking group having an alkylene group having a carbon number of 2 to 20 as a partial structure; and
each of P¹ and P² independently represents a monovalent substituent having a polymerizable ethylenically unsaturated group.

5. The phase difference film according to claim 1, containing at least one kind of element selected from bromine, boron, and silicon in the phase difference layer.

6. The phase difference film according to claim 5,
wherein at least one kind of element selected from bromine, boron, and silicon is largely and unevenly distributed on a side close to the intermediate layer in the phase difference layer.

7. The phase difference film according to claim 1,
wherein a liquid crystal compound forming the phase difference layer is at least one kind of compound which has a polymerizable group and is selected from a group consisting of a compound represented by the following general formula (IIA) and a compound represented by the following general formula (IIB): 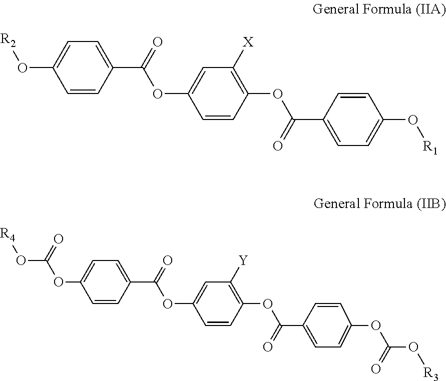
wherein, each of R₁ to R₄ independently represents —(CH₂)ₙ—OOC—CH═CH₂,
n represents an integer of 2 to 5, and
each of X and Y independently represents a hydrogen atom or a methyl group.

8. The phase difference film according to claim 7,
wherein X and Y each represent a methyl group in the general formula (IIA) or (IIB).

9. The phase difference film according to claim 7,
wherein the phase difference layer contains the compound represented by the general formula (IIA) and the compound represented by the general formula (IIB) in the content of 3% by mass or more with respect to the total solid content of the respective phase difference layers.

10. The phase difference film according to claim 1,
wherein the cellulose acylate is cellulose acetate.

11. The phase difference film according to claim 1,
wherein the average substitution degree DS of an acyl group of the cellulose acylate is satisfies 2.00<DS<2.5 in the substrate.

12. The phase difference film according to claim 1,
wherein a tear strength of the phase difference film is in the range of 1.5 g·cm/cm to 6.0 g·cm/cm.

13. The phase difference film according to claim 1,
wherein a thickness thereof is in the range of 20 μm to 50 μm.

14. The phase difference film according to claim 1,
wherein a film thickness of the phase difference layer is in the range of 0.5 μm to 2.0 μm.

15. The phase difference film according to claim 1,
wherein the intermediate layer is a layer containing an acrylic resin having a polar group,
the acrylic resin is a layer crosslinked with an acrylic monomer, and
the polar group is a hydroxyl group.

16. The phase difference film according to claim 1,
wherein the substrate is a substrate obtained by laminating a layer of cellulose acylate having an average substitution degree of acyl of 2.6 to 3.0 as a surface layer.

17. The phase difference film according to claim 1,
wherein Rth of the substrate is greater than Re,
Re satisfies 80 nm≦Re<150 nm, and
Rth satisfies 80 nm<Rth≦150 nm,
wherein, Re represents a value of an in-plane retardation measured using light having a wavelength of 550 nm at 25° C. and at 60% RH, and Rth represents a value of retardation in a thickness direction measured using light having a wavelength of 550 nm at 25° C. and at 60% RH.

18. The phase difference film according to claim 1,
wherein Re is in the range of 0 nm to 10 nm and Rth is in the range of −250 nm to −100 nm in the phase difference layer,
wherein, Re represents a value of in-plane retardation measured using light having a wavelength of 550 nm at 25° C. and at 60% RH, and Rth represents a value of retardation in a thickness direction measured using light having a wavelength of 550 nm at 25° C. and at 60% RH.

19. A polarizing plate comprising:
a polarizing film, and
two sheets of protective films protecting both surfaces of the polarizing film,
wherein at least one protective film is the phase difference film according to claim 1.

20. A polarizing plate according to claim 19,
wherein, among two sheets of protective films, one is the phase difference film according to claim 1 and the other is a film made of an acrylic resin.

21. The polarizing plate according to claim 19,
wherein a film thickness thereof is in the range of 80 μm to 120 μm.

22. A liquid crystal display device, comprising:
the phase difference film according to claim 1.

23. A liquid crystal display device having a horizontal electric field mode using the phase difference film according to claim 1.

24. A liquid crystal display device having a horizontal electric field mode using the polarizing plate according to claim 19.

25. A method of producing a phase difference film which includes at least a substrate, an intermediate layer, and a phase difference layer in this order, the method comprising:
a process of dissolving cellulose acylate whose average substitution degree DS of an acyl group satisfies 2.0<DS<2.6, and i) polycondensation ester containing a dicarboxylic acid residue that contains at least one kind of aromatic dicarboxylic acid residue and has an average carbon number of 5.5 to 10.0, or ii) sugar ester having 1 to 12 pyranose structures or furanose structures in which at least one hydroxyl group is aromatically esterified in a solvent, casting the obtained solution on a metal substrate, and forming a substrate by peeling and removing the solvent;
a process of coating a substrate with a solution obtained by dissolving or dispersing at least one kind of a polyvinyl alcohol resin and an acrylic resin having a polar group in a solvent having swelling ability or lytic potential with respect to cellulose acylate, and forming an intermediate layer by drying and curing the resultant; and
a process of coating the intermediate layer with a solution containing a polymerizable liquid crystal compound, drying the resultant, allowing the polymerizable liquid crystal compound to be homeotropically aligned, allowing the alignment state to be fixed by polymerization, and forming a phase difference layer, in this order.
